(19) United States
(12) Patent Application Publication
(10) Pub. No.: US 2005/0119550 A1
(43) Pub. Date: Jun. 2, 2005

(54) System and methods for screening a luminal organ ("lumen viewer")

(75) Inventors: Luis Serra, Singapore (SG); Freddie Wu Ying Hui, Singapore (SG)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(73) Assignee: Bracco Imaging, s.p.a., Milano (IT)

(21) Appl. No.: 10/981,227

(22) Filed: Nov. 3, 2004

Related U.S. Application Data
(60) Provisional application No. 60/517,043, filed on Nov. 3, 2003.
(60) Provisional application No. 60/516,998, filed on Nov. 3, 2003.
(60) Provisional application No. 60/562,100, filed on Apr. 14, 2004.

(51) Int. Cl. G09B 23/28

(52) U.S. Cl. 600/407

(57) ABSTRACT

Various methods and a system for the display of a luminal organ are presented. In exemplary embodiments according to the present invention numerous two dimensional images of a body portion containing a luminal organ are obtained from scan process. This data is converted to a volume and rendered to a user in various visualizations according to defined parameters. In exemplary embodiments according to the present invention, a user's viewpoint is placed outside the luminal organ, and a user can move the organ along any of its longitudinal topological features (for example, its centerline, but it could also be a line along the outer wall). In order to explore such an organ as a whole, from the outside of the organ, a tube-like structure can be displayed transparently/semi-transparently and stereoscopically.

### CROSS REFERENCE TO OTHER APPLICATIONS

This application claims the benefit of the following United States Provisional Patent applications, the disclosure of each of which is hereby wholly incorporated herein by this reference: Ser. Nos. 60/517,043 and 60/516,998, each filed on Nov. 3, 2003, and Ser. No. 60/562,100, filed on Apr. 14, 2004.

### FIELD OF THE INVENTION

This invention relates to the field of medical imaging, and more precisely to various novel display methods for the virtual viewing of a luminal organ using scan data.

### BACKGROUND OF THE INVENTION

By exploiting advances in technology, medical procedures have often become less invasive. One area where this phenomenon has occurred has been in the examination of luminal or tube like internal body structures such as the colon, aorta, etc. for diagnostic or procedural planning purposes. With the advent of sophisticated diagnostic scan modalities such as, for example, Computerized Tomography (“CT”), a radiological process wherein numerous X-ray slices of a region of the body are obtained, substantial data can be obtained on a given patient so as to allow for the construction of a three-dimensional volumetric data set representing the various structures in a given area of a patient's body subject to the scan. Such a three-dimensional volumetric data set can be displayed using known volume rendering techniques to allow a user to view any point within such three-dimensional volumetric data set from an arbitrary point of view in a variety of ways.

Conventionally, the above described technology has been applied to the area of colonoscopy. Historically, in a colonoscopy, a doctor or other user would insert a semi-flexible instrument with a camera at its tip in through the rectum of a patient and successively push the instrument upwards the length of the patient's colon as he viewed the inner lumen wall. The user would be able to turn or move the tip of the instrument so as to see the interior of the colon from any viewpoint, and by this process patients could be screened for polyps, colon cancer, diverticula or other disorders of the colon.

Subsequently, using technology such as CT, volumetric data sets of the colon were compiled from numerous (generally in the range of 100-300) CT slices of the lower abdomen. These CT slices were augmented by various interpolation methods to create a three dimensional volume which could then be rendered using conventional volume rendering techniques. According to such techniques, such a three-dimensional volume data set could be displayed on an appropriate display and a user could take a virtual tour of the patient's colon, thus dispensing with the need to insert an actual physical colonoscopic instrument.

There are numerous inconveniences and difficulties inherent in the standard “virtual colonoscopy” described above. Conventional “virtual colonoscopy” inspections place the user's viewpoint inside the organ of interest (e.g., the colon) and move the viewpoint along the interior, usually following a centerline. Firstly, depth cues are hard to display in a single monoscopic computer display. Secondly, primarily because of the culture surrounding actual endoscopies, virtual colonoscopies presented the endoscopic view, or solely the view one would see if one actually inserted a colonoscopic instrument in a patient. Technically, there is no reason to restrict a virtual colonoscopy or other display of a volume constructed from colon scan data to such an endoscopic view. There are numerous bits of useful information contained in such a data set that could be displayed to a virtual colonoscopic user, which involve voxels outside of the interior of the colon, such as, for example, voxels from the inside of a polyp or other protruding structure, voxels of diverticula, or voxels from tissue surrounding the inner wall of the colon lumen.

Finally, it is often difficult to maximize the inspection of the available data which a three-dimensional volumetric data set of the colon and surrounding tissues can provide simply by looking at a fly-through view of a colon and stopping periodically to change the view point direction of the virtual camera. In particular, when flying through a colon, one cannot see around a bend or behind (i.e., farther down/up the colon in the respective direction of travel) an interior fold of the colon (of which there are many). In order to see what is behind a fold or what is around a bend of substantial curvature, one must go beyond the fold or around the corner, stop, adjust the angle of view of the virtual camera +/−nearly 180°, so as to be able to look behind the fold or a protruding structure. This adds labor, difficulty and tediousness to performing a virtual colonoscopy.

What is thus needed are a variety of improvements to the process of virtual inspection of large tube-like organs (such as a colon or blood vessel) to take full advantage of the information which is available in a three-dimensional volumetric data set constructed from scan data of the anatomical region containing the tube-like organ of interest.

Applied to the area of virtual colonoscopies, what is needed in the art are techniques and display modes which free a user from relying solely an endoscopic view and allow for the full utilization of a three-dimensional data set of the colon lumen and surrounding tissues.

### SUMMARY OF THE INVENTION

Various methods and systems for the display of a luminal organ are presented. In exemplary embodiments according to the present invention numerous two dimensional images of a body portion containing a luminal organ are obtained from scan process, such as CT. This data is converted to a volume and rendered to a user in various visualizations according to defined parameters. In exemplary embodiments according to the present invention, a user's viewpoint is placed outside the luminal organ, and a user can move the organ along any of its longitudinal topological features (for example, its centerline, but it could also be a line along the outer wall). The organ can then be additionally rotated along its centerline. The user looks as the organ as it moves in front of him, and inspects it. In order to explore such an organ as a whole, from the outside of the organ, one needs the organ to be transparent and also needs to be able to see through the various surfaces of the organ without getting them mixed. Thus, in exemplary embodiments according to the present invention, a tube-like structure can be displayed transparently and stereoscopically. Additionally, in exemplary embodiments according to the present invention, a user can avail himself of a variety of display features, modes and parameters, such as, for example, switch to flythrough mode, simultaneously view a flythrough mode along with a view outside the luminal organ (“lumen view”), axial views, coronal views, sagittal views, “jelly map” view, view all visualizations in stereo, identify and store subregions for display using defined display parameters, such as variant color LUTs (Look Up Tables) or zoom, and divide the display space into connected regions each of which displays the data set according to different display parameters and translate/rotate the organ through such connected regions.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 depicts the surface of a colon displayed transparently and moved along its centerline according to an exemplary embodiment of the present invention;

FIG. 2 is a magnified view of the colon of FIG. 1;

FIG. 3 depicts an exemplary colon surface displayed as a red-blue anaglyphic image according to an exemplary embodiment of the present invention;

FIG. 3A depicts a black and white version of the red channel information of the exemplary colon surface displayed as a red-blue anaglyphic image in FIG. 3 according to an exemplary embodiment of the present invention;

FIG. 3B depicts a black and white version of the blue channel information of the exemplary colon surface displayed as a red-blue anaglyphic image in FIG. 3 according to an exemplary embodiment of the present invention;

FIG. 4 depicts a exemplary colon inner wall with outside tissue made transparent according to an exemplary embodiment of the present invention;

FIG. 5 depicts a view of an inner wall of a colon, with outside tissue made opaque, according to an exemplary embodiment of the present invention;

FIG. 6 depicts an alternative view of the colon inner wall of FIG. 5 according to an exemplary embodiment of the present invention;

FIG. 7 depicts an exemplary colon surface displayed monoscopically and transparently according to an exemplary embodiment of the present invention;

FIG. 8 depicts the exemplary colon of FIG. 7, displayed in red-green stereo according to an exemplary embodiment of the present invention;

FIG. 8A is a black and white illustration of the red channel information of the exemplary colon of FIG. 8 displayed in red-green stereo according to an exemplary embodiment of the present invention;

FIG. 8B is a black and white illustration of the green channel information of the exemplary colon of FIG. 8 displayed in red-green stereo according to an exemplary embodiment of the present invention;

FIG. 9 depicts the exemplary colon surface of FIG. 7, displayed in stereo using cross-eyed viewing technique (two leftmost images) and straight-eyed viewing technique (two rightmost images);

FIG. 10 depicts a detailed view of an exemplary polyp on an inner surface of the exemplary colon segment of FIG. 7 rendered in red-green stereo according to an exemplary embodiment of the present invention;

FIG. 10A is a black and white depiction of the red channel information for the polyp on an inner surface of the exemplary colon segment rendered in red-green stereo in FIG. 10 according to an exemplary embodiment of the present invention;

FIG. 10B is a black and white depiction of the green channel information for the polyp on an inner surface of the exemplary colon segment rendered in red-green stereo in FIG. 10 according to an exemplary embodiment of the present invention;

FIG. 11 depicts the exemplary colon inner surface of FIG. 10, displayed opaquely according to an exemplary embodiment of the present invention;

FIG. 11A is a black and white depiction of the red channel for the exemplary colon inner surface of FIG. 11 according to an exemplary embodiment of the present invention;

FIG. 11B is a black and white depiction of the green channel for the exemplary colon inner surface of FIG. 11 according to an exemplary embodiment of the present invention;

FIG. 12 depicts the exemplary colon surface of FIG. 10 in stereo, using cross-eyed (two leftmost images) and straight-eyed (two rightmost images) viewing techniques;

FIG. 13 depicts the exemplary colon surface of FIG. 11 displayed in stereo using cross-eyed (two leftmost images) and straight-eyed (two rightmost images) viewing techniques;

FIG. 14 depicts an exemplary inner colon surface using shading and color rendering according to an exemplary embodiment of the present invention;

FIG. 15 depicts the exemplary inner colon surface of FIG. 14 rendered transparently to reveal an exemplary measurement marking according to an exemplary embodiment of the present invention;

FIG. 16 depicts the exemplary inner colon surface of FIG. 14 using black and white rendering according to an exemplary embodiment of the present invention;

FIG. 17 depicts the exemplary inner colon surface of FIG. 15 using black and white rendering according to an exemplary embodiment of the present invention;

FIG. 18 depicts a magnified portion of the exemplary inner colon surface of FIG. 17 according to an exemplary embodiment of the present invention;

FIG. 19 depicts the magnified exemplary inner colon surface of FIG. 18 rendered more opaquely and using an exemplary color look up table according to an exemplary embodiment of the present invention;

FIG. 20 depicts the magnified exemplary inner colon surface of FIG. 18 rotated somewhat according to an exemplary embodiment of the present invention;

FIG. 21 depicts the exemplary polyp of FIG. 20, rotated to reveal voxels behind the surface and rendered transparently in black and white according to an exemplary embodiment of the present invention;

FIG. 22 depicts the exemplary polyp of FIG. 21 with visualization changed to render all voxels in black and white according to an exemplary embodiment of the present invention;

FIG. 23 depicts an exemplary colon seen as two halves, with the half nearest the user rendered transparently according to an exemplary embodiment of the present invention;

FIG. 24 depicts the exemplary colon of FIG. 23 with just the rear half visualized in an opaque manner according to an exemplary embodiment of the present invention;

FIG. 25 depicts the two halves of the colon individually represented in FIGS. 23 and 24, respectively, displayed together according to an exemplary embodiment of the present invention;

FIG. 26 depicts the exemplary whole colon of FIG. 25 with a 180° rotation of the colon around its center line according to an exemplary embodiment of the present invention;

FIGS. 27 through 30, respectively, depict the same images as FIGS. 23 through 26, rendered in red-blue stereo, as well black and white versions of each red and blue channel for each red-blue stereo figure according to an exemplary embodiment of the present invention;

FIG. 31 depicts the exemplary colon of FIGS. 23 through 30, respectively, rotated 90° about the plane of the figure, such that the left portion of FIG. 30 is now in the foreground and the right portion of FIG. 30 is now in the background, according to an exemplary embodiment of the present invention;

FIGS. 32 through 34 depict successive points along the colon of FIG. 31 proceeding further along the centerline towards point P2 according to an exemplary embodiment of the present invention;

FIG. 35 depicts the exemplary view of FIG. 31 in red-blue stereo according to an exemplary embodiment of the present invention;

FIGS. 35A and 35B depict black and white illustrations of the separate red and blue channels of the red-blue stereo image of FIG. 35 according to an exemplary embodiment of the present invention;

FIG. 36 depicts the exemplary polyp at point P1 in FIG. 31 in a zoomed-in view according to an exemplary embodiment of the present invention;

FIG. 37 depicts the exemplary polyp of FIG. 36 shown in red-blue stereo according to an exemplary embodiment of the present invention;

FIGS. 37A and 37B are black and white depictions of the separate red and blue channels of the red-blue stereo image shown in FIG. 37 according to an exemplary embodiment of the present invention;

FIG. 38 depicts the exemplary polyp depicted in FIGS. 36 and 37 using opaque shading according to an exemplary embodiment of the present invention;

FIG. 39 depicts the exemplary view of FIG. 38 shown and displayed in red-blue stereo according to an exemplary embodiment of the present invention;

FIGS. 39A and 39B depict black and white images of the separate red and blue channel information of the red-blue stereo image of FIG. 39 according to an exemplary embodiment of the present invention;

FIG. 40 depicts the polyp of FIGS. 36 and 37, respectively rotated 90° about the plane of the figure, such that the left portion of FIG. 36 is in the foreground and the right portion of FIG. 36 is in the background, according to an exemplary embodiment of the present invention;

FIG. 41 depicts the exemplary polyp of FIG. 40 in high magnification, cutting through the surface according to an exemplary embodiment of the present invention;

FIG. 42 depicts the exemplary view of FIG. 41 using a different visualization mode so as to reveal inside voxel values according to an exemplary embodiment of the present invention;

FIG. 43 depicts the exemplary polyp shown in FIG. 40 cutting through the surface using three intersecting planes to generate cross-sectional views according to an exemplary embodiment of the present invention;

FIG. 44 depicts shows an alternative placing of the three cross-sectional planes from that of FIG. 43 according to an exemplary embodiment of the present invention;

FIG. 45 depicts the exemplary view of FIG. 44 using cross-eyed and straight-eyed stereo viewing techniques;

FIG. 46 depicts the exemplary view of FIG. 44 displayed in red-blue stereo according to an exemplary embodiment of the present invention, and FIGS. 46A and 46B depict black and white illustrations of the separate red and blue channels of the stereo image of FIG. 46 according to an exemplary embodiment of the present invention;

FIGS. 47A-C depict exemplary renderings of a colon interior according to an exemplary embodiment of the present invention; FIG. 47A depicts the exemplary colon interior without shading, FIG. 47B depicts the exemplary colon with shading, and FIG. 47C depicts the exemplary colon with shading and with transparency, showing only the lumen interior colon interface, all according to an exemplary embodiment of the present invention;

FIG. 48 is a magnified view of FIG. 47B;

FIG. 49 is a magnified view of FIG. 47A;

FIG. 50 is a magnified view of FIG. 47C;

FIG. 51 is the exemplary colon shaded/transparent view of FIG. 50 shown in red-blue stereo, and FIGS. 51A and 51B are black and white depictions of each red and blue channel of the stereo image of FIG. 51 according to an exemplary embodiment of the present invention;

FIGS. 52 through 56, respectively, depict the rotation of a transparent colon along its centerline in five steps according to an exemplary embodiment of the present invention;

FIGS. 57 through 61, respectively, show the exemplary views of FIGS. 52 through 56, respectively, displayed in red-blue stereo, and also show black and white versions of each red and blue channel for each stereo image according to an exemplary embodiment of the present invention;

FIG. 62 depicts an exemplary colon seen as two halves according to an exemplary embodiment of the present invention, where the front half is seen transparently and the rear half is seen as opaque using color shading;

FIG. 62A is a black and white illustration of only the shading that is used in FIG. 62 according to an exemplary embodiment of the present invention;

FIG. 63 depicts the exemplary colon of FIG. 62 using red-green stereo, and FIGS. 63A and 63B show black and white illustrations of the separate red and green channel information for the stereo image of FIG. 63 according to an exemplary embodiment of the present invention;

FIG. 64 depicts an alternate portion of the exemplary colon depicted in FIGS. 62 and 63, where the rear portion of the colon is displayed opaquely with shading according to an exemplary embodiment of the present invention;

FIG. 64A is a black and white illustration of the shading utilized in FIG. 64 according to an exemplary embodiment of the present invention;

FIG. 65 depicts a further alternate view of the exemplary colon depicted in FIGS. 62 through 64, with the foreground half displayed semi-transparently in gray, and the background half displayed opaquely with shading;

FIG. 65A is a black and white illustration of the shading utilized in FIG. 64 according to an exemplary embodiment of the present invention;

FIG. 66 depicts an exemplary transparent view of an entire colon according to an exemplary embodiment of the present invention with an air injector device inserted into a patient's rectum at the point where the arrow (indicated in yellow in the color drawing) is pointing;

FIG. 67 depicts the air injector device of FIG. 66 in a transparent magnified view according to an exemplary embodiment of the present invention;

FIG. 68 depicts the air injector device of FIG. 66 in a transparent view with higher magnification according to an exemplary embodiment of the present invention;

FIG. 69 depicts the magnified transparent view of FIG. 68 in red-green stereo, and FIGS. 69A and 69B are black and white depictions of the separate red and green channels for the image of FIG. 69 according to an exemplary embodiment of the present invention;

FIG. 70 depicts the air injector device of FIG. 67 rotated 180° according to an exemplary embodiment of the present invention;

FIG. 71 depicts the air injector device of FIG. 67 with a crop box to isolate the air injector according to an exemplary embodiment of the present invention;

FIG. 72 depicts the cropped air injector of FIG. 71 where a user has finished adjusting the crop box according to an exemplary embodiment of the present invention;

FIG. 73 depicts the air injector of FIG. 72 displayed using shading according to an exemplary embodiment of the present invention;

FIG. 74 depicts the shaded air injector and device of FIG. 73 using a slightly different color look-up table according to an exemplary embodiment of the present invention;

FIG. 75 depicts the cropped air injector device of FIG. 71 displayed using a color look-up table according to an exemplary embodiment of the present invention with visible crop box;

FIG. 76 depicts the air injector device of FIG. 75 in an alternative view according to an exemplary embodiment of the present invention;

FIG. 77 depicts the air injector device of FIG. 76 displayed in blue-red stereo, and FIGS. 77A and 77B are black and white illustrations of the separate blue and red channels for the stereo image of FIG. 77 according to an exemplary embodiment of the present invention;

FIG. 78 depicts the air injector device of previous Figs. using a tri-planar view according to an exemplary embodiment of the present invention;

FIG. 79 depicts the air injector device in a transparent tri-planar view revealing actual scan values with an exemplary system user interface according to an exemplary embodiment of the present invention;

FIG. 80 depicts the transparent tri-planar view of the air injector device shown in FIG. 79 using a different color lookup table according to an exemplary embodiment of the present invention;

FIG. 81 depicts the air injector device shown in transparent volume-rendered view according to an exemplary embodiment of the present invention;

FIG. 82 depicts the isolated air injector device of FIG. 81 displayed using a different color look-up table (colon fly color look-up table) according to an exemplary embodiment of the present invention;

FIG. 83 depicts a totally opaque view of the air injector and device of FIGS. 81 and 82 according to an exemplary embodiment of the present invention;

FIG. 84 depicts the opaque view of the air injector device of FIG. 83 after cropping to reveal voxel values inside the device according to an exemplary embodiment of the preset invention;

FIG. 85 depicts the air injector device of FIG. 84 using a transparent view with color lookup table and cropped to reveal voxel values insider the device according to an exemplary embodiment of the present invention;

FIG. 86 depicts the air injector device of FIG. 85 using a transparent black and white view according to an exemplary embodiment of the present invention;

FIG. 87 depicts the air injector device of FIG. 86 using a transparent and magnified black and white view according to an exemplary embodiment of the present invention;

FIG. 88 depicts the air injector device of FIG. 87 using a color look-up table according to an exemplary embodiment of the present invention;

FIG. 89 depicts the air injector device of FIG. 88 using a transparent, magnified black and red view according to an exemplary embodiment of the present invention;

FIG. 90 depicts the air injector device of FIG. 89 using a tri-planar magnified black and white view cropped to reveal voxel values inside the device according to an exemplary embodiment of the present invention;

FIG. 91 depicts the air injector device of FIG. 89 in a transparent magnified black and white view according to an exemplary embodiment of the present invention;

FIG. 92 depicts the air injector device of FIG. 91 in a transparent magnified black and red view against a white background according to an exemplary embodiment of the present invention;

FIG. 93 depicts the air injector view of FIG. 90 against a white background according to an exemplary embodiment of the present invention;

FIG. 94 depicts the air injector device of FIG. 91 using a transparent black and white view with a slightly different look-up table against a white background according to an exemplary embodiment of the present invention;

FIG. 95 depicts an air injector device inserted into a rectum, and the view of surrounding tissues using CT scan data according to an exemplary embodiment of the present invention;

FIG. 96 depicts the exemplary air injector device and surrounding tissues of FIG. 95 from a different perspective according to an exemplary embodiment of the present invention;

FIG. 97 depicts the air injector device and surrounding tissues of FIG. 96 while using a different color look-up table according to an exemplary embodiment of the present invention;

FIG. 98 depicts the view of FIG. 97 with certain structures rendered transparently so as to allow a direct view of the air injector device according to an exemplary embodiment of the present invention;

FIG. 99 depicts the view of the air injector and surrounding opaque tissue of FIG. 98 using a different look-up table according to an exemplary embodiment of the present invention;

FIG. 100 depicts the view shown in FIG. 99 against a black background according to an exemplary embodiment of the present invention;

FIG. 101 depicts the air injector surrounding opaque tissue as depicted in FIG. 100 with certain structures rendered transparently so as to allow a direct view of the air injector device according to an exemplary embodiment of the present invention;

FIG. 102 illustrates an interface for centerline generation according to an exemplary embodiment of the present invention;

FIG. 103 illustrates a flowchart for centerline generation for lumen segments according to an exemplary embodiment of the present invention;

FIG. 104 depicts the interaction between the flythrough module, lumen viewer module, and the application model according to an exemplary embodiment of the present invention;

FIG. 105 depicts radii estimation of a lumen at various positions as a function of distance along the centerline according to an exemplary embodiment of the present invention;

FIG. 106 illustrates a graph of a function estimating the radius of a lumen at points along a centerline according to an exemplary embodiment of the present invention;

FIG. 107 shows a translucent lumen view according to an exemplary embodiment of the present invention;

FIG. 108 illustrates a combined opaque-translucent view according to an exemplary embodiment of the present invention;

FIG. 109 depicts a histogram of a typical abdominal CT scan segmented into different ranges with several thresholds of interest according to an exemplary embodiment of the present invention;

FIG. 110 shows a histogram, thresholds of interest, and their relationship to a color look-up table according to an exemplary embodiment of the present invention;

FIG. 111 illustrates an opaque view of a lumen using CT data in a grayscale image according to an exemplary embodiment of the present invention;

FIG. 112 shows the same image as FIG. 111 augmented with transparency according to an exemplary embodiment of the present invention;

FIG. 113 depicts the same CT image as FIGS. 111 and 112, augmented with both transparency and color according to an exemplary embodiment of the present invention;

FIG. 114 illustrates the utilization of a color look-up table that emphasizes the bone structure of an abdominal CT scan according to an exemplary embodiment of the present invention;

FIG. 115 illustrates the utilization of a color look-up table that emphasizes the colon wall of an abdominal CT scan according to an exemplary embodiment of the present invention;

FIG. 116 shows the layout of a virtual colonoscopy user interface that includes synchronized flythrough and lumen views according to an exemplary embodiment of the present invention; and

FIG. 117 shows the user interface of FIG. 116, with the flythrough view and the “jelly map” view of the entire color interchanged according to an exemplary embodiment of the present invention.

### DETAILED DESCRIPTION OF THE INVENTION

Exemplary System

In exemplary embodiments according to the present invention, any 3D data set display system can be used. For example, the Dextroscope™, provided by Volume Interactions Pte Ltd of Singapore is an excellent platform for exemplary embodiments of the present invention. The functionalities described can be implemented, for example, in hardware, software or any combination thereof.

General Overview

In exemplary embodiments according to the present invention novel systems and methods are provided for the enhanced virtual inspection of a large tube-like organ, such as, for example, a colon or a blood vessel. In an exemplary embodiment according to the present invention, in contradistinction to the conventional “fly-through” view, which imitates the physical “endoscopic” perspective, a tube-like organ can be virtually displayed so that a user's viewpoint is outside of the organ, and the organ can move along any of its longitudinal topological features, such as, e.g., its centerline or a line along an outer wall, effectively passing the organ in front of a user. Additionally, in exemplary embodiments according to the present invention, the organ can be rotated along its centerline.

To fully explore a luminal organ such as the colon as a whole, from a viewpoint outside it, one needs (1) the colon to be transparent and (2) stereoscopy display in order to be able to see through the surfaces without getting them mixed up or confused. Thus, in exemplary embodiments according to the present invention, numerous user controlled stereoscopic display parameters are available. Additionally, in exemplary embodiments according to the present invention, a user can display all or part of a luminal organ transparently or semi-transparently, and such transparent or semi-transparent display can utilize essentially any palette of color according to user defined color lookup tables.

Additionally, since a luminal organ is displayed by processing a three dimensional data set, in exemplary embodiments according to the present invention various navigational and display functionalities useful in the display and analysis of three dimensional data sets can be implemented. Accordingly, U.S. Provisional Patent Application No. 60/505,344, filed Nov. 29, 2002 and U.S. patent application Ser. No. 10/727,344, filed Dec. 1, 2003, both under common assignment herewith and both entitled “SYSTEM AND METHOD FOR MANAGING A PLURALITY OF LOCATIONS OF INTEREST IN 3D DATA DISPLAYS” are incorporated herein by this reference (the “Zoom Context” applications). Similarly, U.S. Provisional Patent Application No. 60/505,345, filed Nov. 29, 2002, and U.S. patent application Ser. No. 10/425,773, filed Dec. 1, 2003, both under common assignment herewith and both entitled “METHOD AND SYSTEM FOR SCALING CONTROL IN 3D DISPLAYS” are incorporated herein by reference (the “Zoom Slider” applications). All of the functionality described in said Zoom Context and Zoom Slider applications can just be applied to the display of a luminal organ in exemplary embodiments of the present invention.

“Zoom context” relates to “bookmarks” (marked regions of interest) in a section of tube-like anatomical structure, such as a human colon. During a first pass through the colon lumen with either Flythrough or Lumen Viewer interface views, the user may find a number of regions of interest (ROI). In order to enable a user to quickly revisit of these ROIs, bookmarks can to be used to tag regions of interest. Such bookmarking may be done in a virtual colonoscopy application. Furthermore, in order to cater to the specific needs of radiologists or other users, information such as the location of the ROI and the boundaries of the ROI may be included in a bookmark. For example, when a bookmark is reached, the ROI may be zoomed in on for better viewing.

Viewing parameters for the ROI may also be included in a bookmark, such as the view point, the viewing direction, the field of view, or other similar viewpoints. The rendering parameters for the ROI can be included in bookmarks as well, and may include color look-up tables. For example, there may be a set of alternative CLUTs (Color Look Up Tables) associated with each bookmark, either predefined or user-defined. In addition, shading modes and light positions may also be included in bookmarks. Diagnostic information may also be associated with bookmarks. This diagnostic information may include identification (e.g., identifying name, patient name, title, date of image, time if image creation, size of image, modality, etc.); classifications, linear measurements (created by a user), distance from the rectum; comments, snapshots (as requested by user, in monoscopic or various stereoscopic modes), and other items of information. Snapshots may be affiliated with bookmarks, and these user-requested snapshots can be in monoscopic or various stereoscopic modes. Bookmarks may be presented to the user as a list. A user may browse through the list of bookmarks just by the information described above, or by activating the Flythrough/Lumen Viewer interface for further inspection.

In exemplary embodiments of the present invention the zoom slider is not exposed to the user in Lumen Viewer display screen. Instead of allowing the user to interactively control the zoom and the center of interest, the Lumen Viewer application takes control of the zoom sliding process. The centerline of interest of the Lumen Viewer is determined by the current position along the centerline, whereas the zoom is determined by the result of the radius estimation algorithm. By applying similar process as the user-interactive version of the zoom slider, the Lumen Viewer application translates the volume so that the center of interest is at the center of the Lumen Viewer's window, and adjusts the zoom of the volume to the appropriate size so that the colon lumen fits into the window.

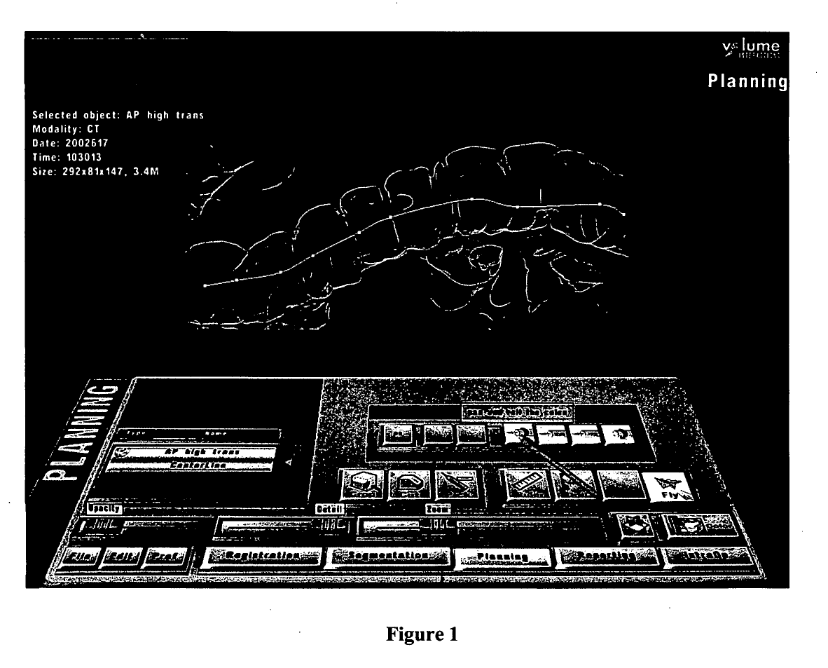

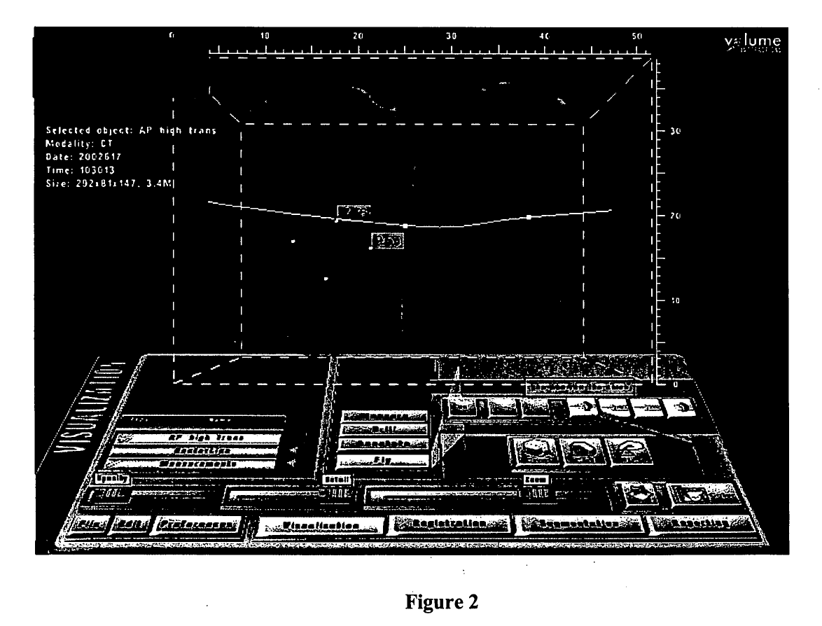

In exemplary embodiments according to the present invention, several modes of presenting a luminal (or tube-like) organ are possible. In one exemplary embodiment, such an organ can be presented as a translucent jelly-like structure so that all of its surfaces (inner and outer, those closer to the user as well as those away from the user) are visible. FIG. 1 depicts an exemplary overview of this display mode, and FIG. 2 depicts an exemplary close up or magnified view of this display mode. Overview mode allows a user to have more of the colon visible within an inspection box (a matter of adjusting a zoom parameter with respect to a zoom box). This mode gives the user a sense of the shape of the colon (and also shows the bigger polyps or diverticula) to the detriment of some of the detail.

With reference to FIG. 2, a polyp is visible in the wall of the colon farthest from the user (protruding into the colon lumen, i.e., in a direction towards the user), and a user can accordingly add measurements to the polyp in this viewing mode as seen in FIG. 2. It is often desirable to measure polyps to determine how developed they are, to see if they can be considered a serious threat. Polyp measurement can be one important element to the colonoscopic exploration. Usually, linear measurements are taken (length across). In exemplary embodiments according to the present invention, a user can measure a polyp by placing two end points of a measuring “tape” on two ends of a visible polyp. The selected points of measurement, the measurement line, and the value of the measurement may, for example, be displayed for the user. In exemplary embodiments according to the present invention, a user can switch between the overview (FIG. 1) and magnified (FIG. 2) display modes at will.

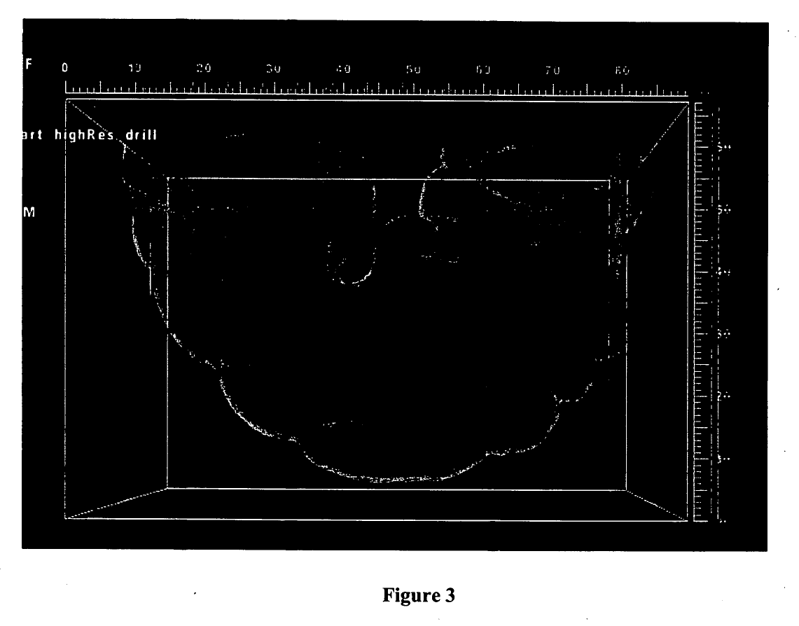

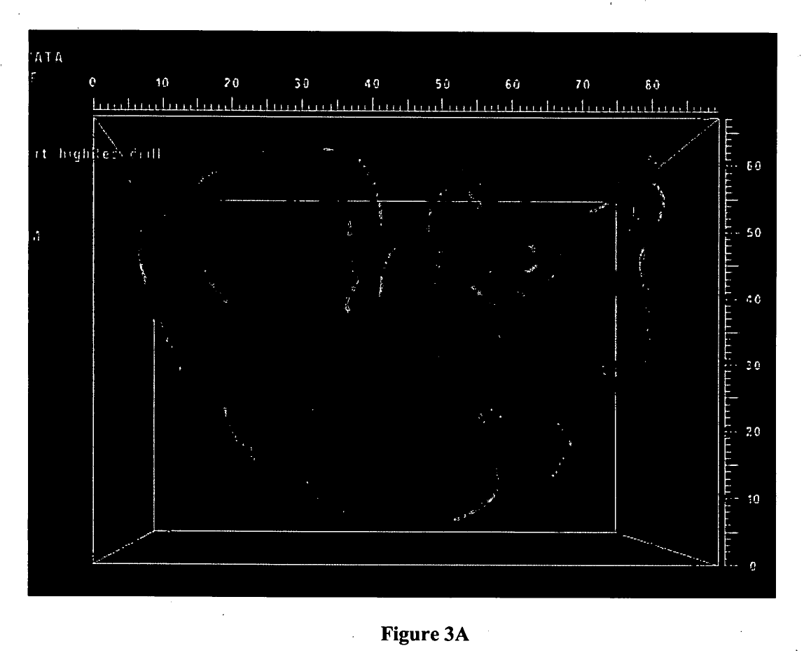

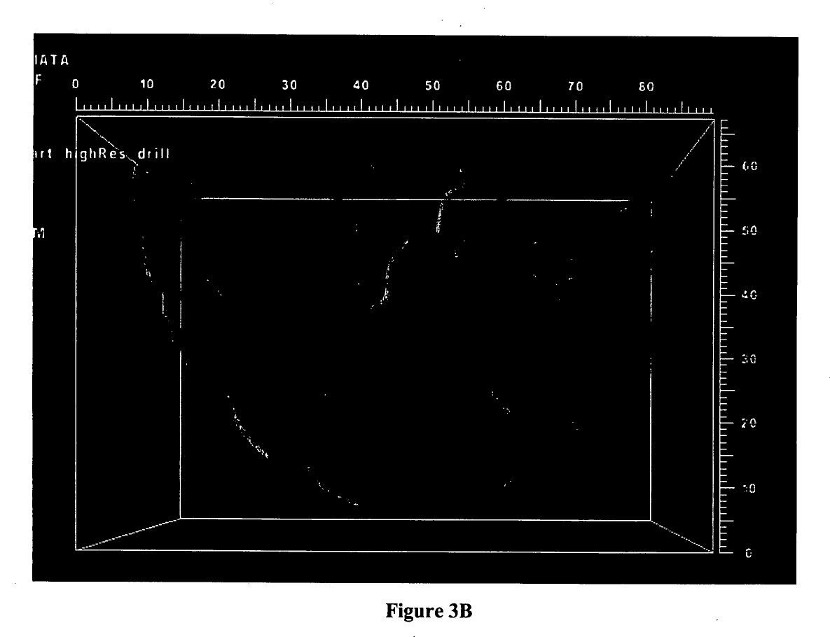

In the exemplary visualization modes of FIGS. 1 and 2, the parts of an organ closer to a user could obscure those parts farther away. An example of such obstruction could be when two suspicious areas have the same XY coordinates, but different Z coordinates in a display space. Thus, in exemplary embodiments according to the present invention, a luminal organ can be displayed stereoscopically, and inner and outer structures may be identifiable based on depth perception. FIG. 3 depicts an exemplary stereoscopic display of a colon in magnified display mode. FIG. 3 is an anaglyphic stereo image, visible using anaglyphic glasses. Also, stereo resolves if the pathology is a polyp or a diverticle by estimating if the structure is coming or going away from user, relative to the surface where the structure is attached. FIGS. 3A and 3B are black and white depictions of the separate red and blue channels of image information of FIG. 3. These separate red and blue channels of information may be combined to form a composite stereo image.

Similarly, by rotating the organ along its centerline a display may avoid, for example, having lesions obscure other lesions that may lie in a viewer's line of sight. The parallax depth effect obtained by rotating (and translating) may assist a user in establishing what object or element of interest is in front of other object or elements. In exemplary embodiments according to the present invention, a user can stop the rolling of the image if he sees a suspicious spot and inspect an area for possible polyps. Such inspection can be done, for example, with the help of a set of predefined color look-up tables that emphasize different parts the colon. The acquisition values of a scan (voxels) are mapped to the color and transparency values for display purposes.

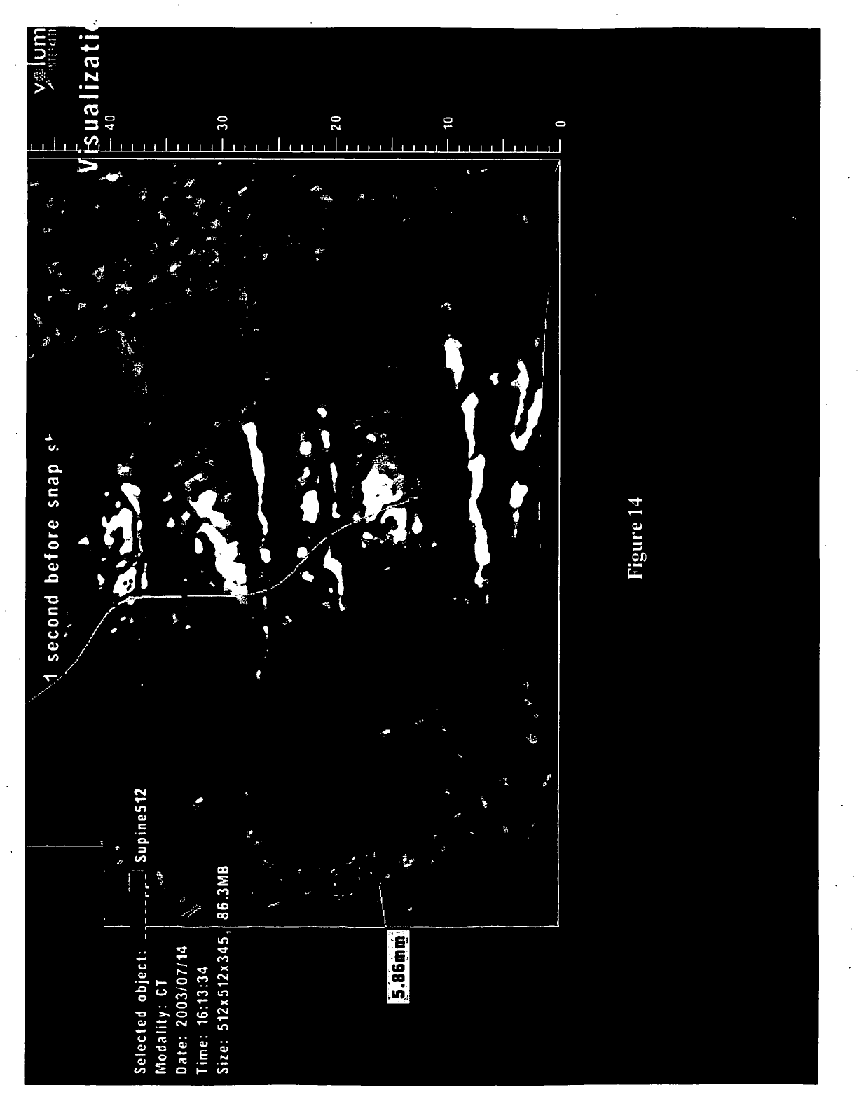

One technique to perform this mapping is called “Color Look-Up Table” (CLUT), in which a “transfer function” maps voxel values to Red, Green, and Blue (plus Transparency) values. A CLUT can be either, for example, linear (mapping voxel 0 to (R, G, B, T)=(0, 0, 0, 0); voxel 1 to (1, 1, 1, 1), etc.) or it can be, for example, a filter where certain voxel values are completely transparent and others are visible, etc. In the case of a colon, voxel values corresponding to air can be made transparent (T=0), and voxel values corresponding to colon tissue (for example, inner surface tissue) can be made opaque so as to allow the user to see them (see, for example, FIGS. 14-17). Once a suspicious potential polyp has been detected, it is important to examine the inner voxel values of the polyp to establish what type of substance they are (for example, they could be tissue, or in case of a false polyp, a piece of fecal matter). By examining the inner voxel values a user can distinguish a “real” polyp form a clinging piece of stool, as stool generally contains air bubbles (often many air bubbles), which will show up as different voxel values than those of tissue. This inspection procedure requires that a CLUT be changed to reveal interior voxels (as depicted in, for example, FIGS. 18-22 and 43-46) in exemplary embodiments according to the present invention.

Additionally, in exemplary embodiments according to the present invention, a tube-like (or “luminal”) organ can be displayed, such that one of its surfaces (e.g., its inner wall or its outer wall) is made opaque and the other transparent. In such exemplary embodiments, the organ can be cut in half along its longitudinal axis, so that a user can see one half of the wall. The organ can then be rolled along such longitudinal axis so that a full revolution is displayed as it passes in front of a user. In exemplary embodiments according to the present invention, an organ can be moved in a direction parallel to the viewing direction of a user, either towards or away from the user's point of view (“fly-through view”), or, in alternative exemplary embodiments according to the present invention, in a direction which is orthogonal to the viewing direction of the user (“lumen view”), or in any direction in between, such as, for example, at a 45 degree angle to the user's viewing direction. In some embodiments, as described below, these views may be synchronized and simultaneously displayed in a user interface.

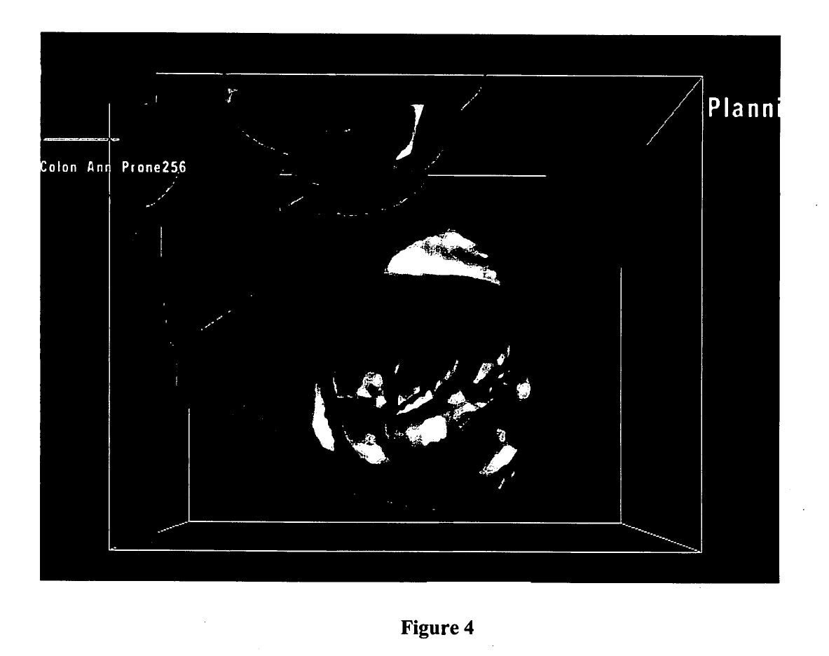

FIG. 4 is an exemplary display of an inner colon wall with the outside tissue made transparent. The ability to see through the outside tissue reveals to a user the direction of movement so that turns are not disorienting. In the exemplary display of FIG. 4, the organ is being moved along its centerline in a direction towards the user. Put another way, the user experiences such a view as if he is moving into the display through the colon along its center.

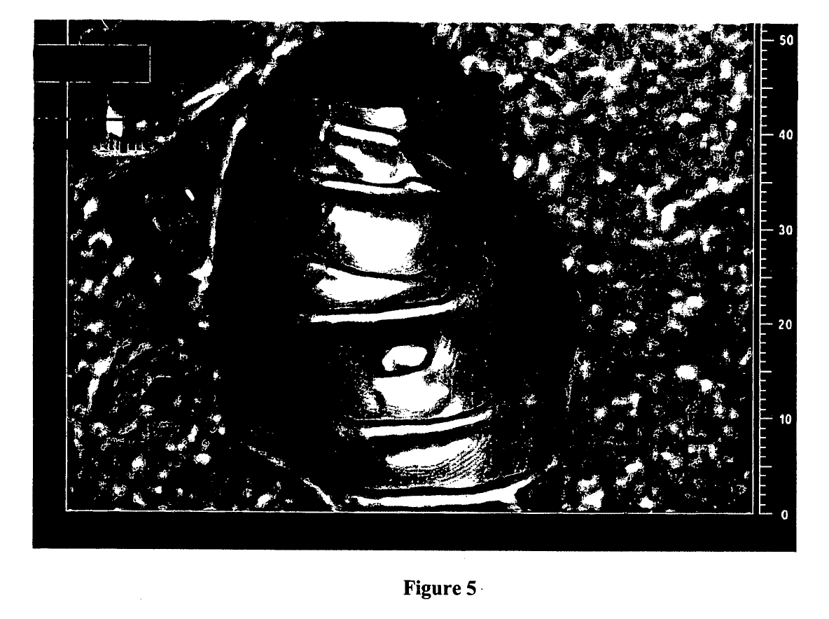

With reference to FIG. 5, a similar view of the colon depicted in FIG. 4 is displayed. However, in the exemplary display of FIG. 5, not only the inner wall of the colon is visible but the outside tissue is made opaque so as to allow a user to inspect its properties.

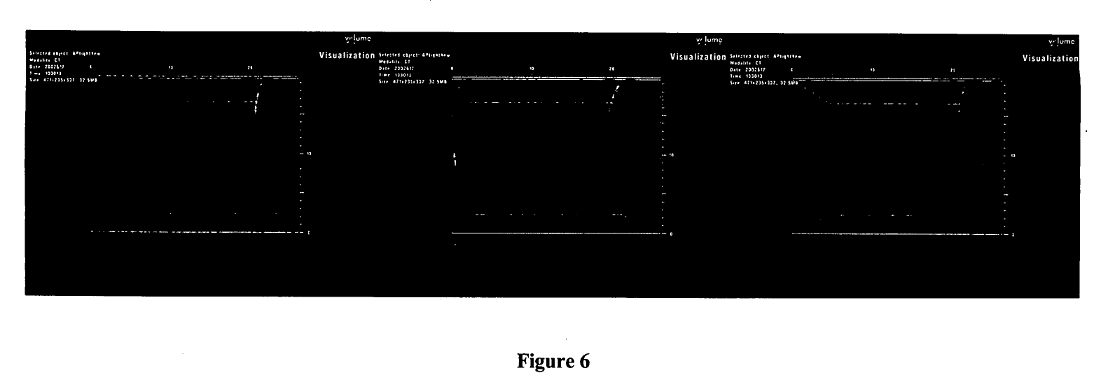

Similarly, FIG. 6 depicts an alternative exemplary view showing the inner wall of a colon with the outside tissue made opaque. However, in contradistinction to FIG. 5, the organ is here cut in half and moves along its centerline in a direction orthogonal to the user's viewing direction. In this type of exemplary display mode, a user experiences the colon at a fixed distance in front of him, moving to either his left or his right and rotating at the same time. Because there is a virtual vertical cut plane in the model space, which divides the colon lumen in half into two semi-cylindrical volumes, as the colon rotates different portions of the colon are behind the virtual plane and rendered visible and other portions are in front of the virtual plane and rendered transparently. This image does not have a transparent front half (see FIGS. 62-65 below, for similar examples). Thus, with one full rotation the entire wall of the colon can be successively viewed.

In what follows numerous exemplary functionalities of exemplary embodiments according to the present invention are illustrated using virtual colonoscopy as an illustrative application. In the remaining figures, various exemplary visualizations and user interactions therewith shall be described in that context. It is understood that the functionalities and methods of the present invention are applicable to numerous applications and uses, virtual colonoscopy being only one example of them.

Additionally, various exemplary embodiments according to the present invention can implement on or more of the display modes or types illustrated by the remaining figures. While descriptions will be provided of what is depicted, the functionalities of the present invention are understood to be in no way limited by such descriptions, the illustrative figures being, in general, each worth the proverbial many words.

Stereoscopic Visualization

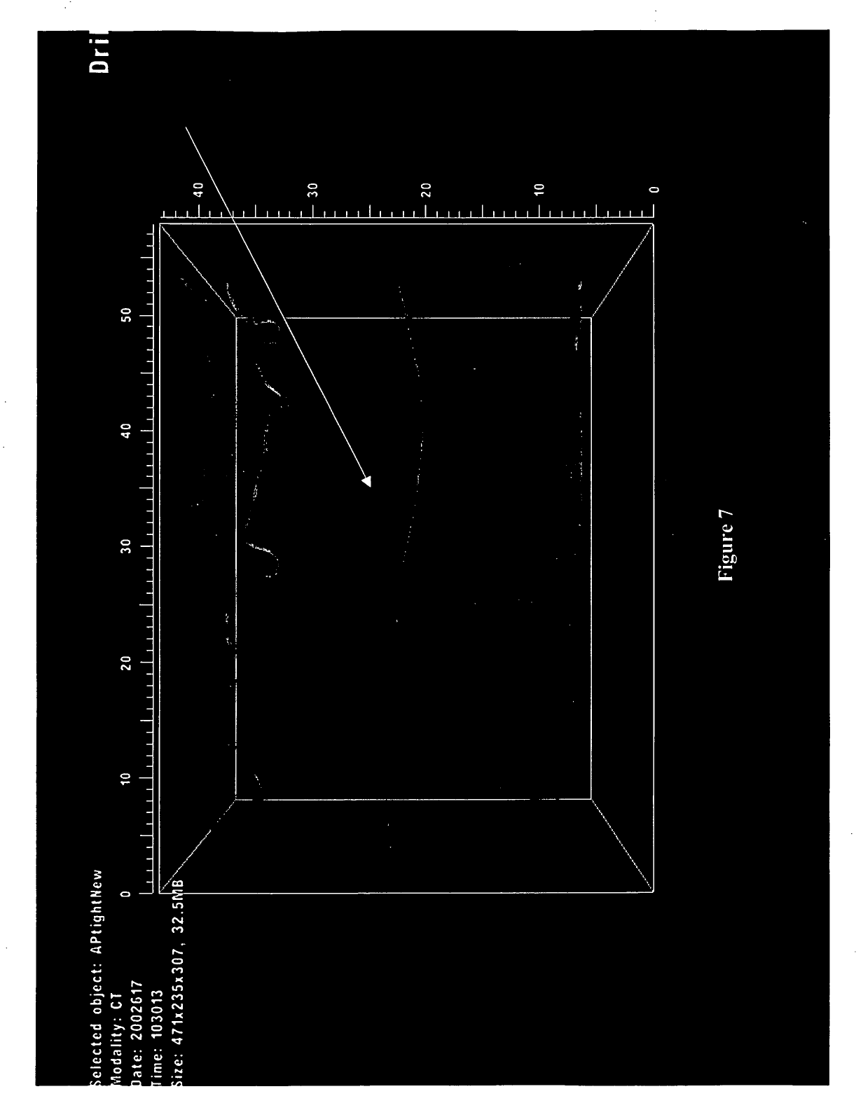

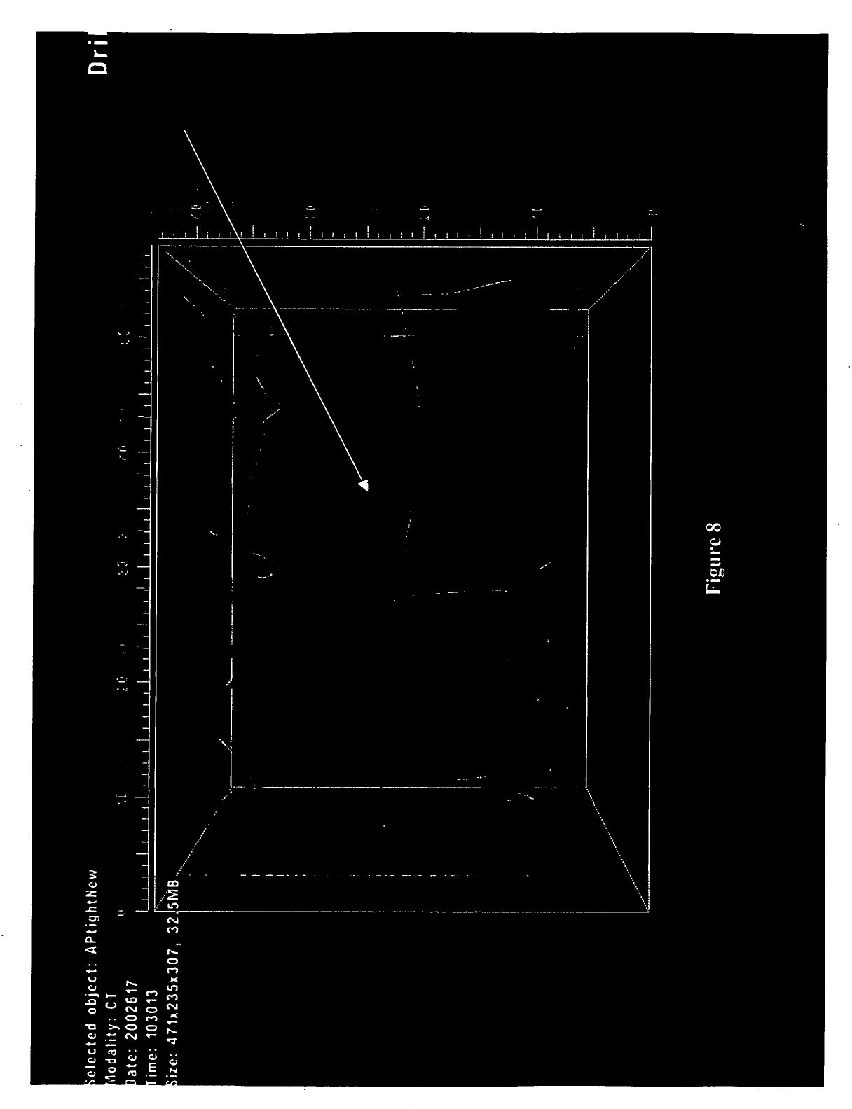

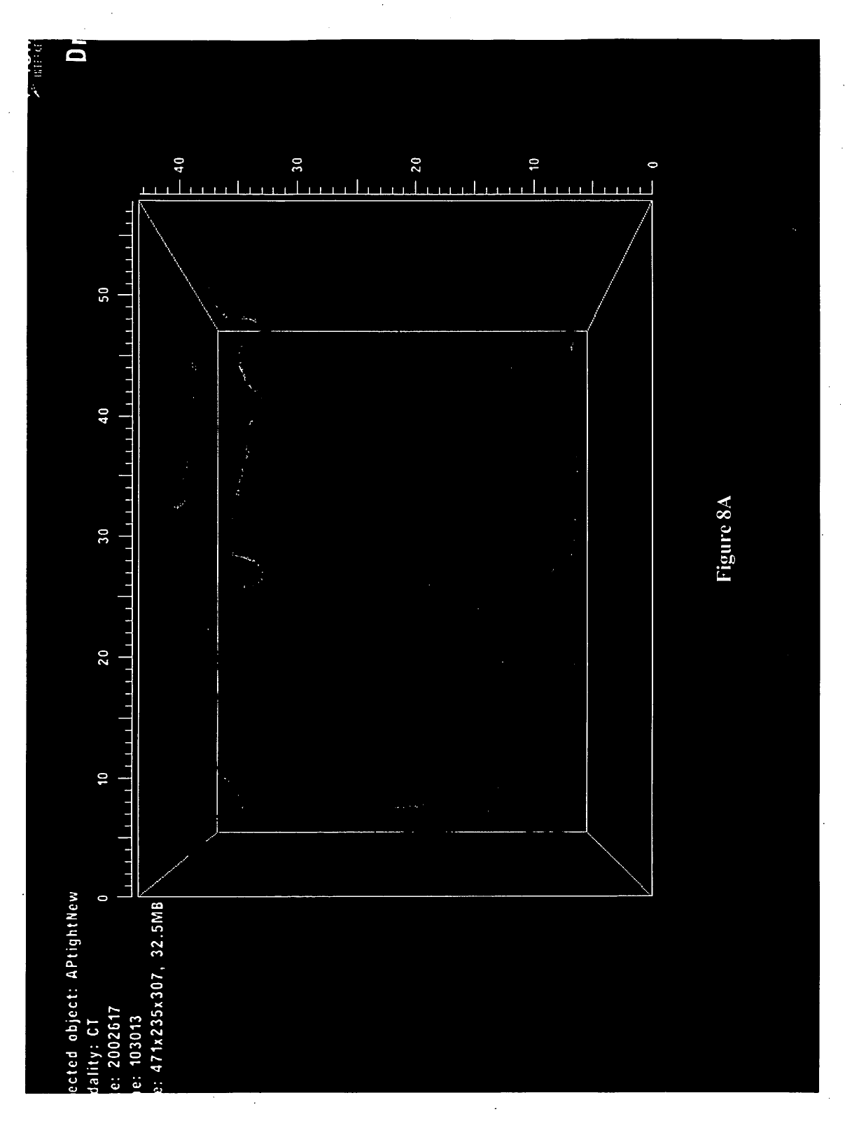

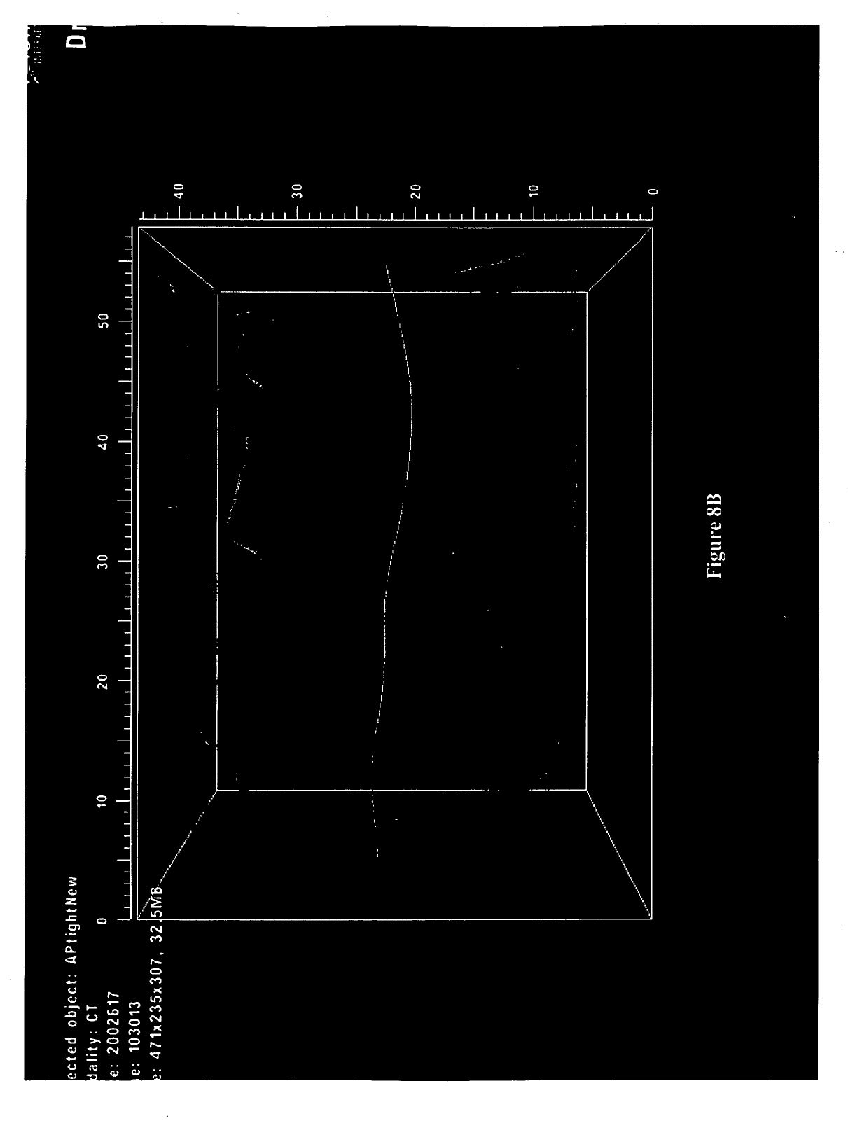

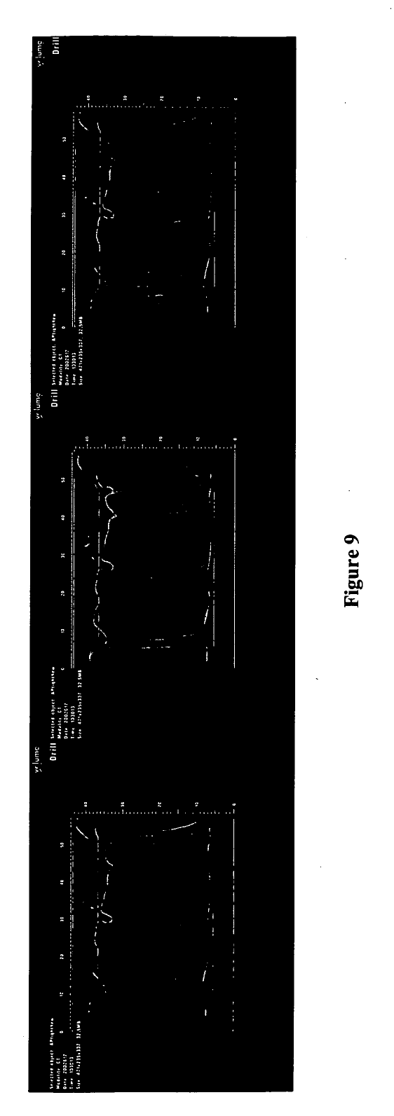

FIG. 7 depicts the surface of an exemplary colon, displayed transparently, according to an exemplary embodiment of the present invention. An arrow (indicated in yellow in the color drawing) points to a suspected polyp. Without viewing this exemplary colon stereoscopically, and having few other depth cues, it can be hard to assess if the structure pointed by the arrow is protruding into the colon lumen and is likely a polyp, or is protruding outward from an outer wall and is thus a diverticle. Viewing the same colon stereoscopically, as depicted in FIG. 8, mitigates against this problem.

FIG. 8 depicts the exemplary colon of FIG. 7 anaglyphically, in red-green stereo. FIGS. 8A and 8B are black and white images of the separate red and green channel stereo information for FIG. 8. When these separate red and green channels can be combined to form a stereoscopic image of a colon. Using a stereoscopic display, the structure pointed to by the arrow (depicted in yellow in the color drawing) can be clearly identified as a polyp protruding from the inner surface of the farther wall of the colon.

FIG. 9 depicts the stereo images of FIG. 8 using the cross-eyed viewing technique (FIGS. 9A and 9B, the two left most images) and the straight-eyed technique (FIGS. 9B and 9C, the two right most images). Using a stereoscopic display, the structure (pointed to by the arrow in FIG. 7) can be clearly identified as a polyp protruding from the inner surface of the farther wall of the colon.

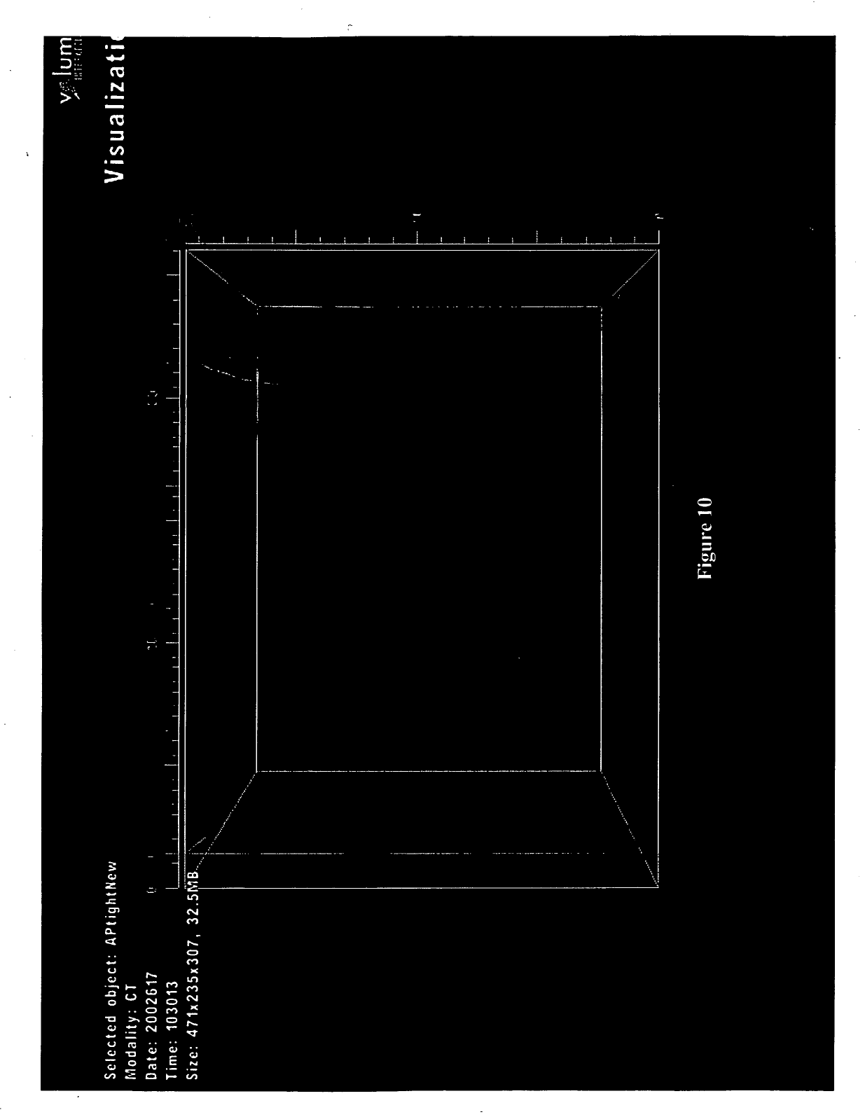

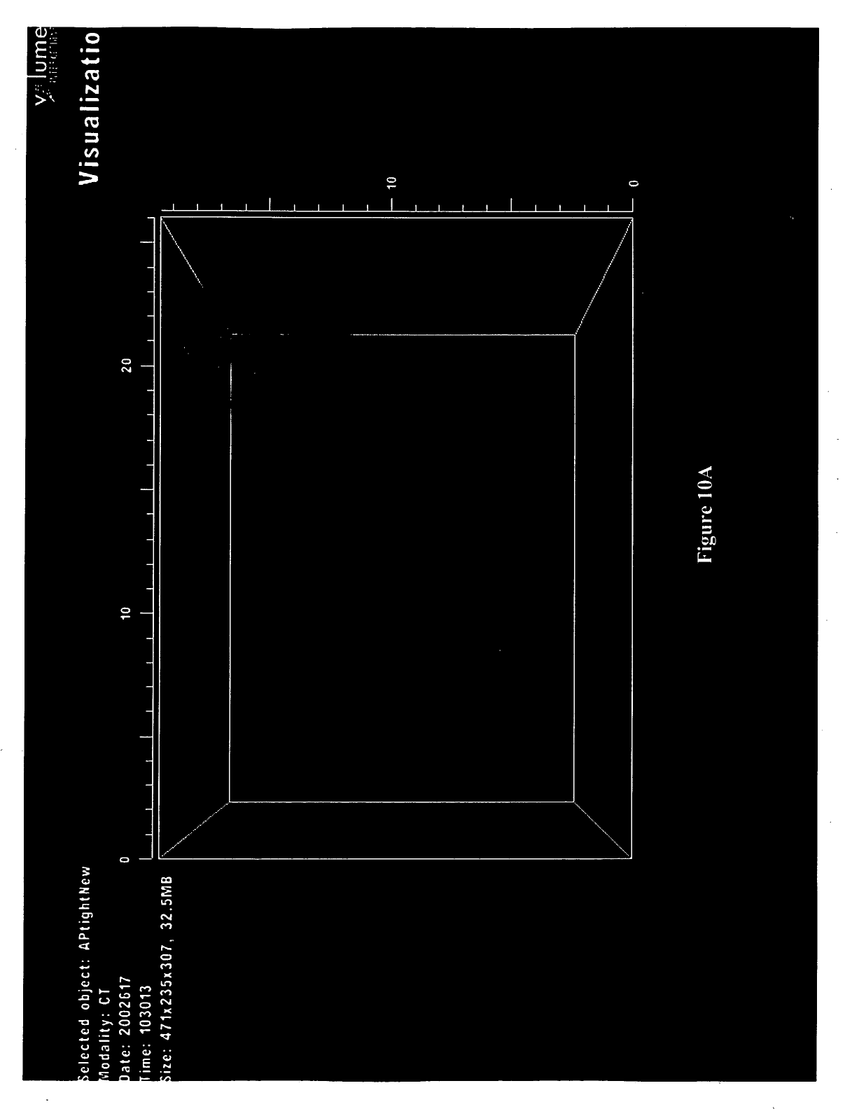

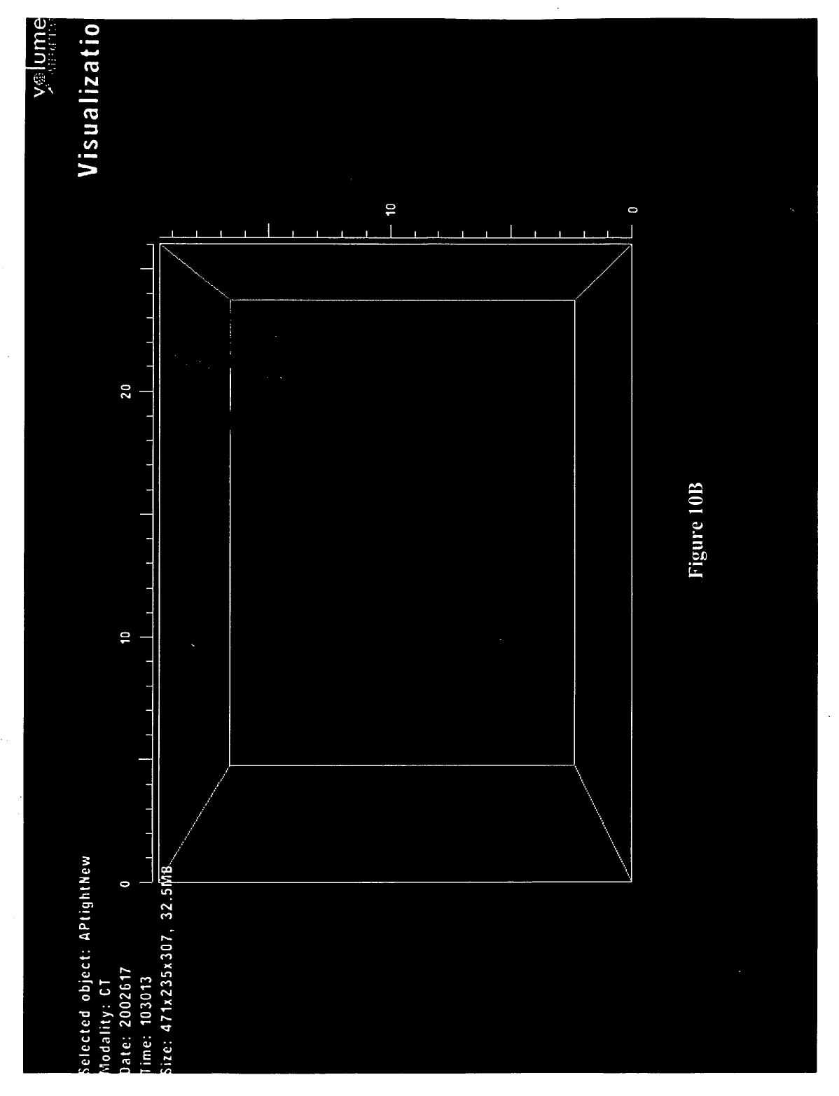

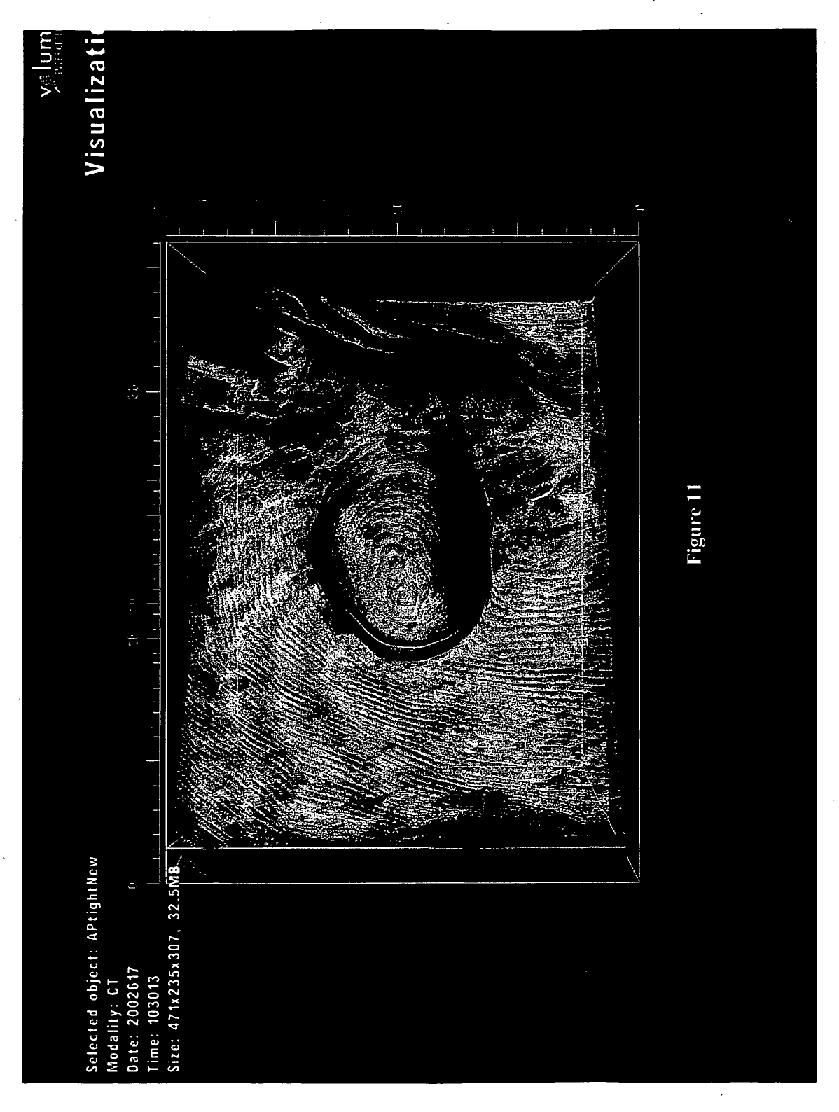

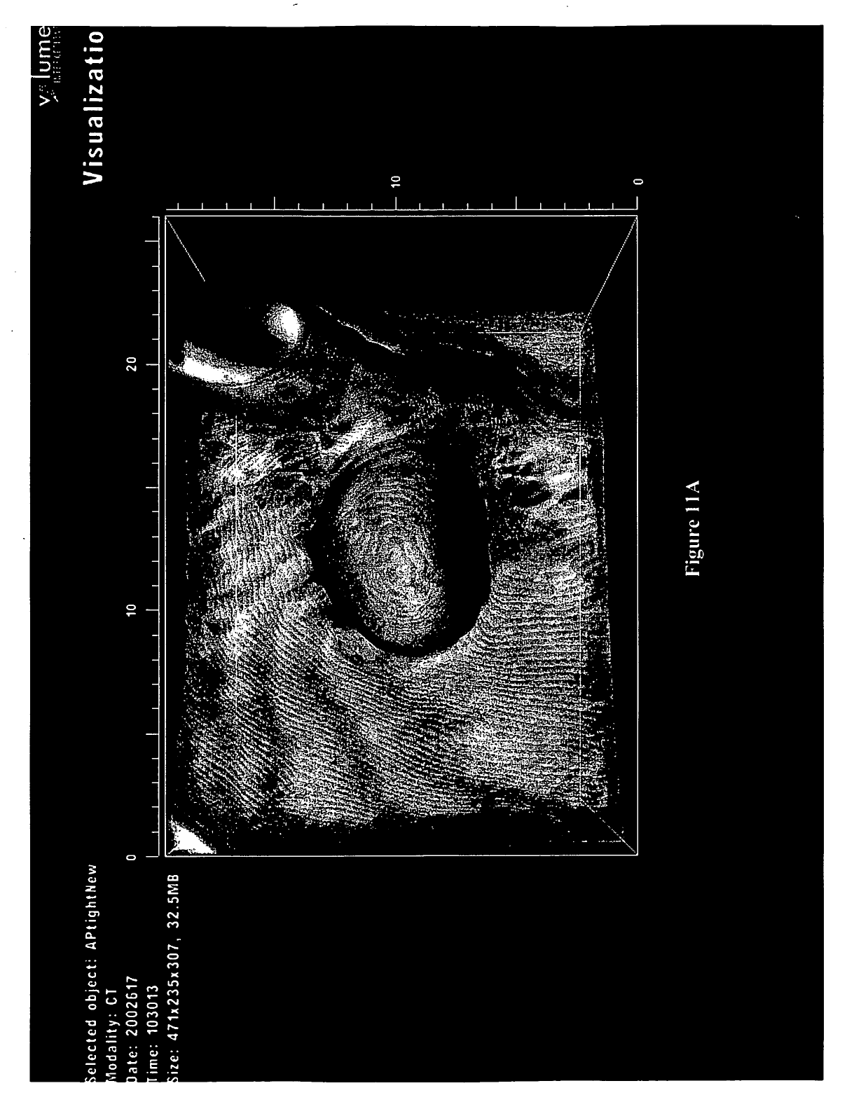

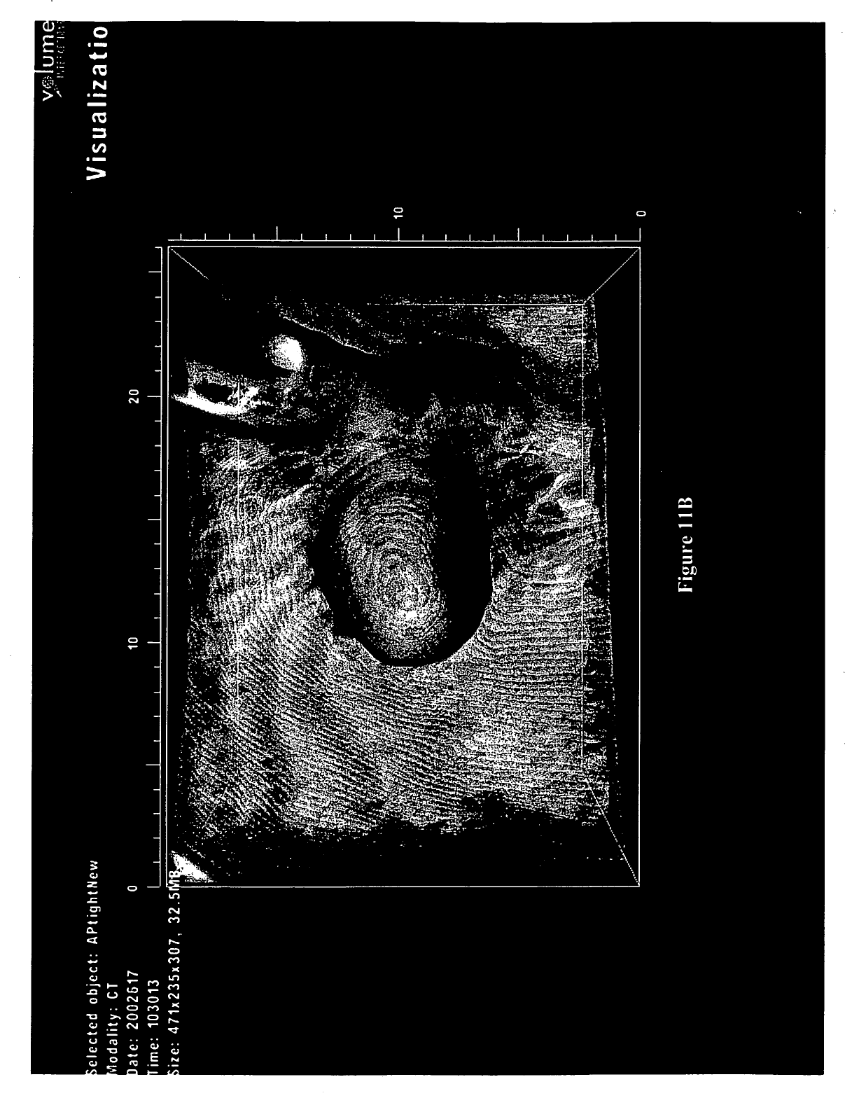

FIG. 10 depicts an exemplary magnified colon section in red-green stereo according to an exemplary embodiment of the present invention. FIGS. 10A and 10B illustrate the separate red and green channel information (shown in the figures in black and white) that may be combined to form a stereoscopic image. A polyp on an inner surface of the colon is visible. A user can magnify an area of interest for closer inspection. Here the colon segment is displayed transparently, and stereo viewing reveals that the polyp is “popping” out. FIG. 11 is an alternative view of FIG. 10 with the colon surface displayed opaquely. FIGS. 11A and 1B are black and white illustrations of the separate red and green channel information that may be combined to form a single red-green stereo image.

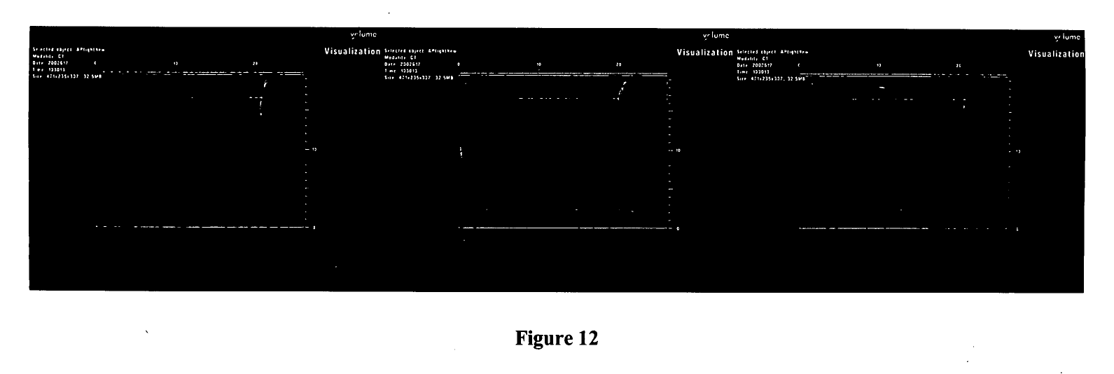

Alternatively, FIG. 12 depicts the stereo images of FIG. 10 using the cross-eyed viewing technique (FIGS. 12A and 12B, the two left most images) and the straight-eyed technique (FIGS. 12B and 12C, the two right most images). As in FIG. 10, the area of interest is magnified. Here the colon is displayed transparently, and stereo viewing reveals that the polyp is “popping” out.

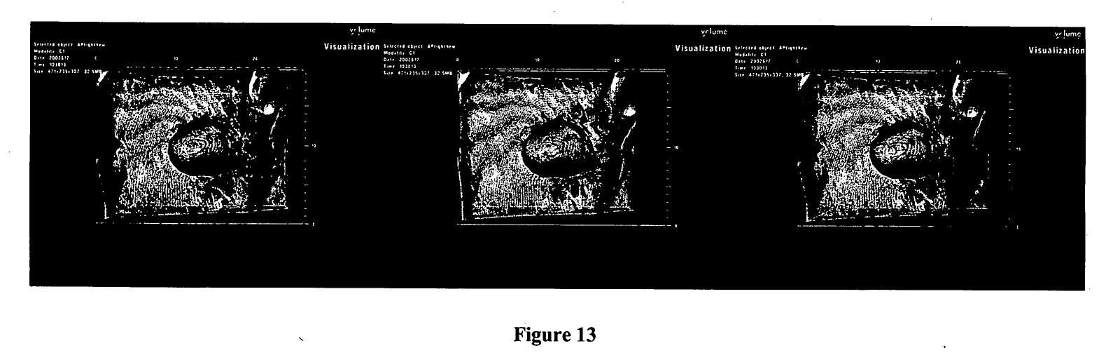

FIGS. 13 depict the stereo images of FIG. 11 using the cross-eyed viewing technique (FIGS. 13A and 13B, the two left most images) and the straight-eyed technique (FIGS. 13B and 13C, the two right most images). As in FIG. 11, the area of interest is magnified. Here the colon is displayed opaquely, and stereo viewing reveals that the polyp is “popping” out.

Shading

Exemplary display using shading effects will next be described with reference to FIGS. 14 through 20. With reference to FIG. 14, an exemplary inner surface of the colon is rendered using shading. Shading is a computer graphics technique which simulates the effect of the interaction of light with a given surface. In FIG. 14, a center line is visible running along the center of the depicted colon. As can be seen, the effects of shading are to give a user depth cues regarding folds and topographical structures within the colon.

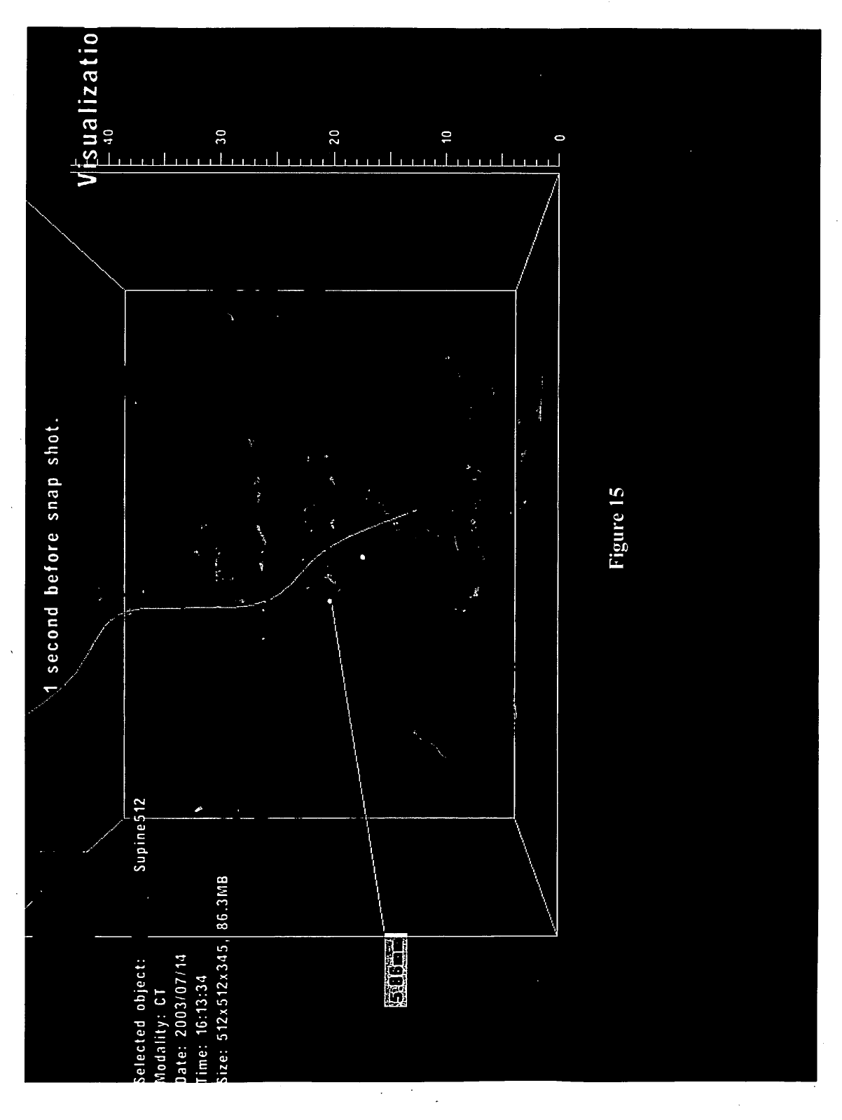

FIG. 15 is the exemplary colon surface depicted in FIG. 14, now rendered transparently, thus revealing the measurement marking of 5.86 mm at the center (to the left of the visible center line).

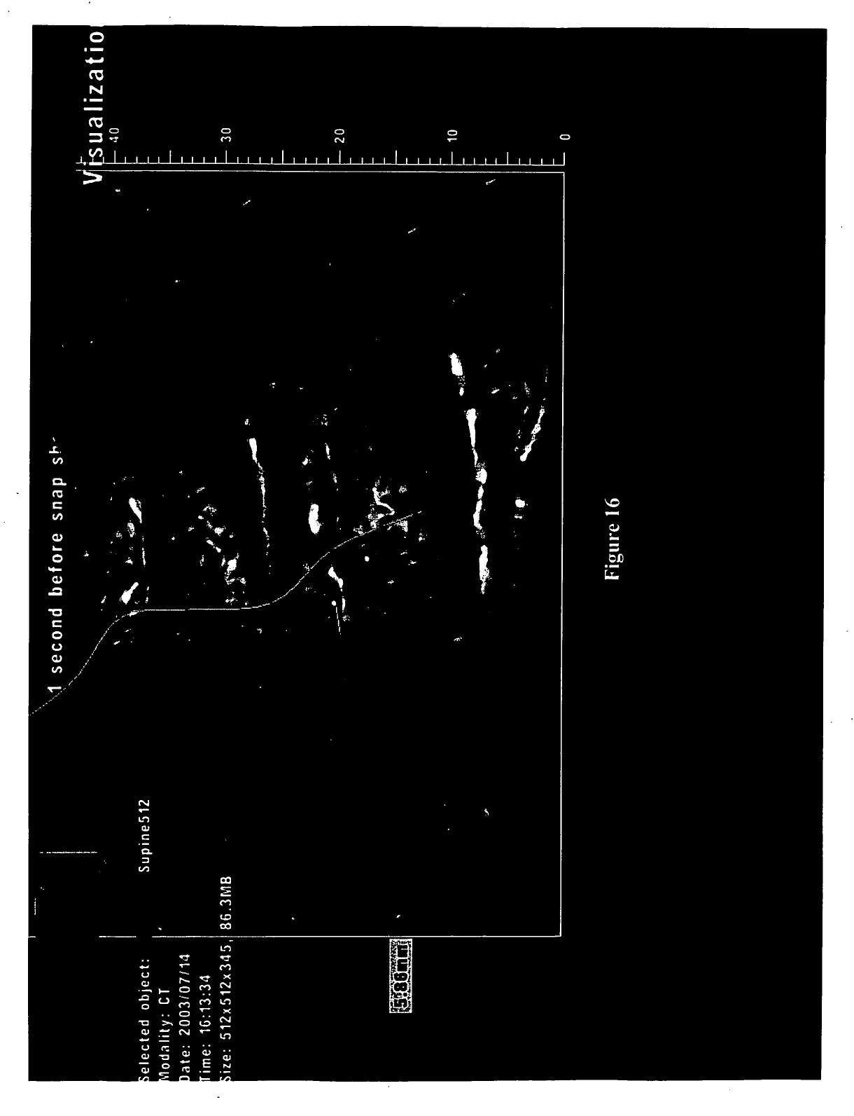

The exemplary colon section of FIGS. 14-15 is depicted in FIG. 16 using black and white opaque rendering.

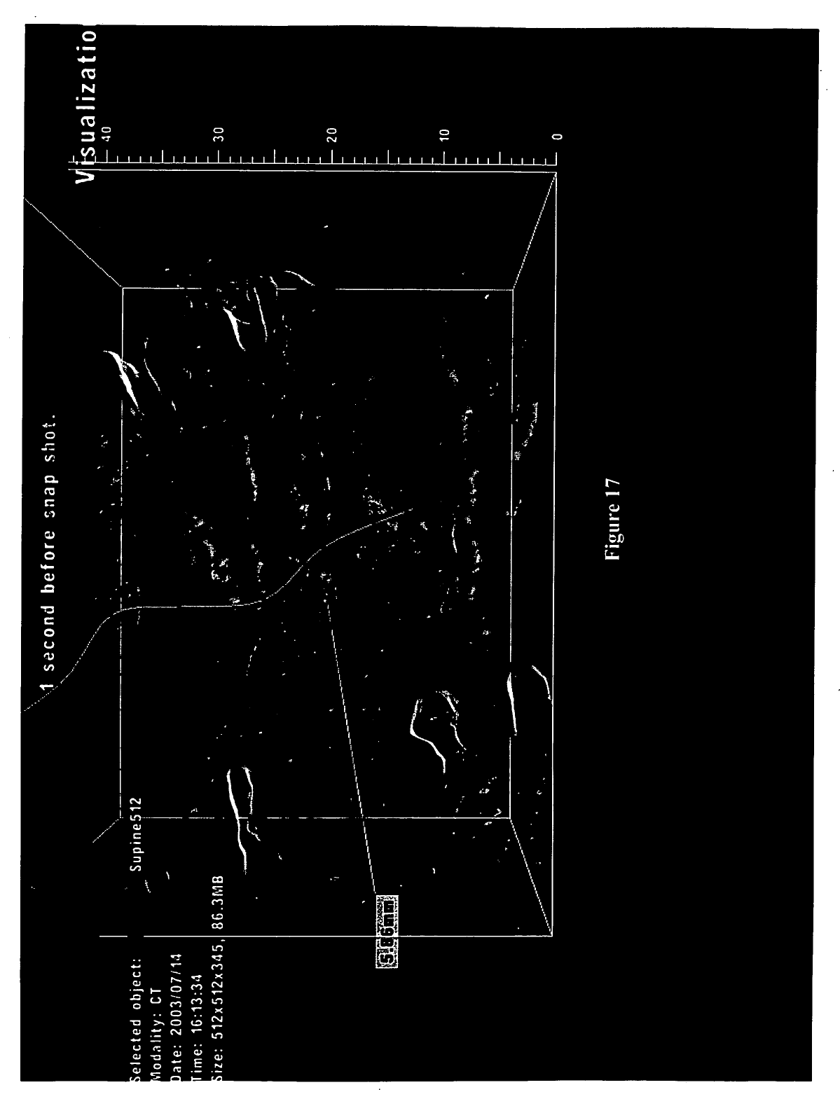

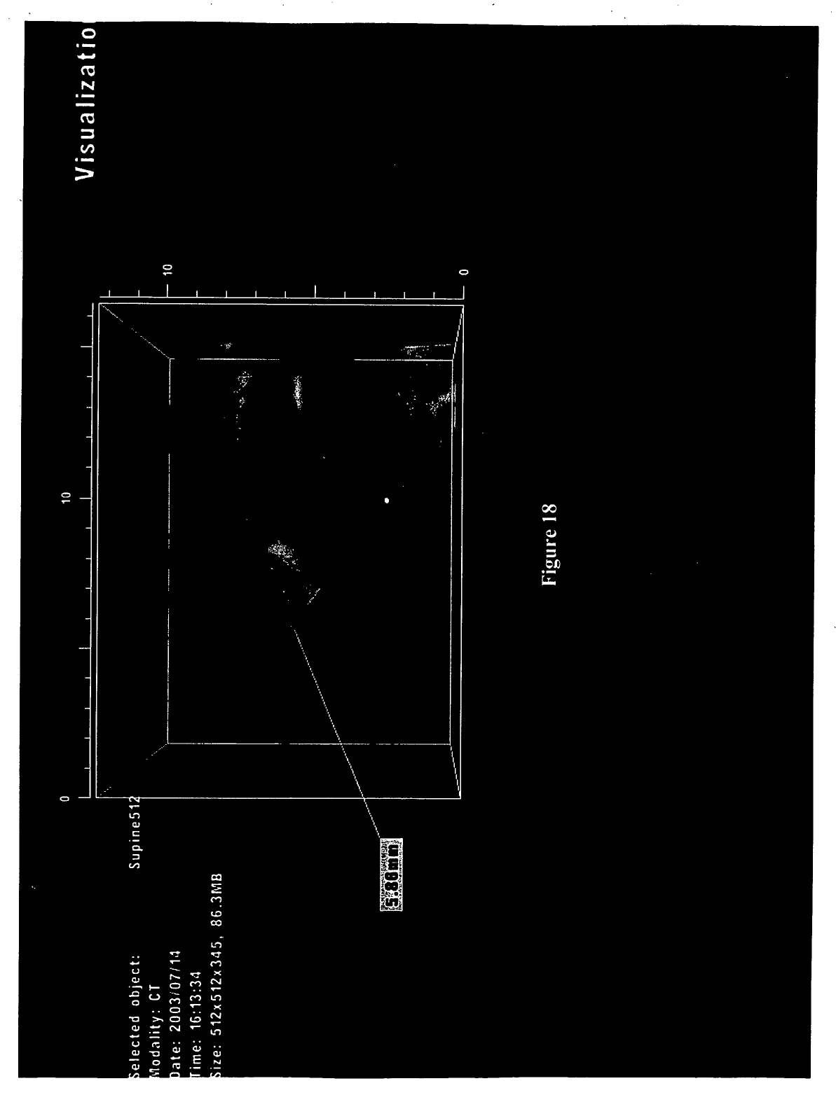

Turning to FIG. 17, the same black and white color look-up table of FIG. 16 is used, but renders the exemplary colon surface transparently, again revealing the measurement marking of 5.86 mm at the center (left of the visible center line) similar to the exemplary depiction of FIG. 15.

FIG. 18 is a magnified version of the exemplary depiction in FIG. 17, where the user has brought the area with the measurement marking of 5.86 mm into the center of the viewing box.

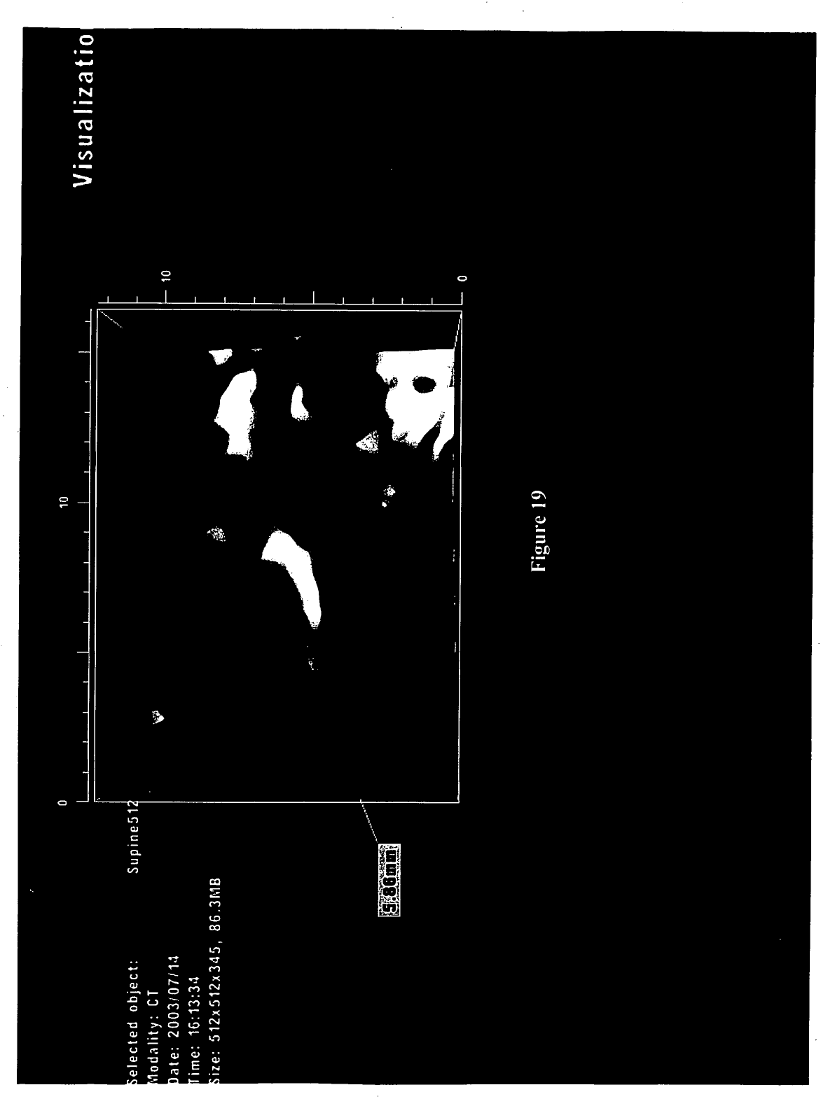

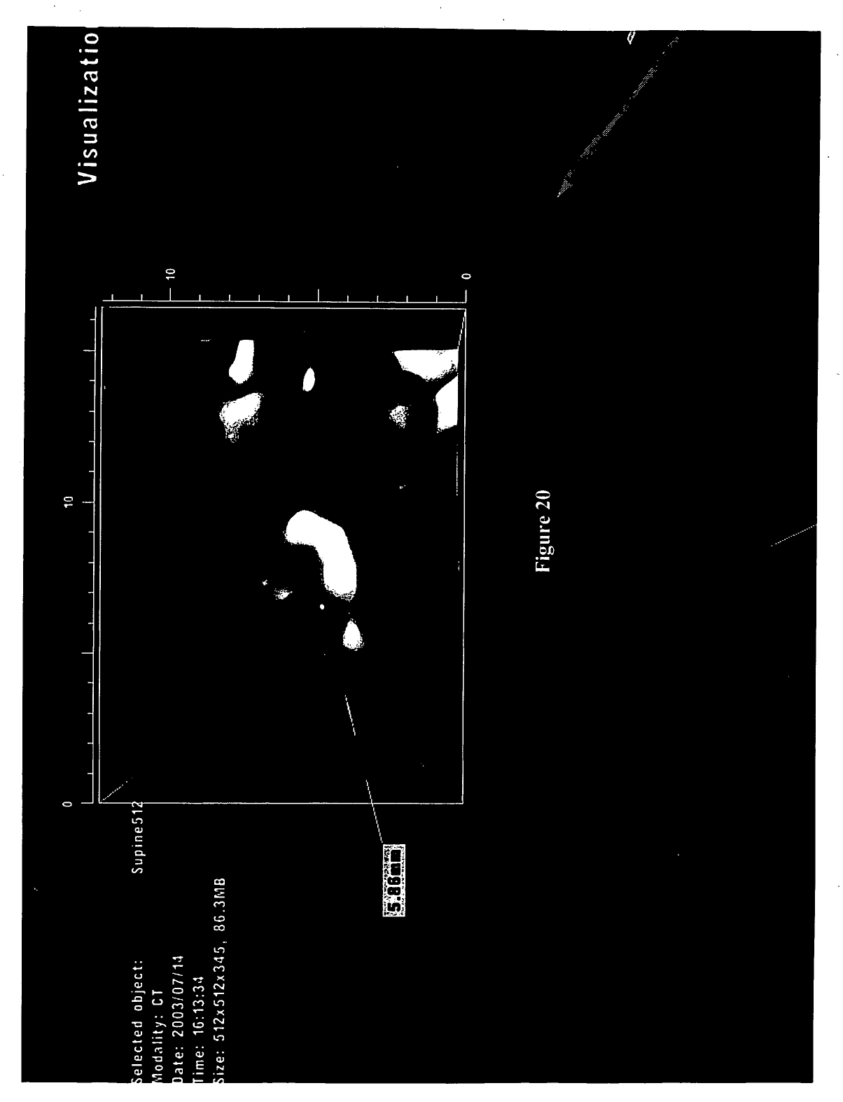

FIG. 19 is essentially a magnified portion of the area of interest as would be seen if a user started with FIG. 14, maintained the opacity and color look-up table and implemented a zoom operation. Finally, FIG. 20 is the exemplary depiction of FIG. 19 rotated somewhat to further reveal the shape of polyp. As can be seen in providing comparison of FIGS. 19 and 20, FIG. 20 depicts the colon of FIG. 19 rotated clockwise about the center line of the colon lumen if the positive direction is pointing towards the right of the figure.

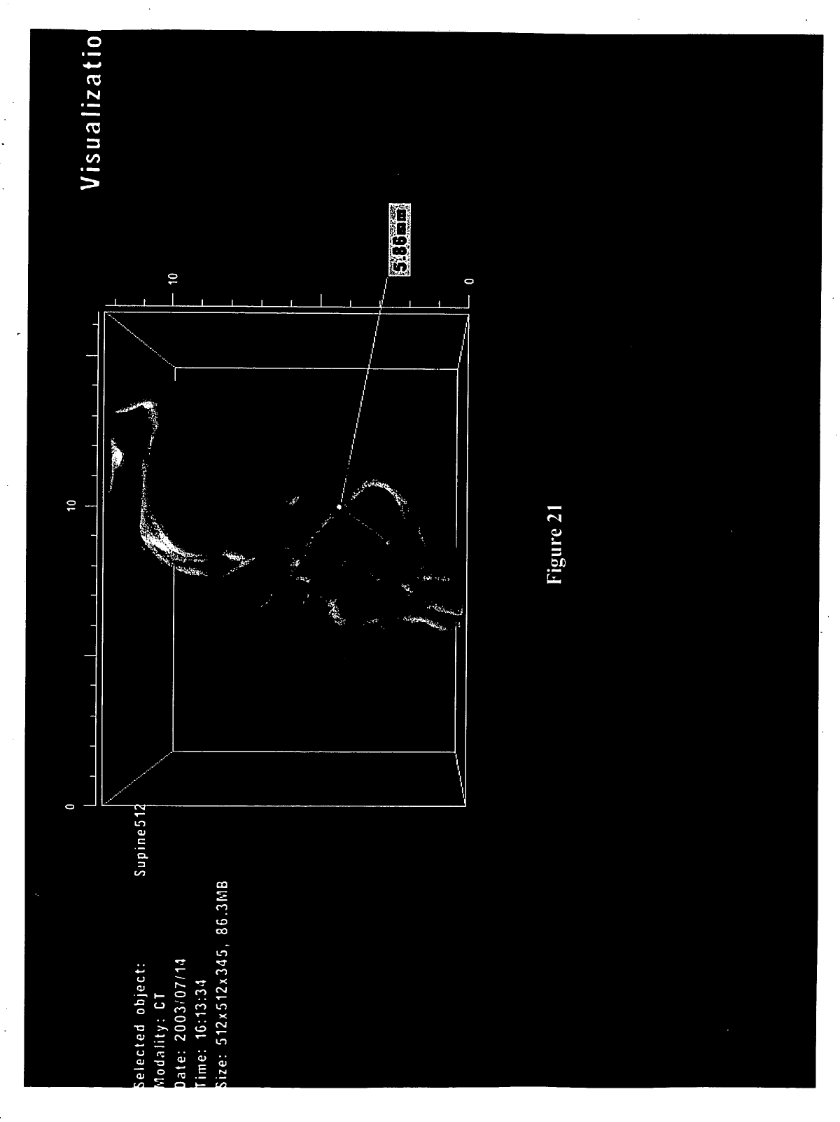

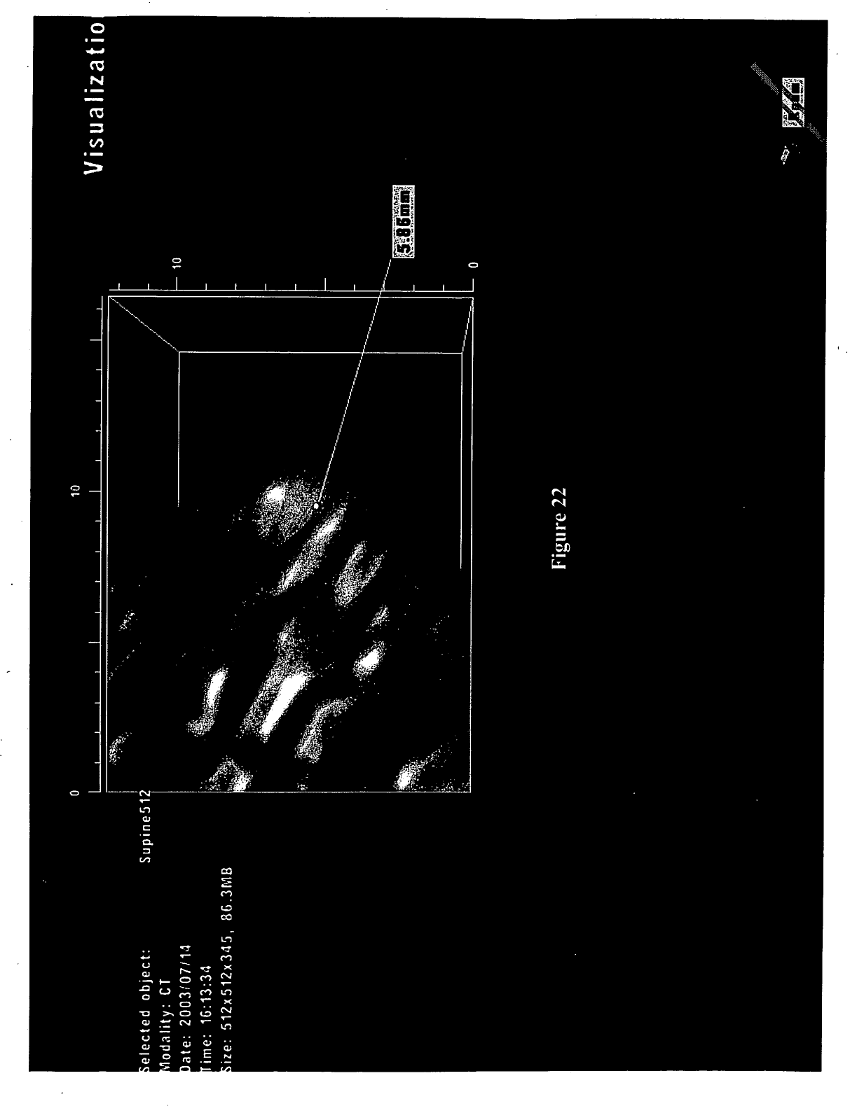

FIGS. 21-22 are exemplary depictions of an examination of a polyp using a zoom feature. In FIG. 21, a suspected polyp is rotated to reveal the voxels behind its surface. FIG. 22 illustrates the exemplary polyp of FIG. 21 with visualization changed to render all voxels in black and white.

Half and Half

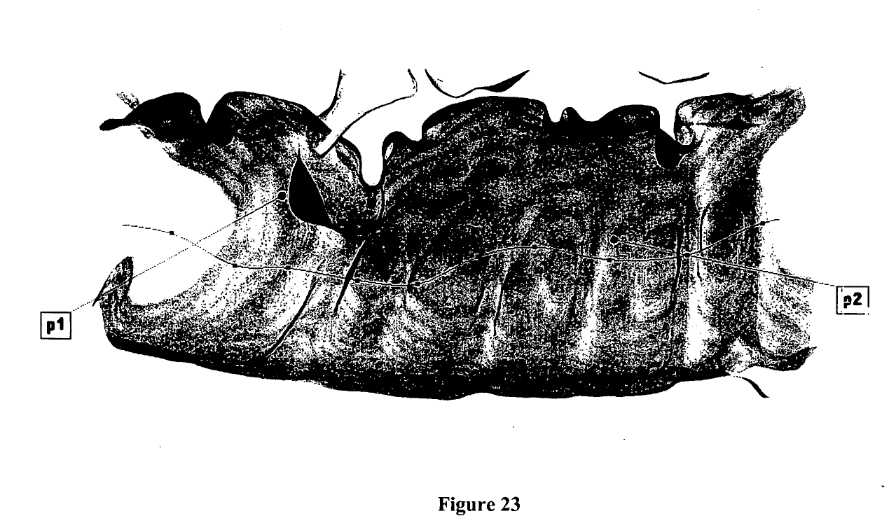

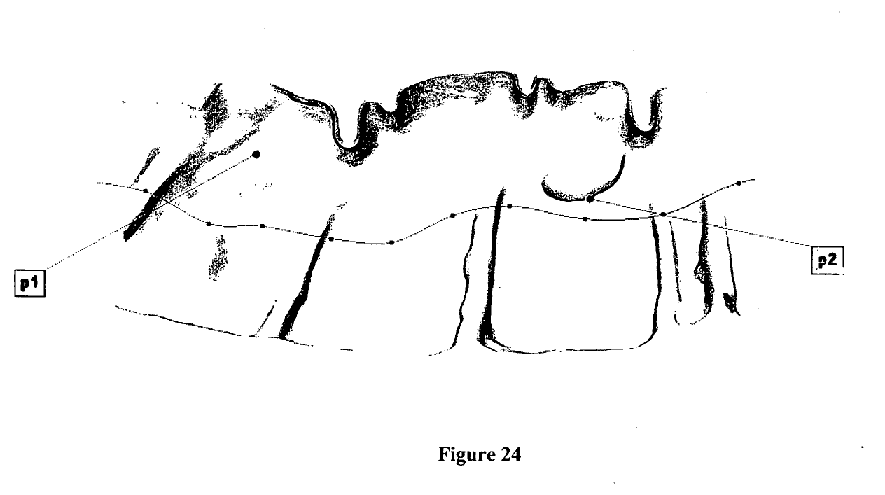

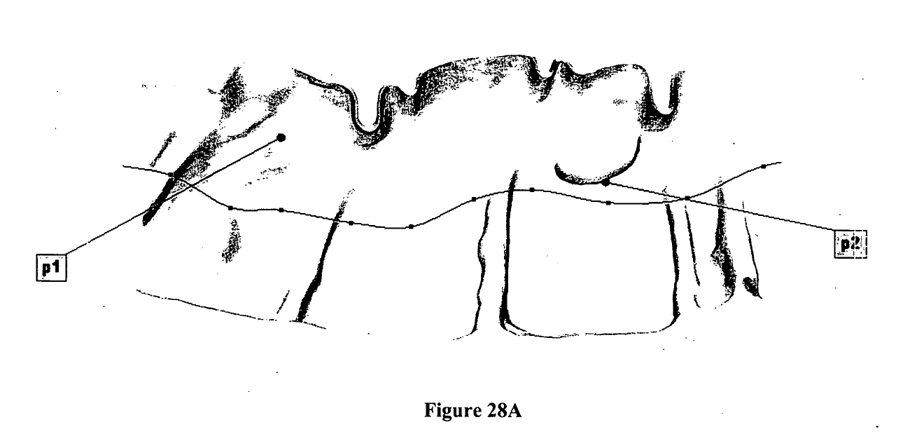

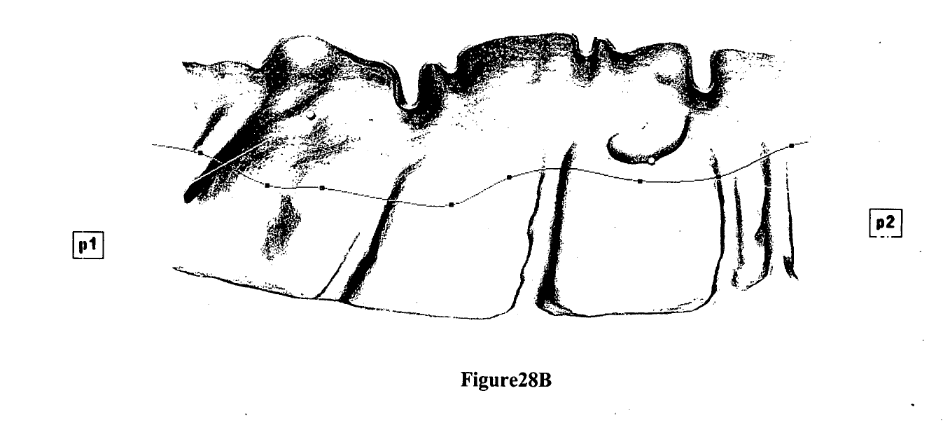

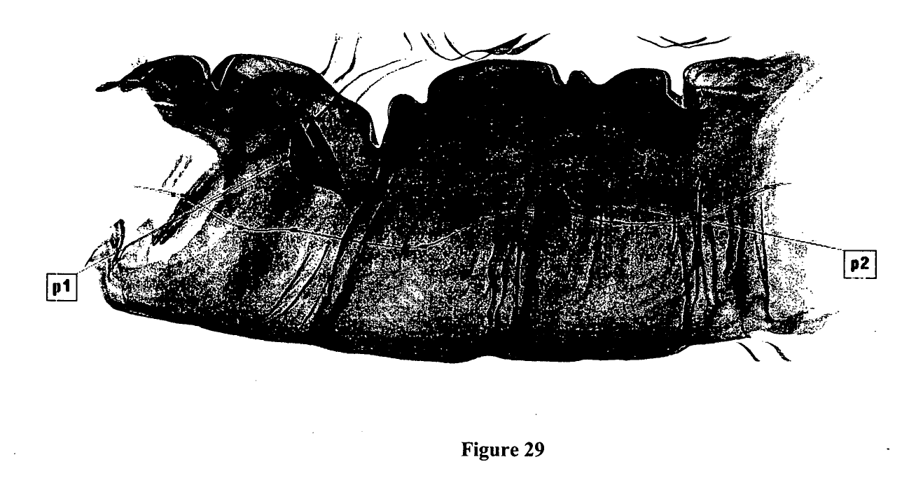

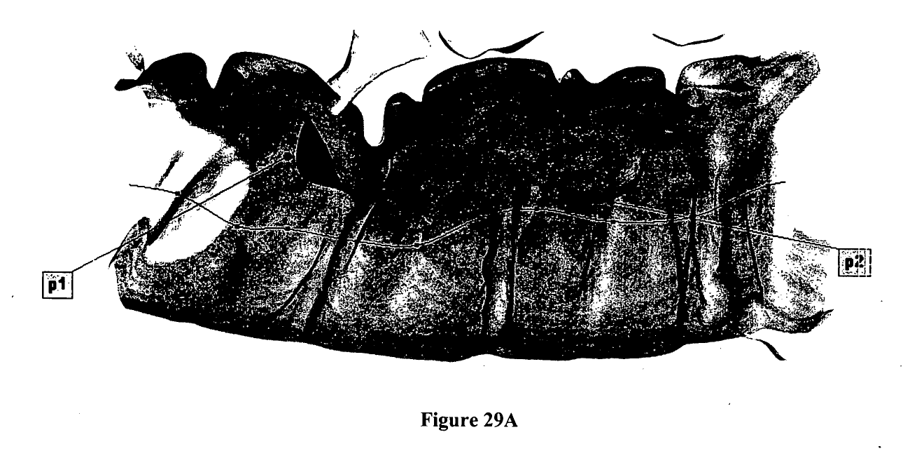

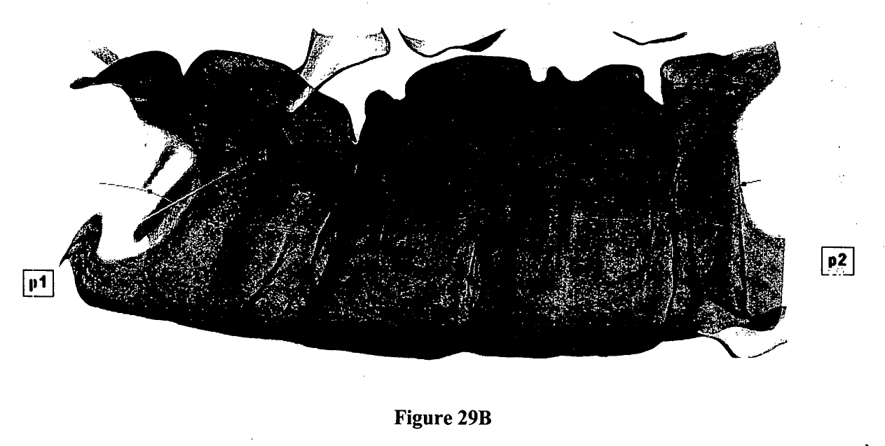

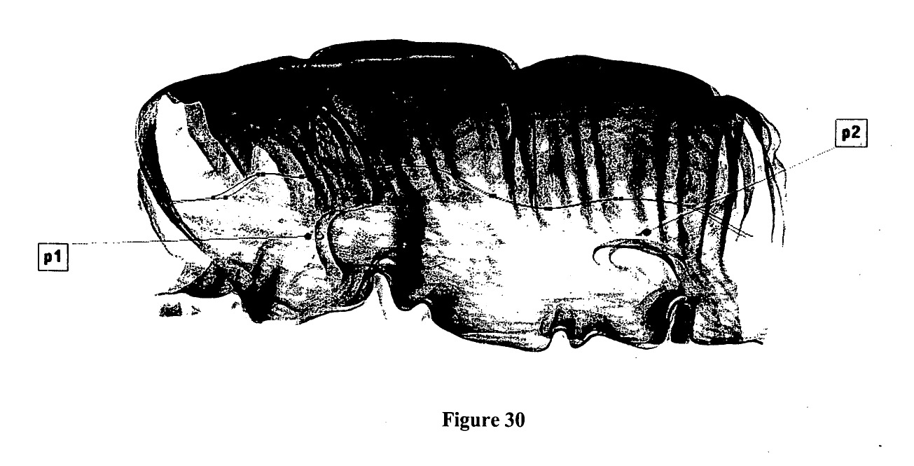

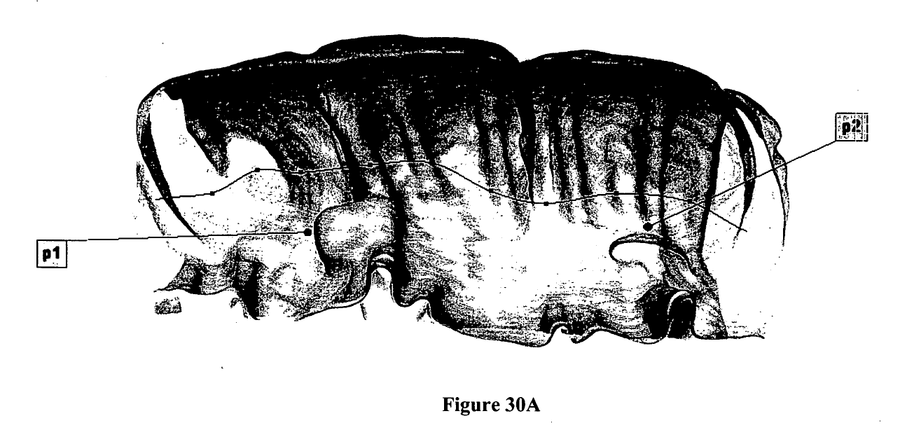

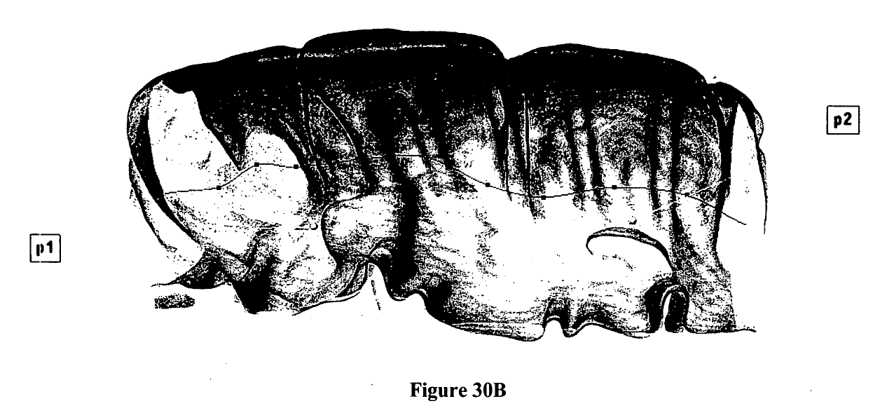

As noted above, the advantageous use of the full data available in a 3D data set of a patient's lower abdomen allows for the depiction of the colon with the user's point of view outside of it and the colon moving by on the display screen in front of a user. As further noted, this raises a potential scenario where a user may want to view a portion of the colon on the rear side that is obscured by some structure on the forward facing side of the colon. This problem can be solved in exemplary embodiments according to the present invention by displaying the colon, either just the interface between the colon lumen and the inner colon wall, or the inner wall with surrounding tissues, using two sets of display parameters. This is known colloquially as a “half and half” display and shall be described in detail with reference to FIGS. 23 through 30.

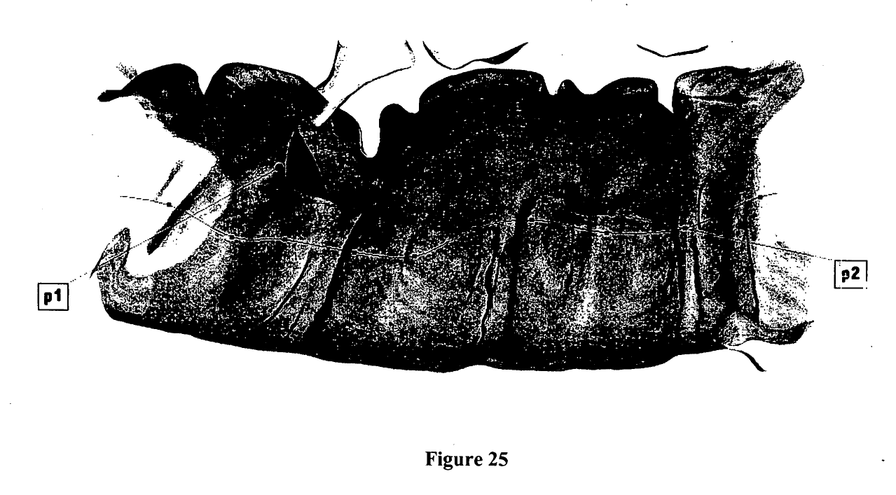

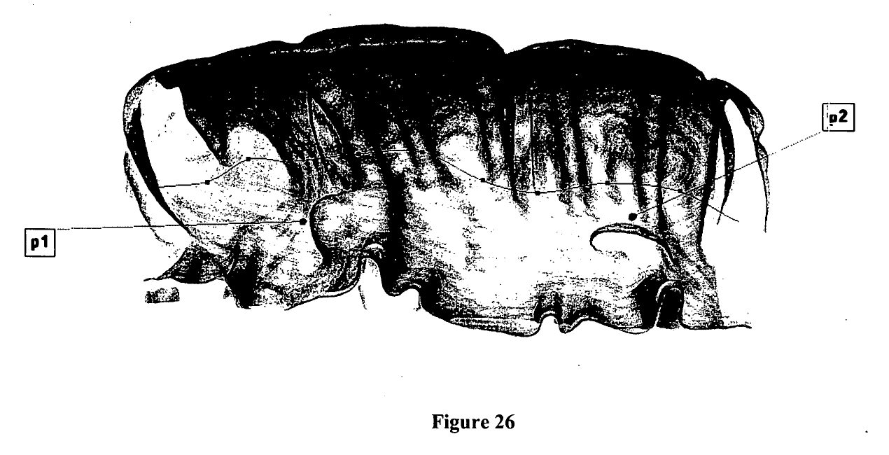

With reference to FIGS. 23 through 25, an exemplary colon section is displayed according to an exemplary embodiment of the present invention. According to this embodiment, the colon is split into two along a virtual plane parallel to the display screen and containing the centerline of the colon lumen. The portion of the colon on the user's side of the virtual plane is displayed using one set of display parameters and the portion of the colon on the other side of the virtual plane is displayed using another set of display parameters. With reference to FIG. 23, the front portion or half of the exemplary colon section is displayed transparently, and in FIG. 24 the other half of the same colon is displayed opaquely. With reference to FIG. 25, the separate halves of FIGS. 23 and 24, respectively, are superimposed, showing the entire colon wall. FIG. 26 is the exemplary depiction of the exemplary colon of FIG. 25, where the colon is rotated 180° around its center line (in a clockwise direction if the positive direction of the center line is taken to be pointing to the right of the figure).

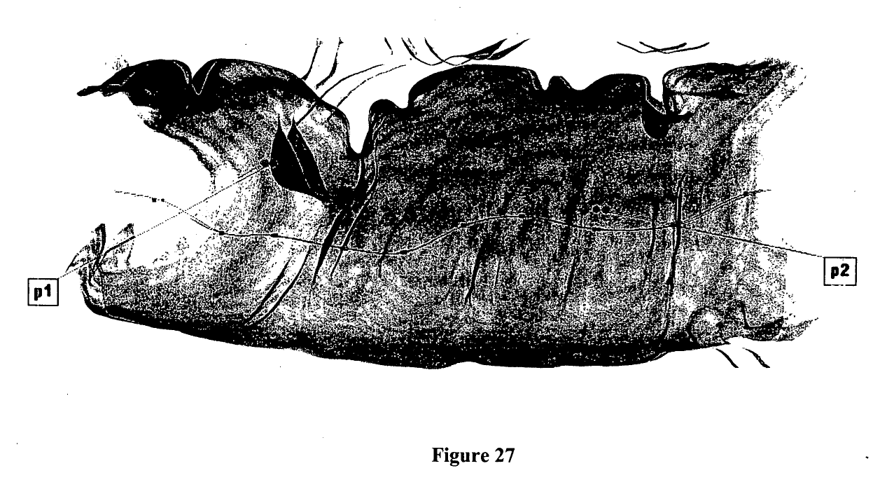

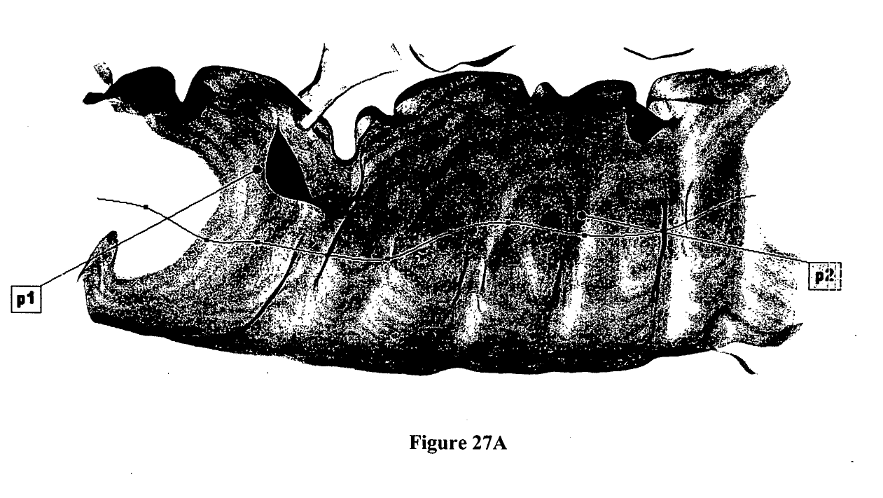

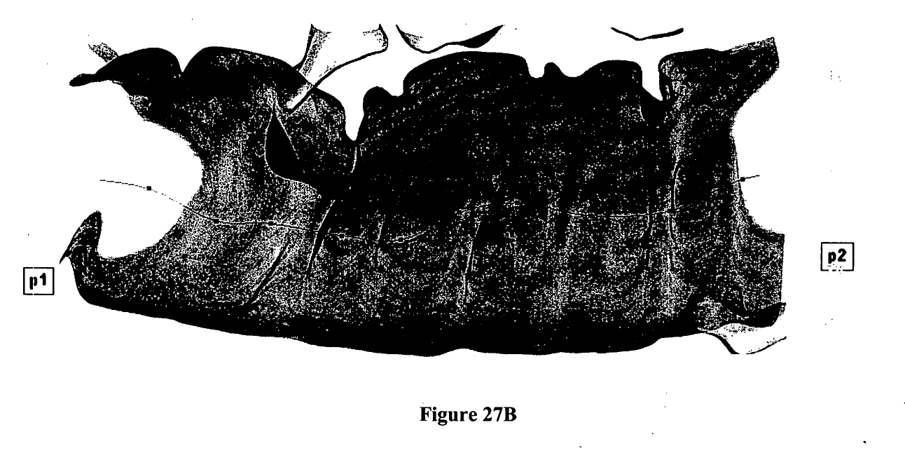

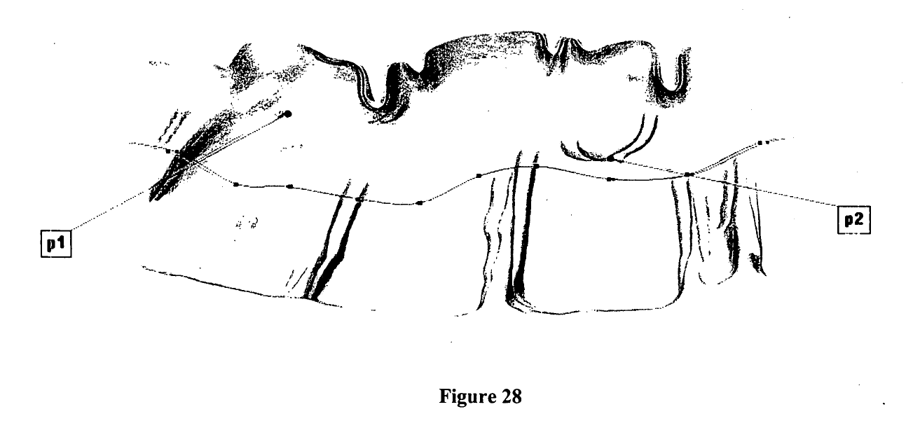

FIGS. 27 through 30 are stereo versions of FIGS. 23 through 26, respectively, according to an exemplary embodiment of the present invention. Similarly to the previous stereoscopic figures described above, FIGS. 27 through 30 illustrate both complete color red-blue stereo images, as well as black and white depictions of the separate red and blue channels stereo information. A stereoscopic image may be formed by combining the red and blue channels to form a composite image. As noted above, stereo display of a tube-like organ allows a user to perceive more acutely the depths and acquire thereby a better mental impression of the three-dimensionality of the tube-like organ under scrutiny.

The half-half functionality could also be used to juxtapose a section of a colon rendered from the prone CT scan and the same section rendered from the supine CT scan, in exemplary embodiments of the present invention.

Fly-Through

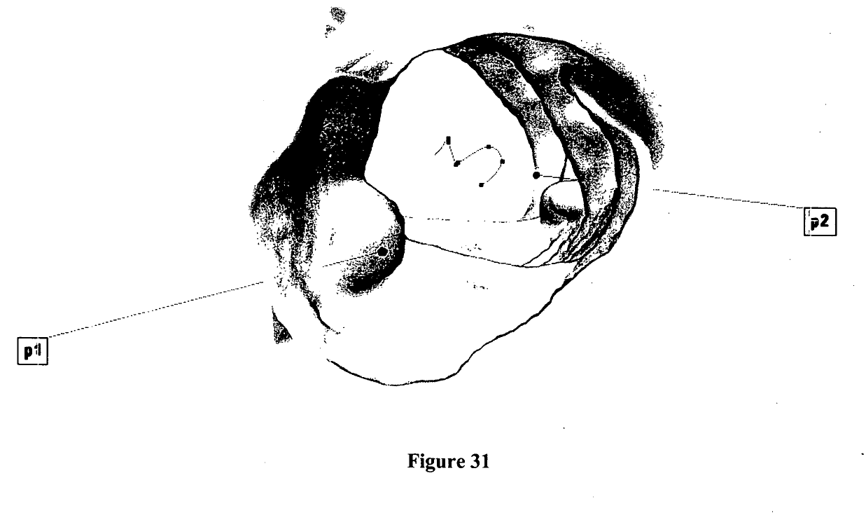

FIGS. 31 through 37 depict a fly through view of an exemplary colon according to an exemplary embodiment of the present invention. Viewing the exemplary colon depicted in FIGS. 23 through 30 in this 90° rotated orientation, a user can travel down the center line of a colon and join the endoscopic view as described above. Given the 90° rotation, reference point P1, which was on the left of the figure in the lumen viewer perspective is now in the foreground of the figure in the endoscopic or fly through perspective. Reference point P2, accordingly, which was at the left of the figure in the lumen viewer perspective (i.e., the perspective where the user's viewpoint is outside the luminal organ, as shown, for example, in FIG. 7), is now at the background of the figure in the fly through or endoscopic perspective.

In FIGS. 31 through 34, a user successively moves from a starting point somewhere rearward of P1, through P1, and to a point near and approaching P2. Additionally, visible in each of FIGS. 31 through 34, respectively, is the centerline (indicated in blue in the color figures) of the colon, which can be calculated and displayed according to an exemplary embodiment of the present invention. It is noted that the centerline is not depicted in the scan data, but is rather calculated from knowledge gleaned from the scan data where the colon lumen and inner colon wall interface lie. Its curvilinear shape is due to the irregular twists, turns and translations through the 3D space of a patient's lower abdomen.

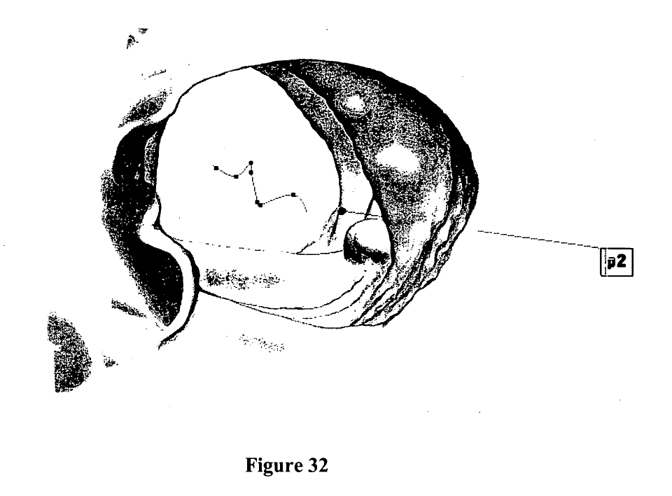

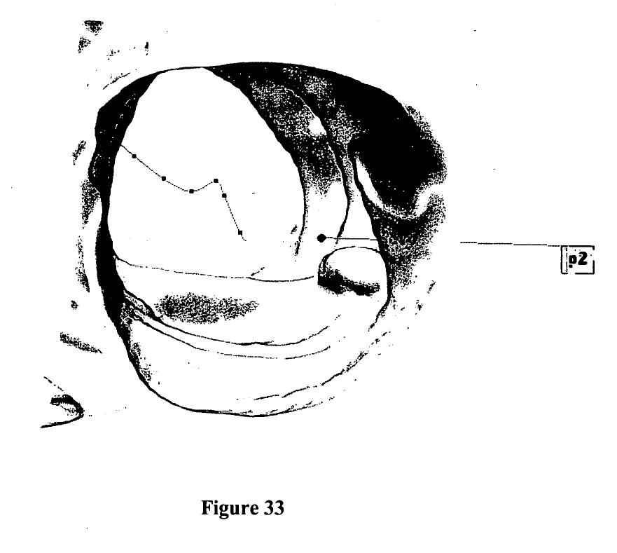

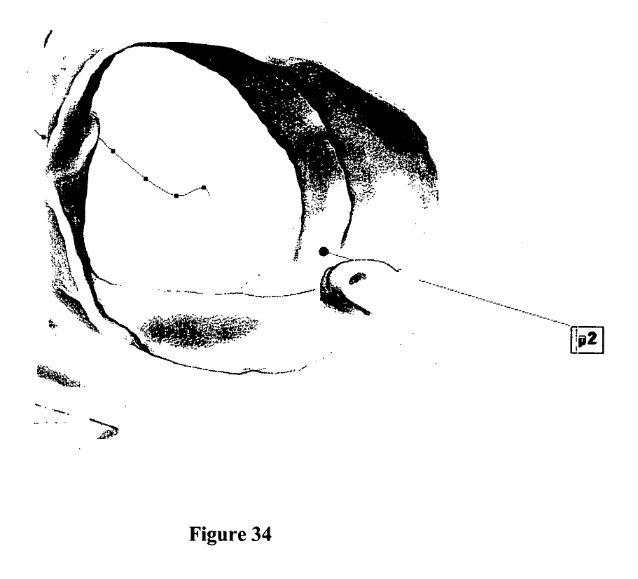

As can be seen from a comparison of FIGS. 31 through 34, respectively, there are two suspect structures within the colon which may be polyps. One of these structures, visible only in FIG. 31 at the bottom left of the colon is labeled with reference point P1 in its approximate center. With reference to FIG. 32, P1 is now out of the view of the display, being at a Z value closer to the user than the virtual cut plane which marks the user ward closest Z position for which colon is rendered visible. In FIG. 32, the back portion of the possible polyp is visible at the bottom left foreground of the picture in a cross-section of the colon wall sitting at the top of this potential polyp. In FIG. 33, the user's viewpoint has moved beyond that reach entirely. However, in FIG. 33, somewhat towards the user of reference point P2 there is another structure at the bottom right of the colon which is also a potential polyp. In FIG. 34, the colon wall associated with this potential polyp is cut approximately in half by the virtual cut plane.

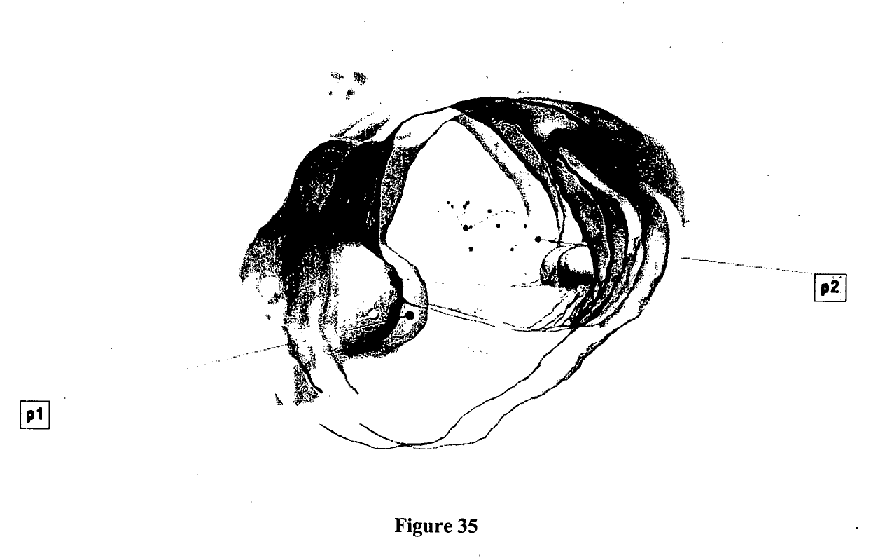

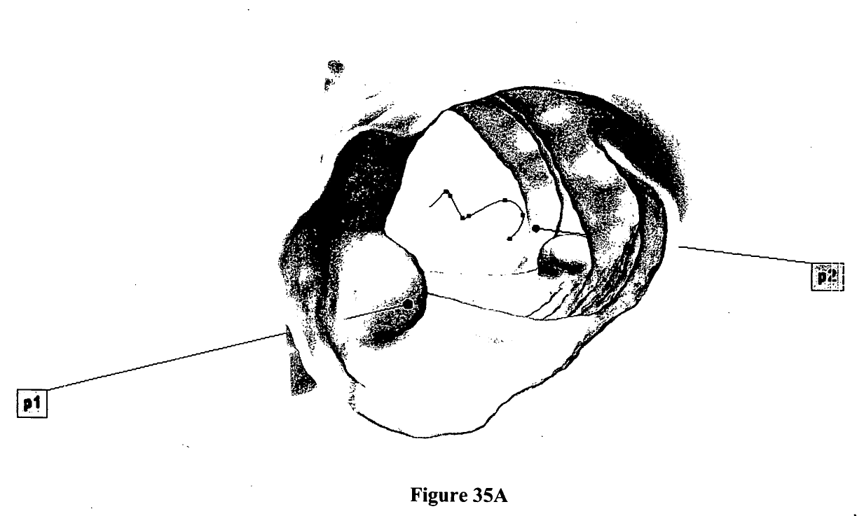

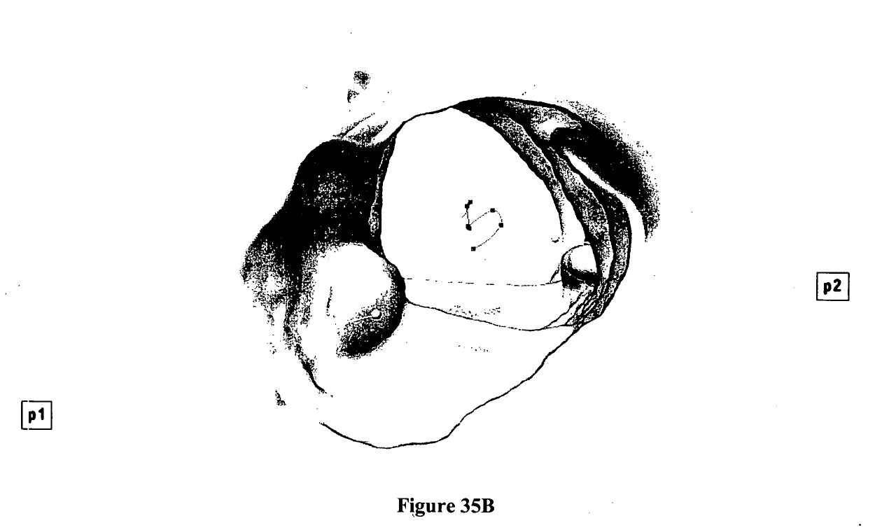

As shall be described below, according to exemplary embodiments of the present invention, a user can visualize more than just the colon wall and thereby inspect the inner tissues of suspect regions such as those discussed above, being the reference points P1 and P2. FIG. 35 is a stereoscopic rendering of the exemplary colon sample visible in FIG. 31 according to an exemplary embodiment of the present invention. FIGS. 35A and 35B are black and white illustrations of separate red and blue channels of FIG. 35 that may be combined to form a composite image, which would be a red-blue stereoscopic image. Accordingly, both reference points P1 and P2 are fully visible, as are the potential polyp structures near each of them.

High Magnification Visualization

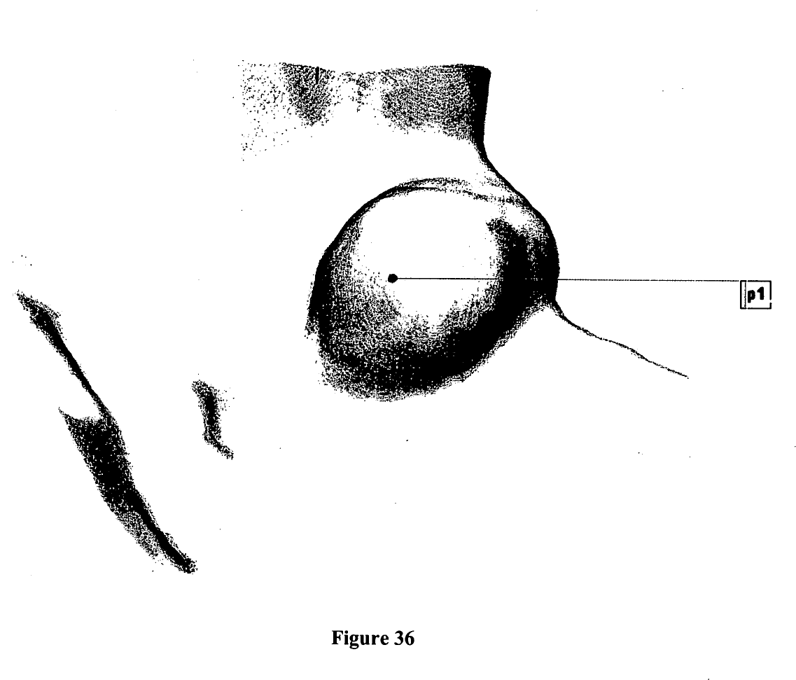

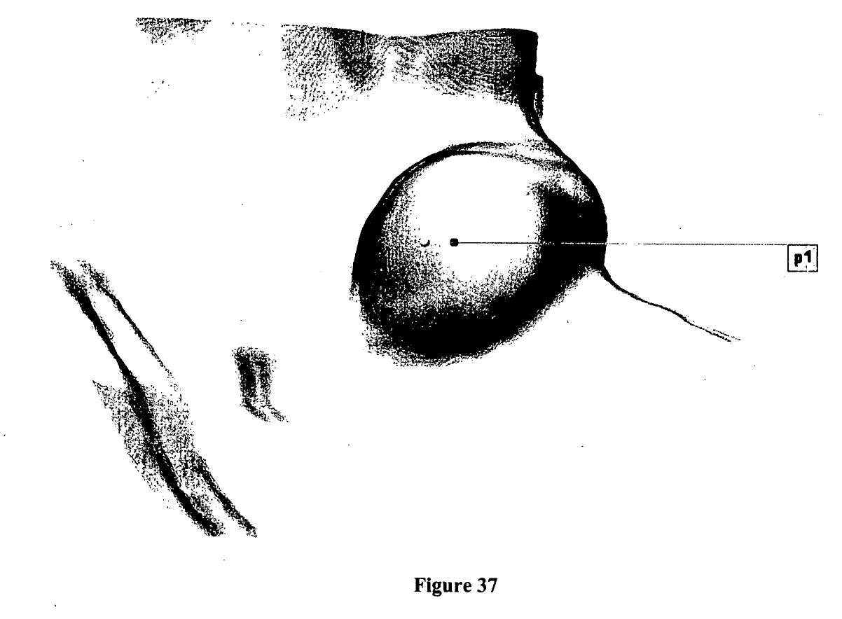

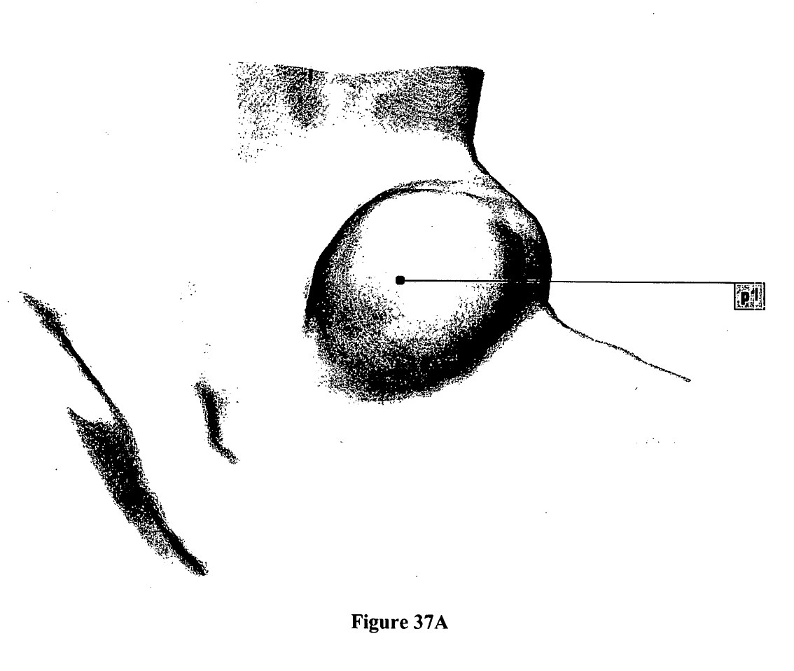

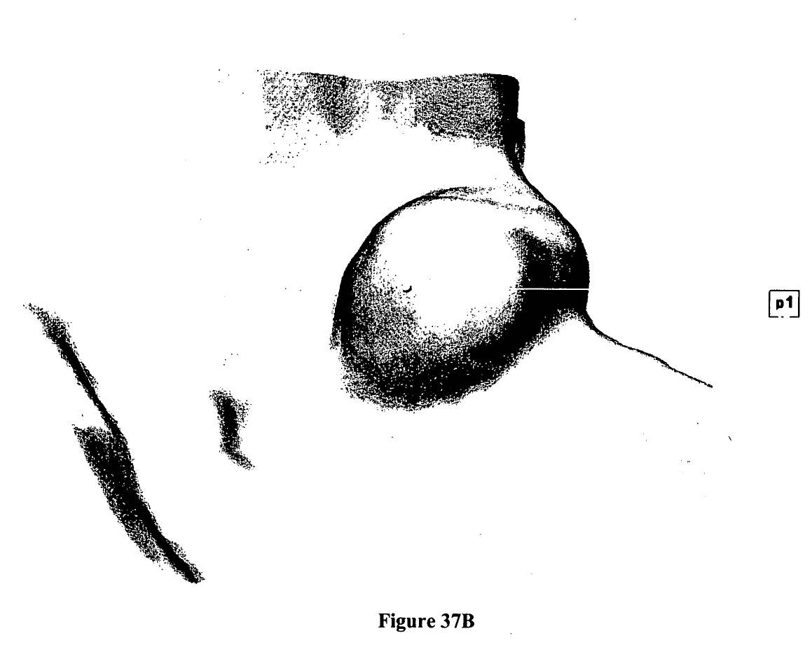

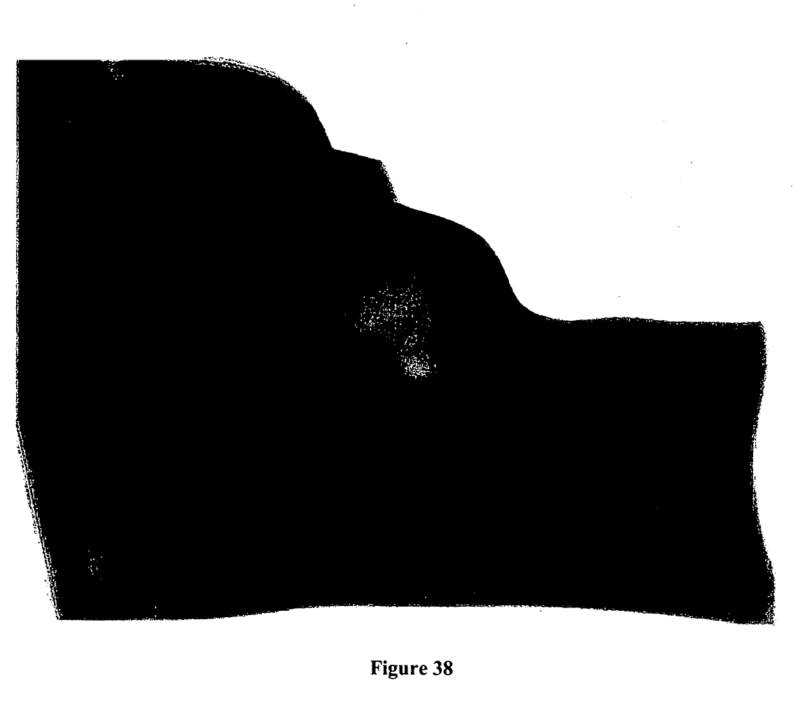

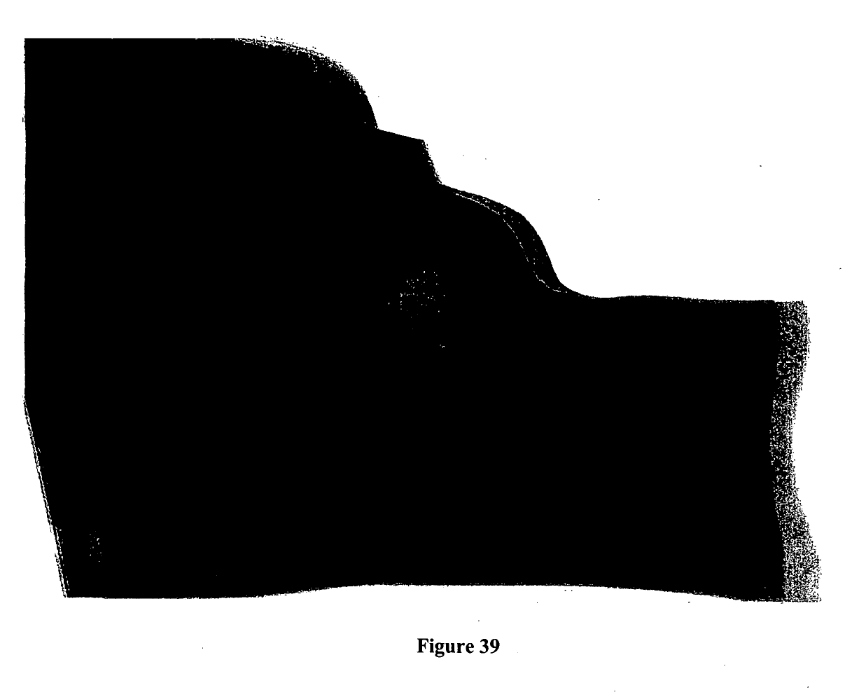

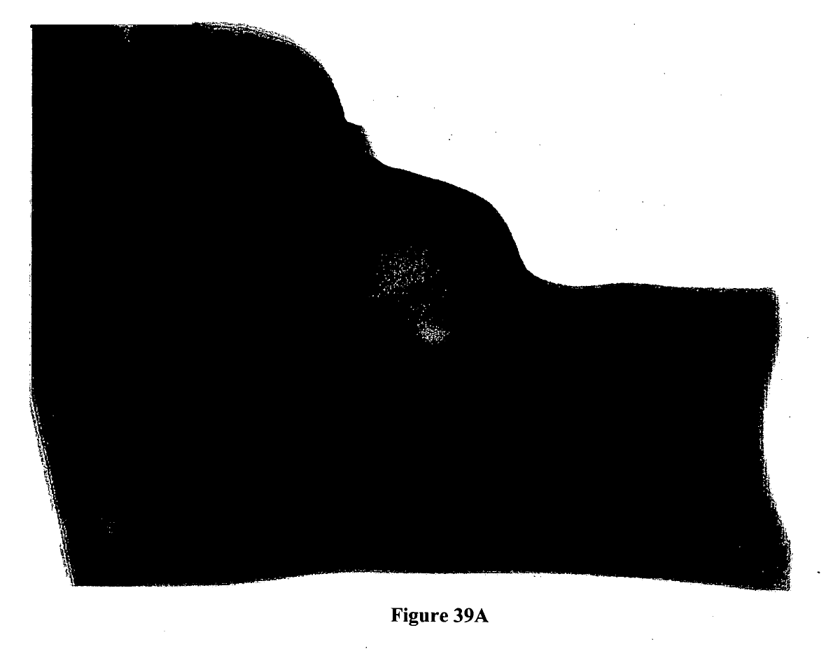

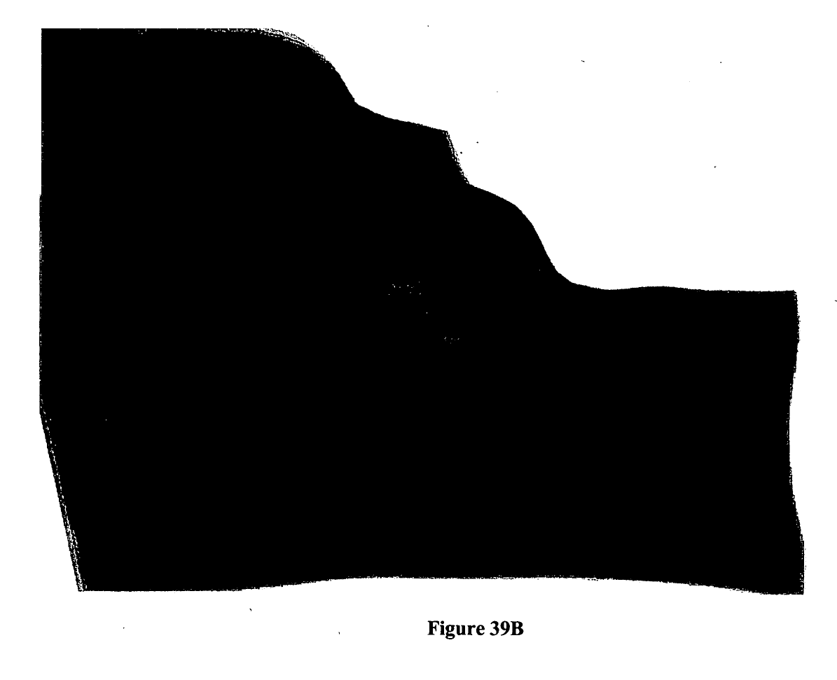

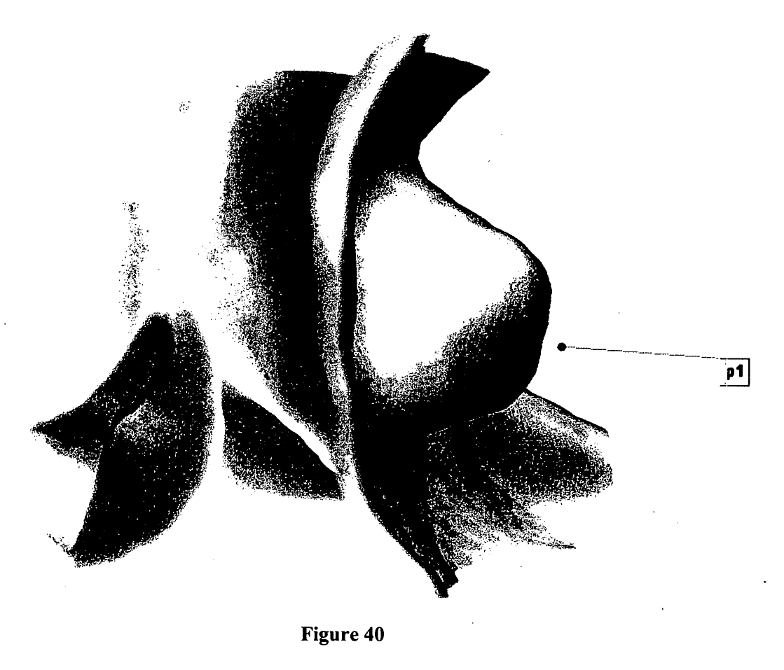

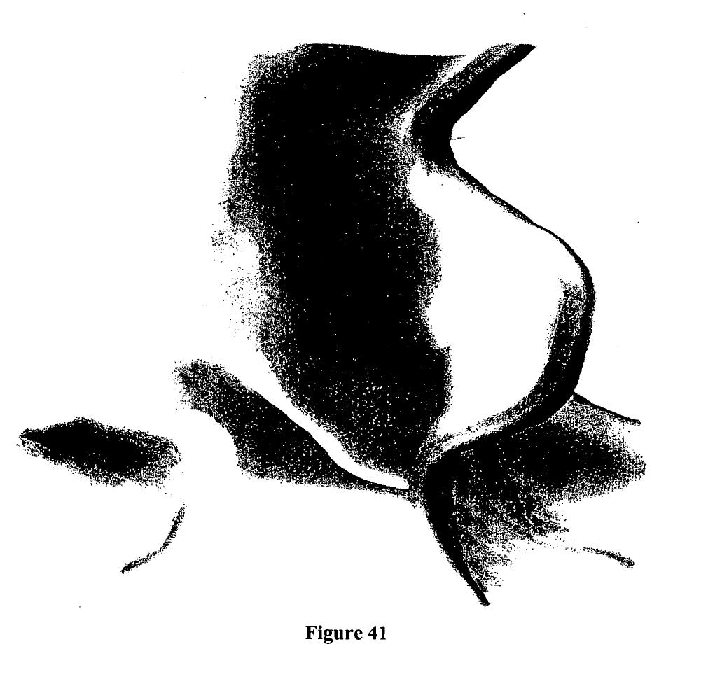

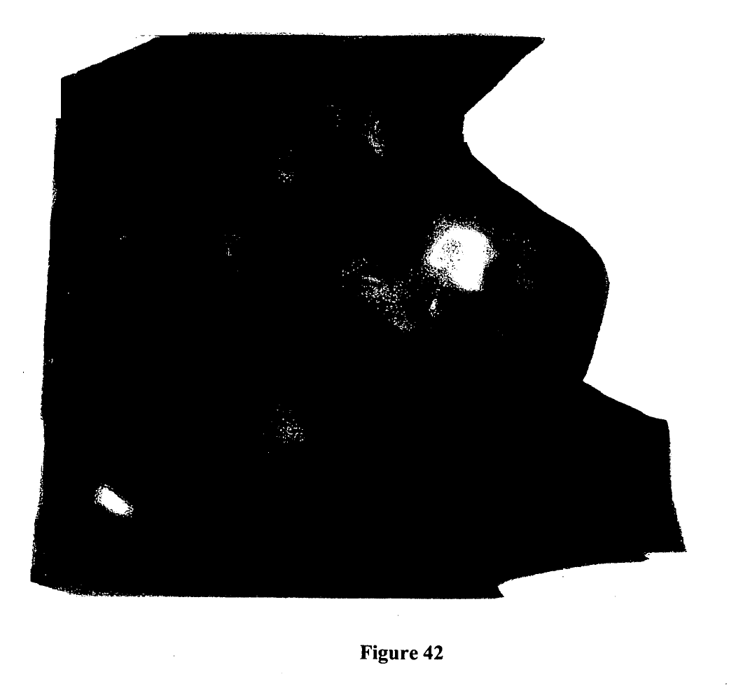

With reference to FIGS. 36 through 42, what will next be described is high magnification visualization. In exemplary embodiments according to the present invention, the user may, upon viewing a suspected area such as that near P1, with reference to FIGS. 26 and 31, in high magnification. FIG. 36 depicts high magnification of the suspected polyp to which the reference point P1 was attached. The depiction in FIG. 36 is a magnified view of the suspected region as depicted in FIG. 31. In exemplary embodiments according to the present invention, a user, using imaging system interface controls, would zoom into or magnify the area surrounding reference point P1. As can be seen with reference to FIG. 36, reference point P1 is approximately in the center of the depicted view. FIG. 37 is a stereoscopic display of the exemplary colon depicted in FIG. 36 according to an exemplary embodiment of the present invention. FIGS. 37A and 37B represent black and white illustrations of the separated red and blue channels of the red-blue stereo image of FIG. 37. The combination of FIGS. 37A and 37B into a color composite image would form a red-blue stereoscopic image. FIG. 38 is a depiction of the exemplary colon section depicted in FIGS. 36 and 37, respectively, rotated approximately 45° counterclockwise and rendered using a slightly different color look-up table for enhanced viewing. FIG. 39 is the exemplary depiction of FIG. 38 using red-blue stereo. FIGS. 39A and 39B are black and white illustrations of the separate red and blue channels of the red-blue stereo image of FIG. 39. The combination of FIGS. 39A and 39B into a composite color image would form a red-blue stereoscopic image. FIG. 40 is the exemplary suspected polyp region depicted in FIG. 36 rotated 90° around the suspected polyp center of rotation so that it can be inspected from another perspective. FIG. 41 is the exemplary colon section depicted in FIG. 40 moved closer to the user cutting through the surface of the exemplary polyp to allow inspection of the back of the structure. Finally, FIG. 42 is a high magnification depiction of the suspected polyp depicted in FIG. 41 using a different visualization mode to reveal inside voxel values.

Tri-Planar View/Three-Dimensional Cross Sections

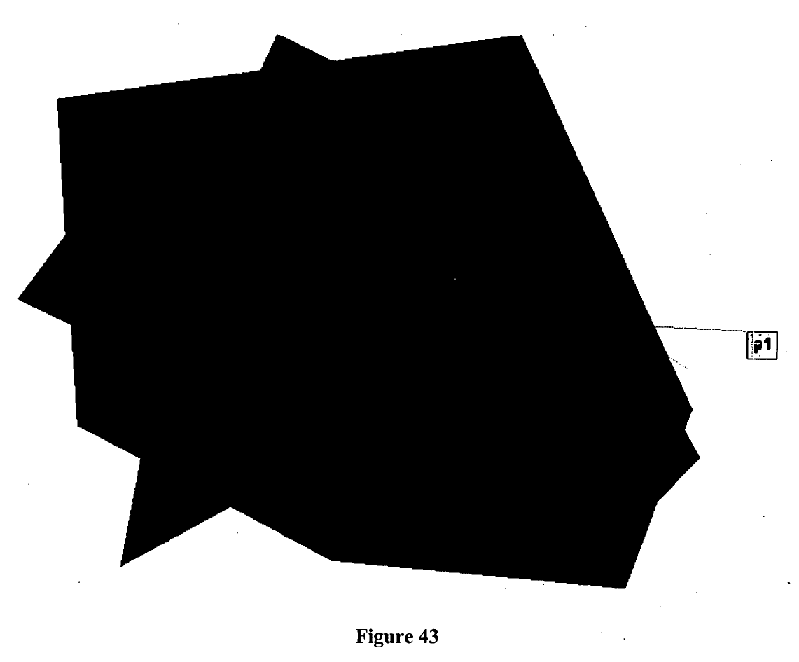

What will next be described with reference to FIGS. 43 through 46 are exemplary methods for examining the interior of a structure of interest such as a polyp. With reference to FIG. 43, what is depicted is a tri-planar view according to an exemplary embodiment of the invention. In the tri-planar view, in this case, for example, a polyp, a user can use three orthogonal planes to generate cross-sections for a region of interest. These planes are an XZ plane and an XY plane in a UI (User Interface) plane and either plane can be moved plus or minus the direction in which it has a degree of freedom. For example, the XY plane, which is a plane in the display space parallel with the display screen can be moved plus or minus in the Z direction. Accordingly, an XZ plane, which is a plane horizontal in the display space can be moved up or down in the plus or minus Y direction.

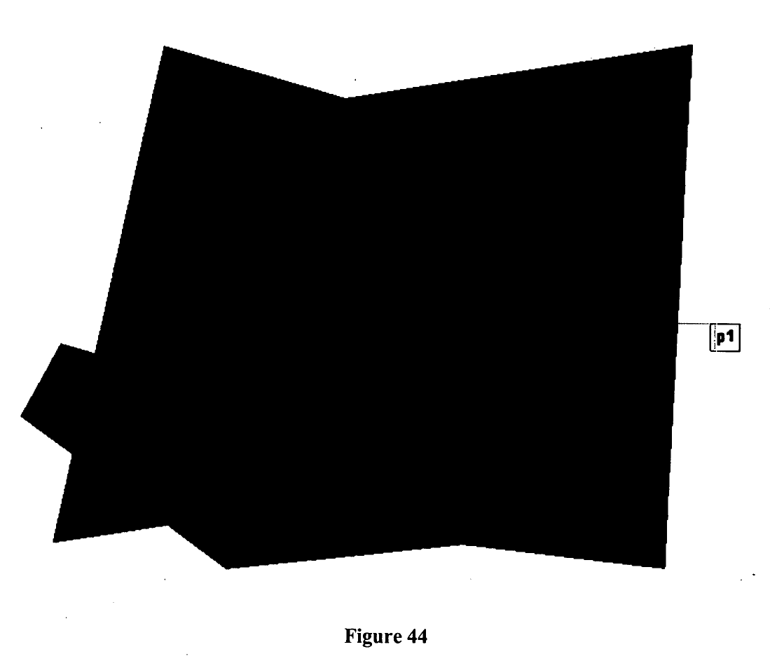

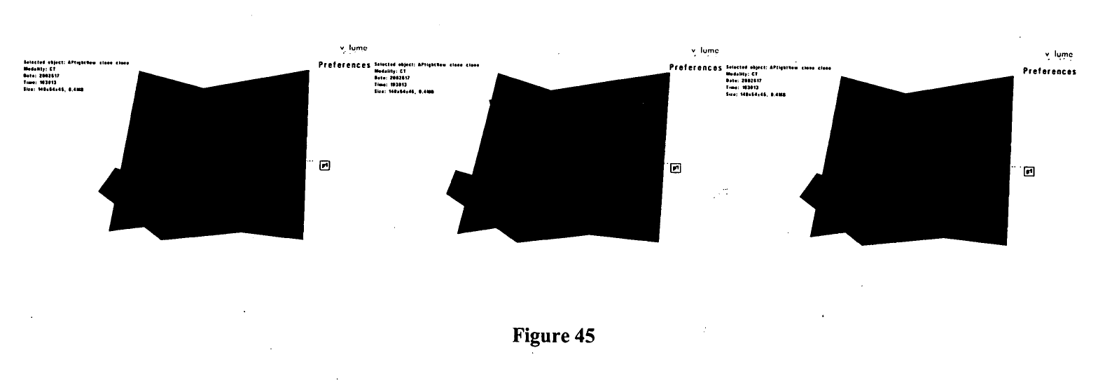

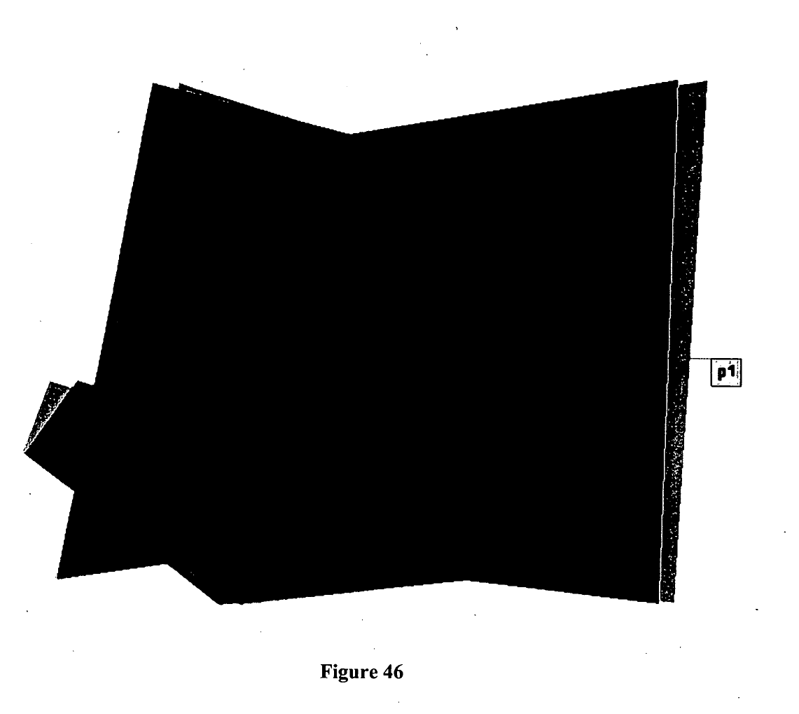

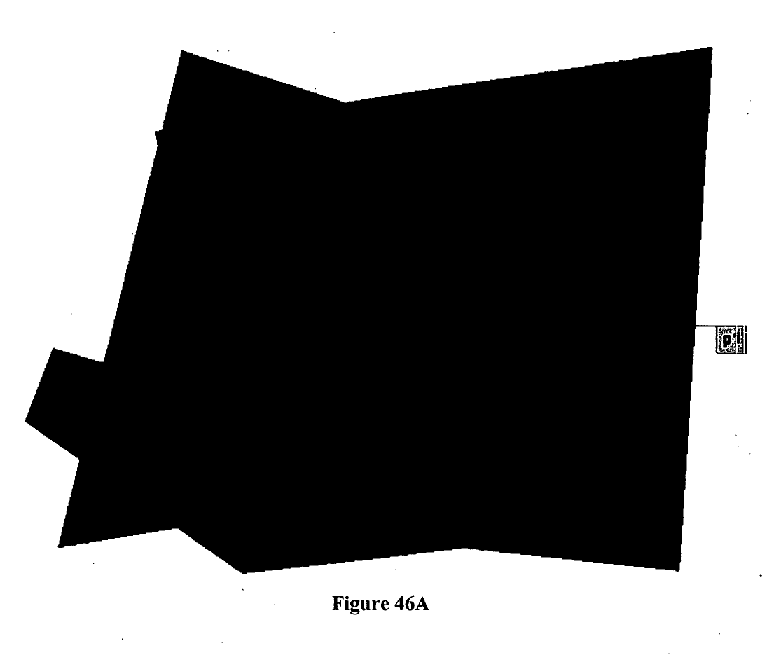

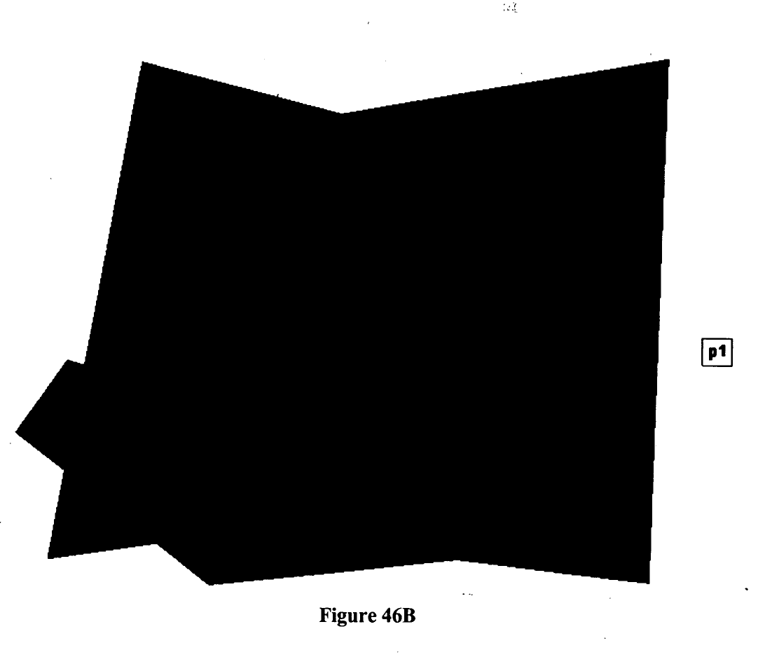

Using the tri-planar functionality, any structure can be broken down into three sets of cross-sections and its interior view. Similarly, FIG. 44 depicts the exemplary polyp being viewed in FIG. 43 with the XZ plane lowered considerably (i.e., moved in the negative Y direction) revealing different cross-sections. As well, the YZ plane has been moved to the left with reference to FIG. 44 or in the negative X direction. Using any combination of movements of the three planes, a user can view the entire inner composition of a structure of interest. Moreover, as depicted with reference to FIG. 45, the tri-planar view in exemplary embodiments according to the present invention can be viewed displayed stereoscopically. This will enhance the depth perception of the structures or elements thereof being viewed. Accordingly, FIGS. 45 and 46 show the tri-planar view presented monoscopically in FIG. 44. FIG. 45 displays the information using the two common stereoscopic techniques of cross-eyed and straight-eyed viewing, and FIG. 46 displays the information in red-blue stereo, anaglyphically. FIGS. 46A and 46B illustrate, in black and white, the separate red and blue channels of FIG. 46 that, when combined, form a red-blue stereoscopic image.

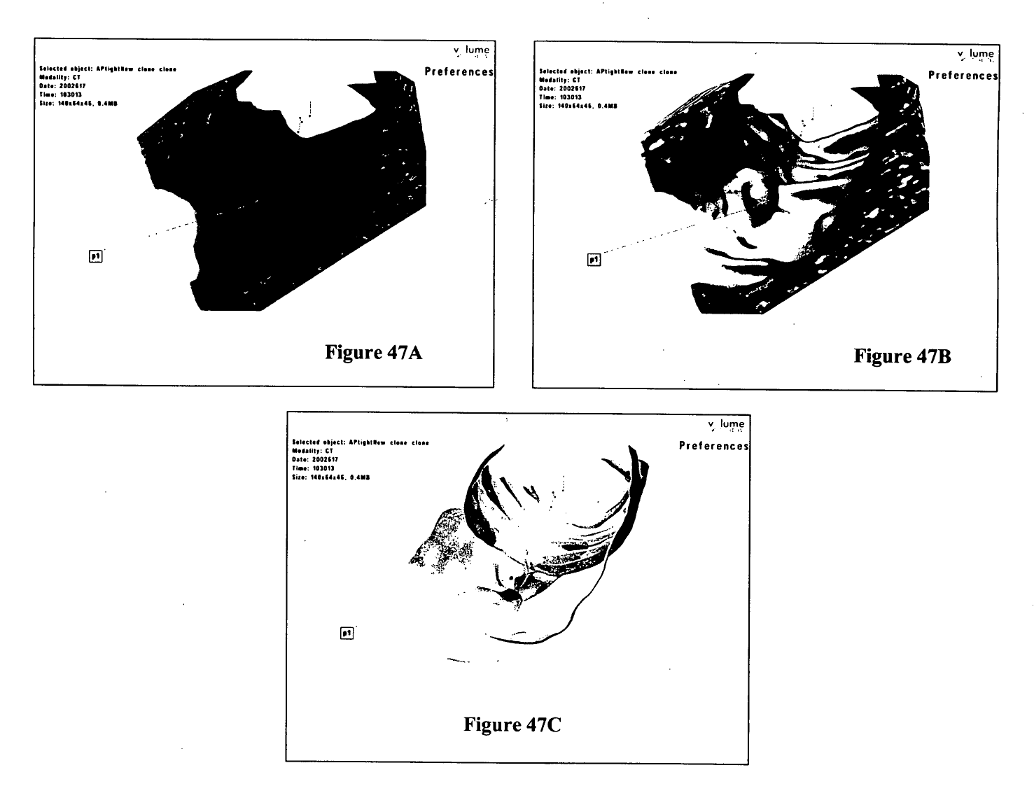

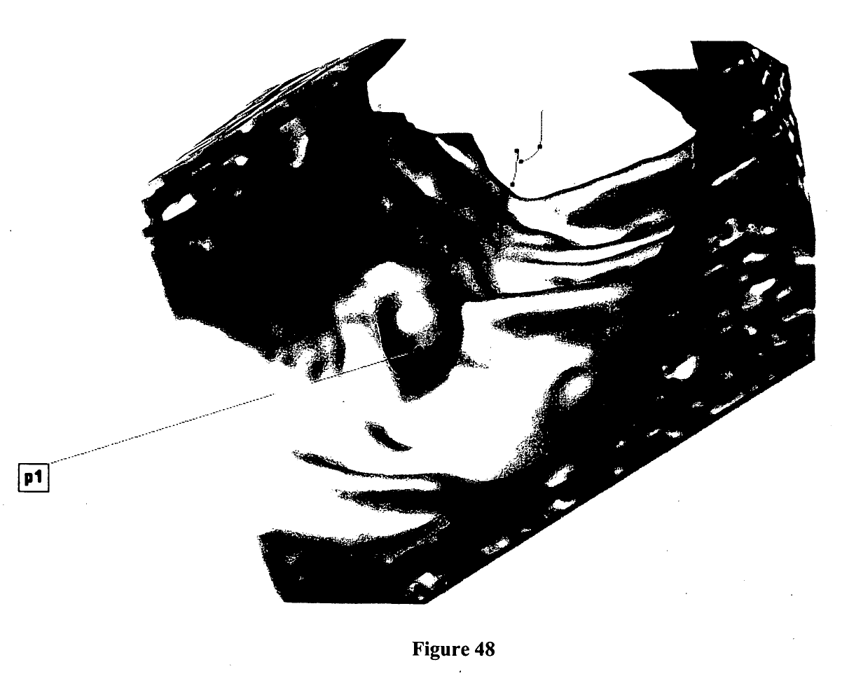

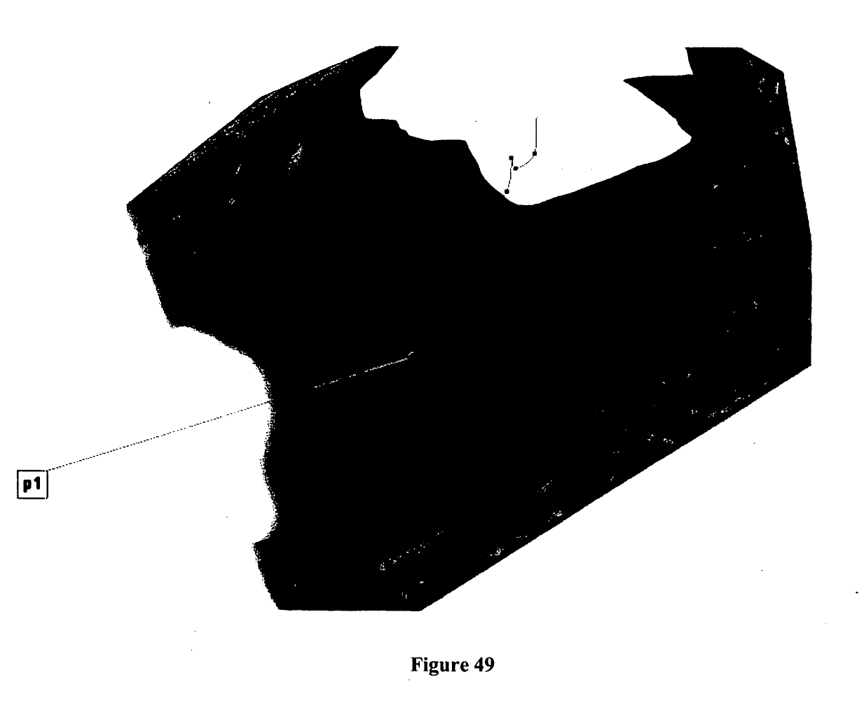

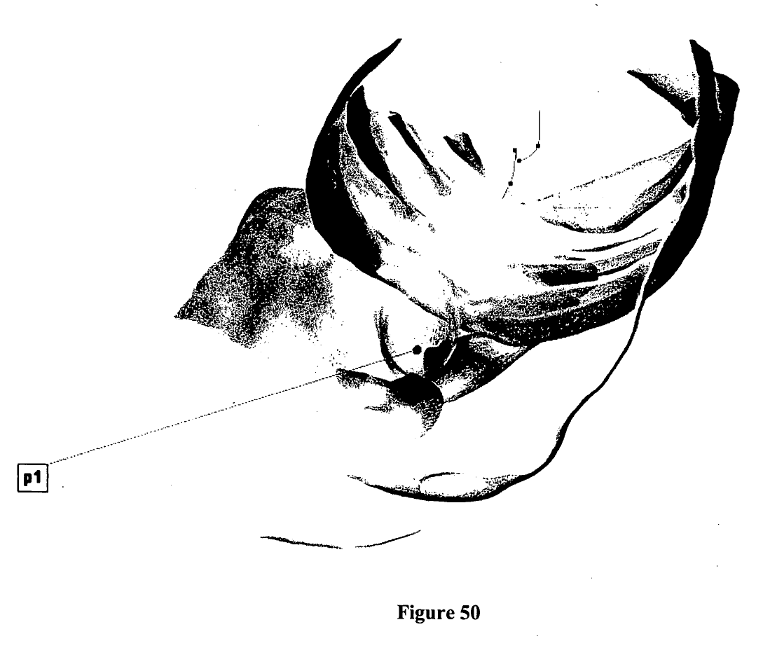

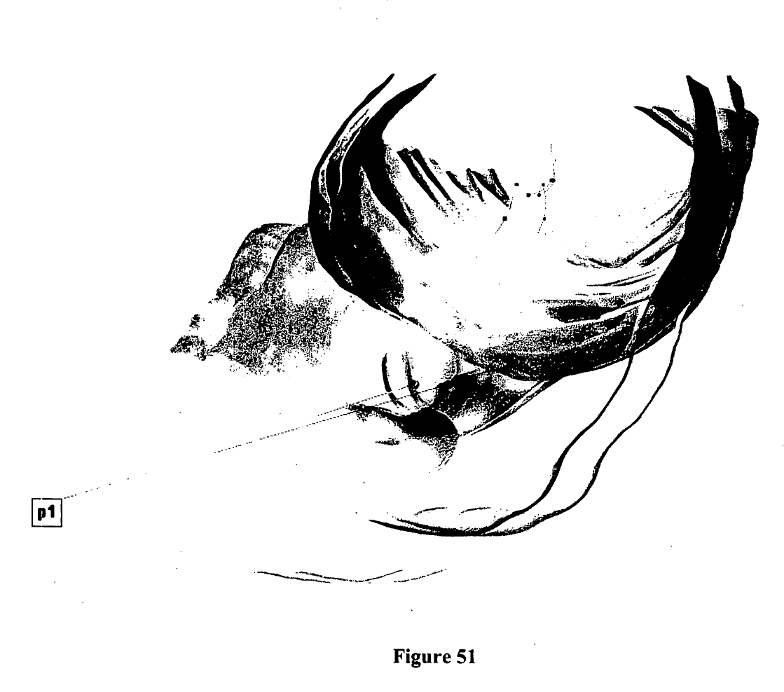

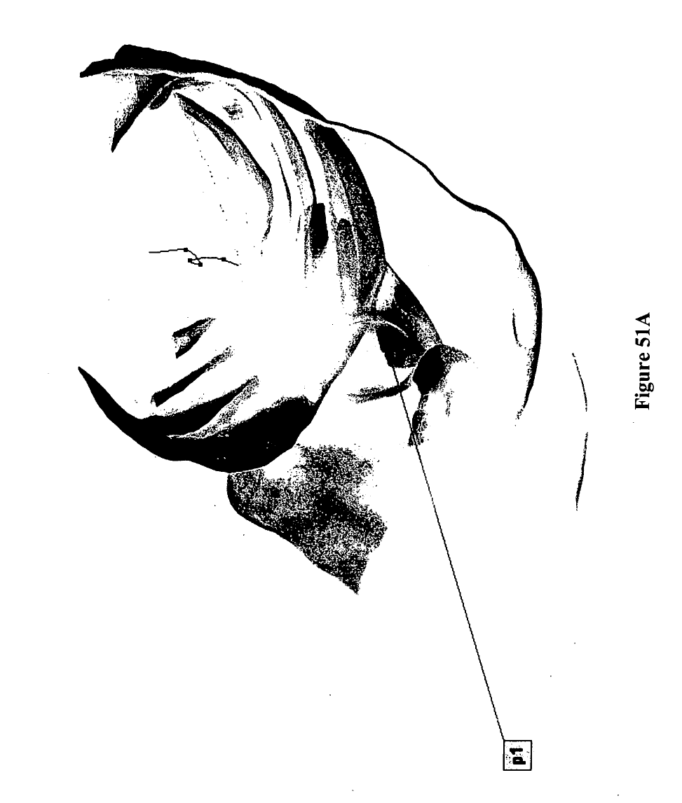

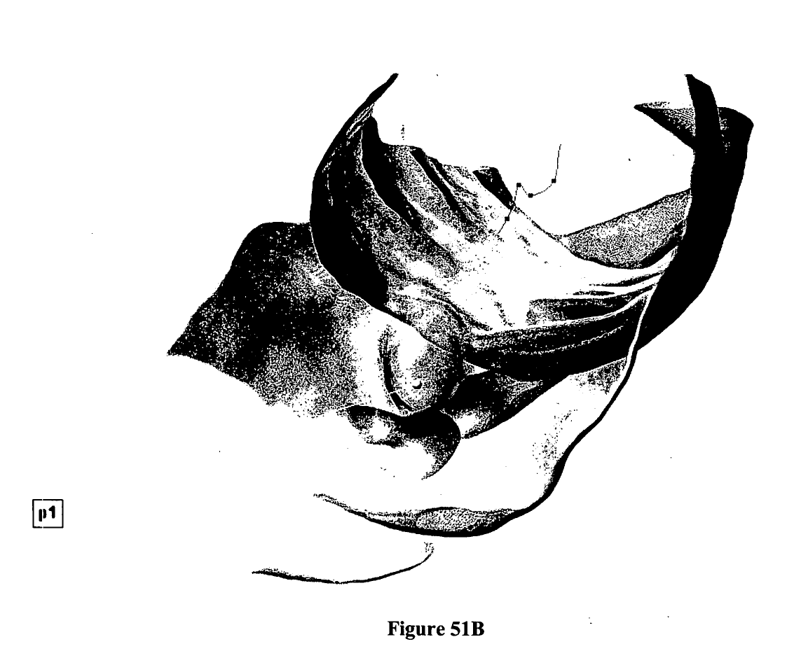

With reference to FIGS. 47-51, the use of shading comparison according to an exemplary embodiment of the present invention will next be described. As can be seen from FIGS. 47A through 47C, there are different ways in which an inner colon wall can be depicted according to exemplary embodiments of the present invention. FIG. 47A depicts an exemplary rendering of a colon interior without shading, and FIG. 47B depicts the same exemplary section of a colon interior rendered with shading. FIG. 47C depicts the same exemplary colon view with shading, but with making the colon transparent. As can be seen from FIG. 47C, although it makes it easier in a sense to view the colon transparently, it also introduces some confusion as to depth perception, as shall be noted below. FIGS. 48-50 are larger versions of each of FIGS. 47B, 47A and 47C, respectively. FIG. 51 is a stereoscopic rendering of the exemplary colon interior segment depicted in FIG. 50. FIGS. 51A and 51B illustrate, in black and white, separate red and blue channels of a stereoscopic image of FIG. 51. These channels may be combined to form a red-blue stereoscopic image. The stereoscopic image formed from the red and blue channels solves any ambiguity due to depth perception and the suspect polyp designated by P1 in FIG. 50 can be clearly seen as protruding into the colon lumen. It is noted that in exemplary embodiments of the present invention where stereoscopic display is not implemented, the same depth ambiguity as to the suspect polyp region P1 of FIG. 50 can be resolved using the voxels behind or on the outside of the colon wall with or without shading as is shown in FIGS. 48 and 49, respectively.

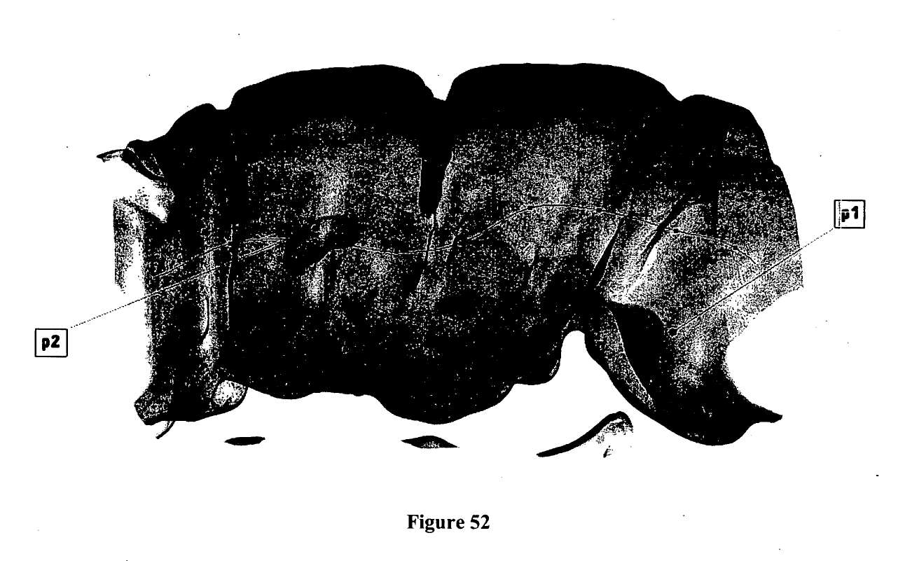

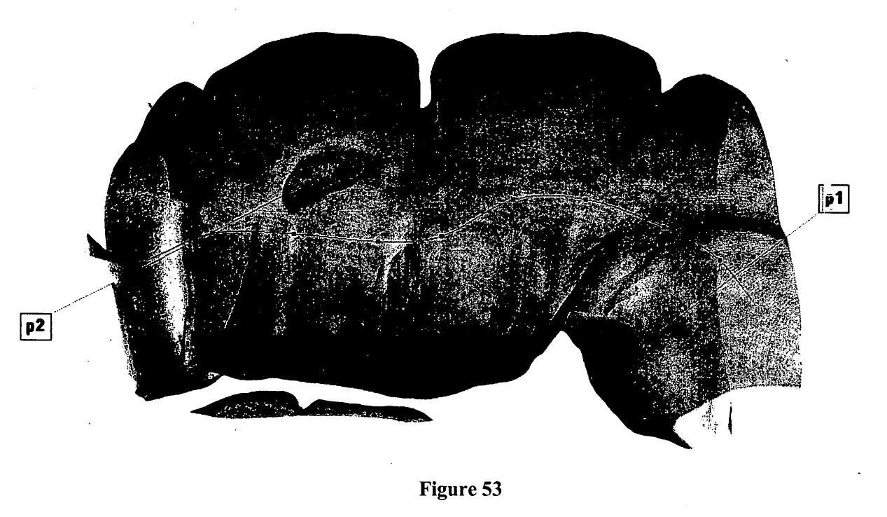

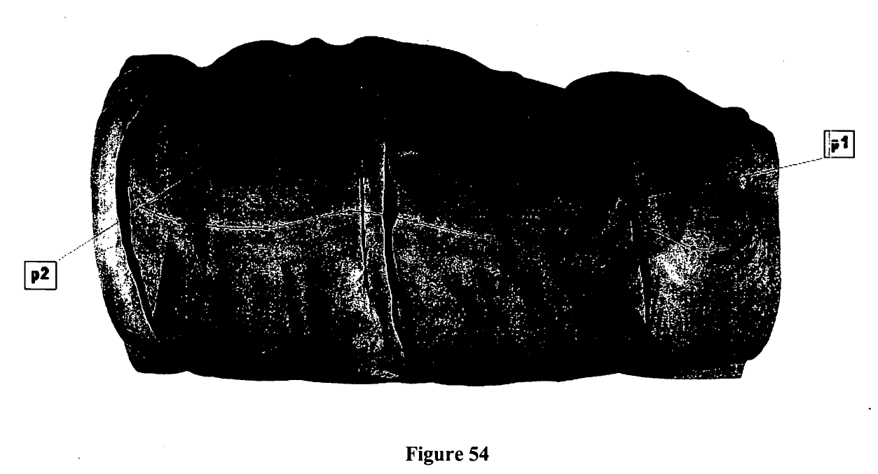

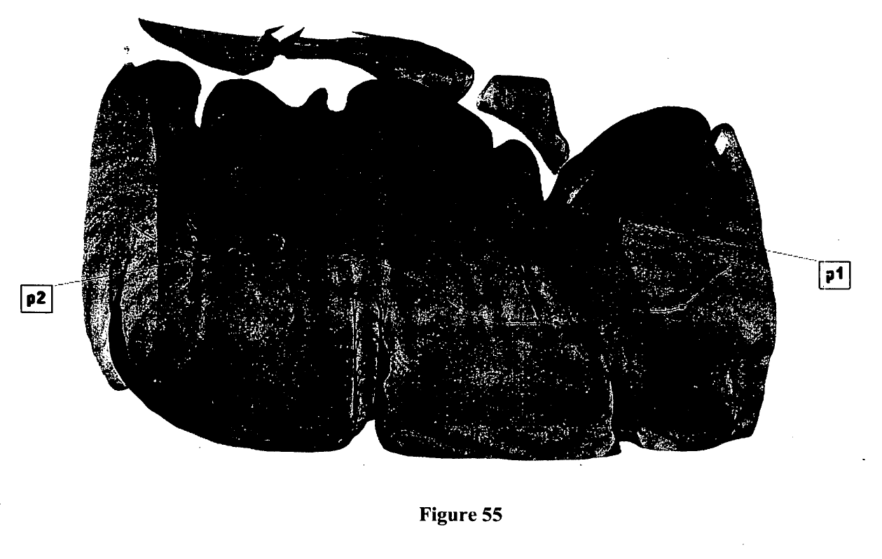

What will next be described with reference to FIGS. 52-61 is the rotation of a transparent colon along its centerline according to an exemplary embodiment of the present invention. By rotating the displayed colon as well as translating it in front of a user, suspected polyp or other regions of interest can be viewed from many directions.

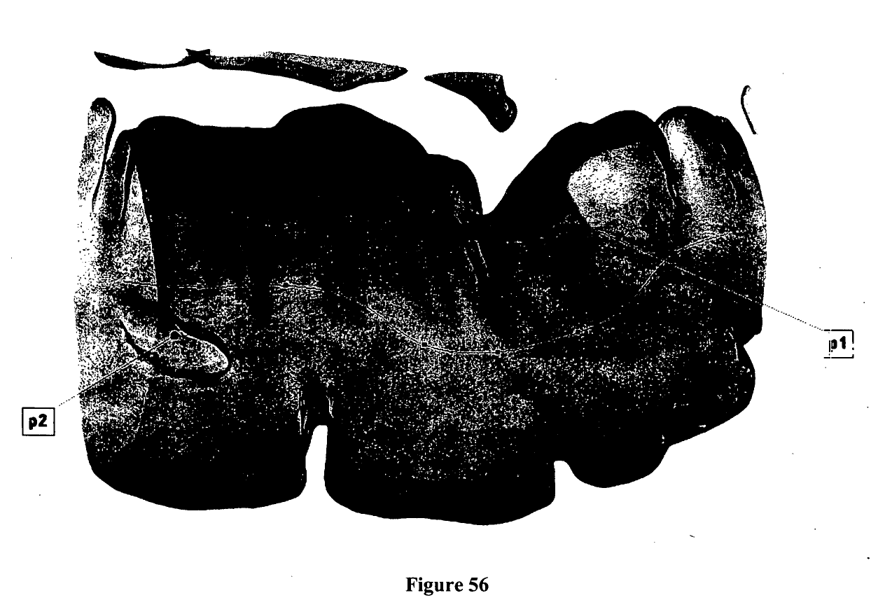

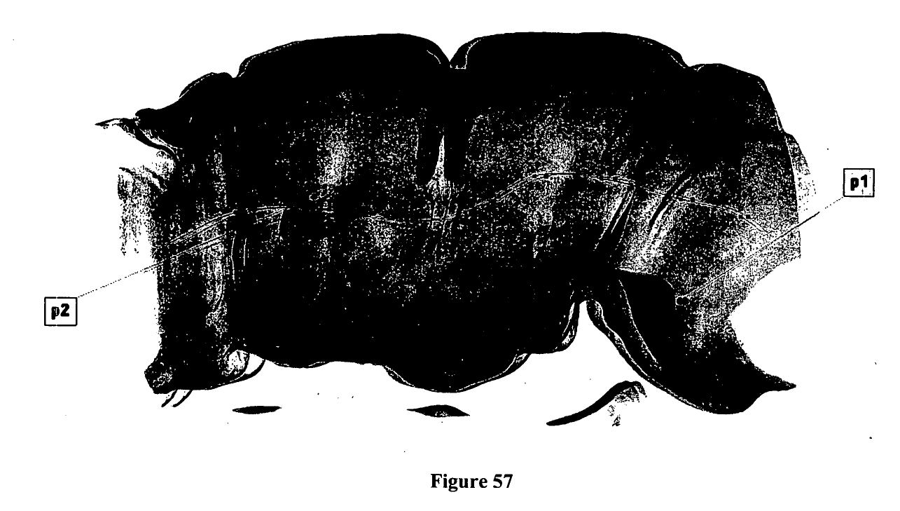

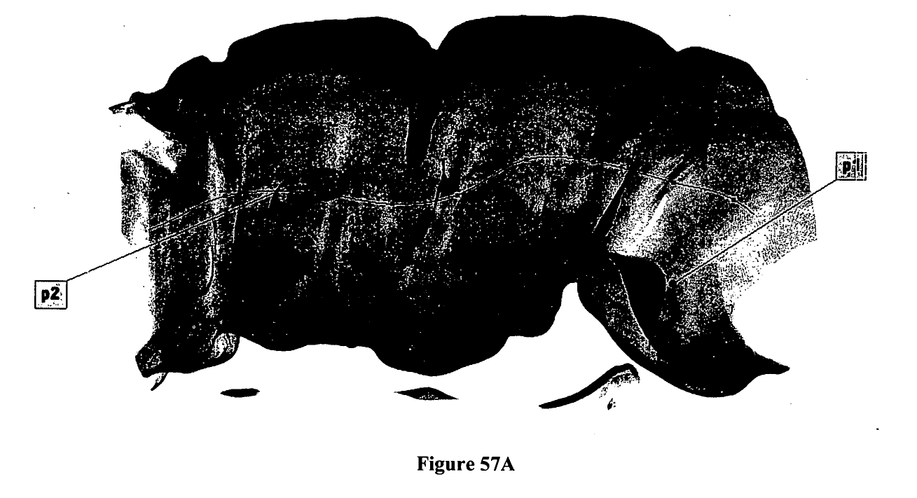

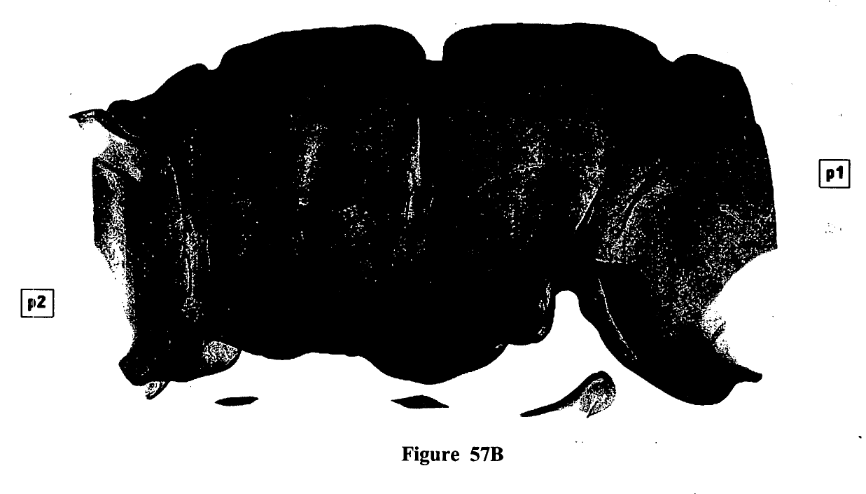

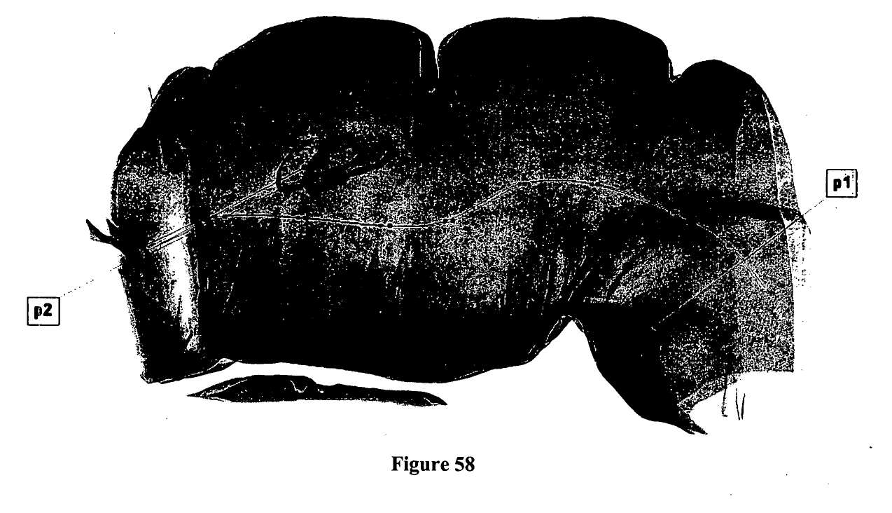

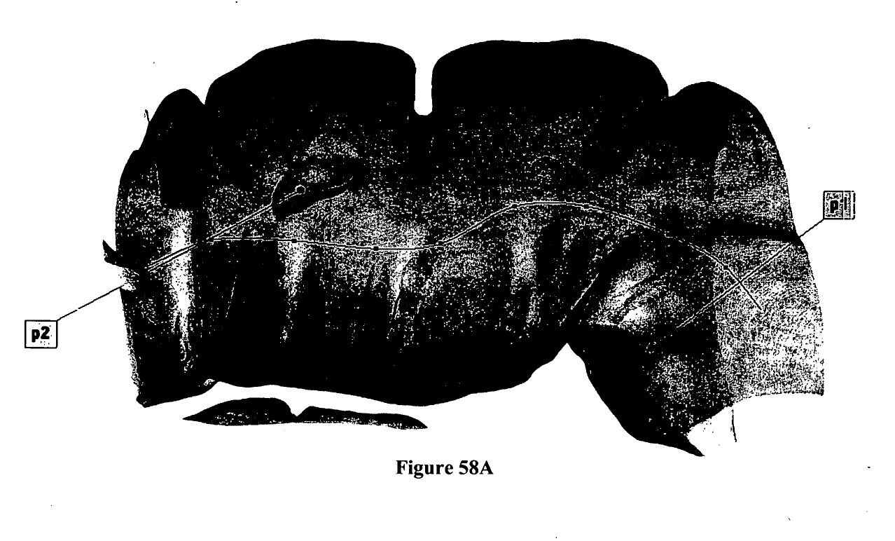

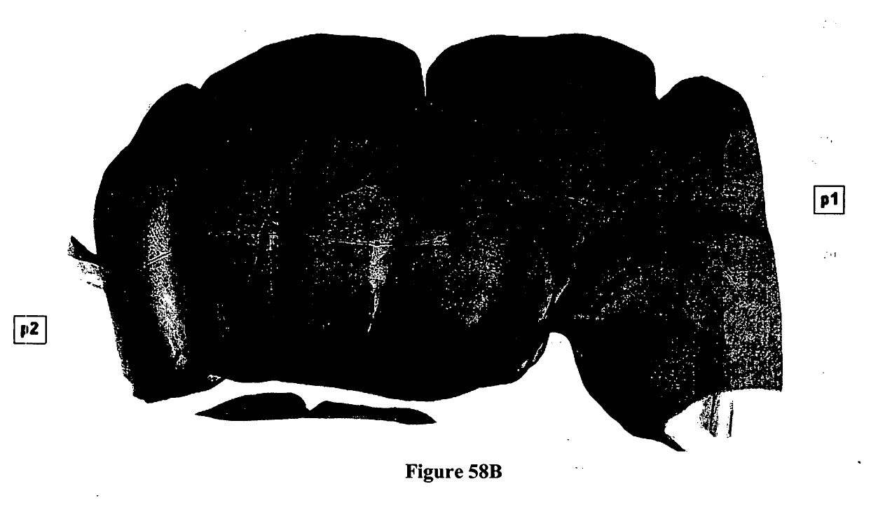

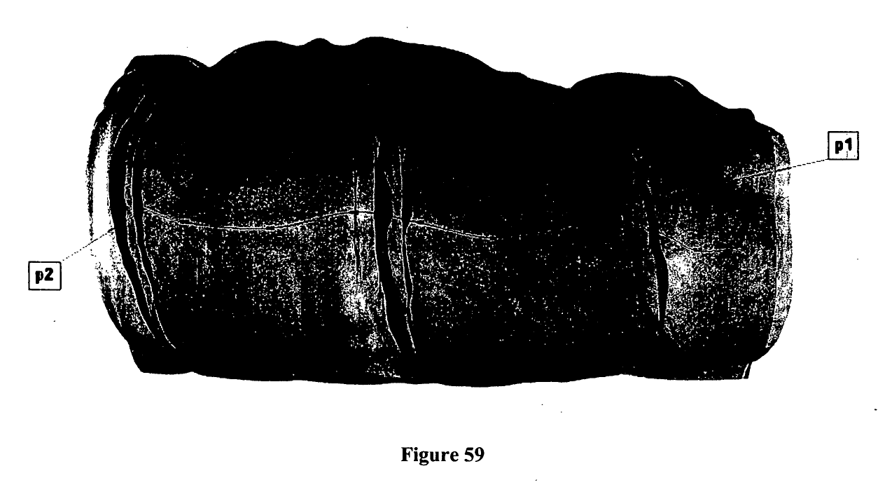

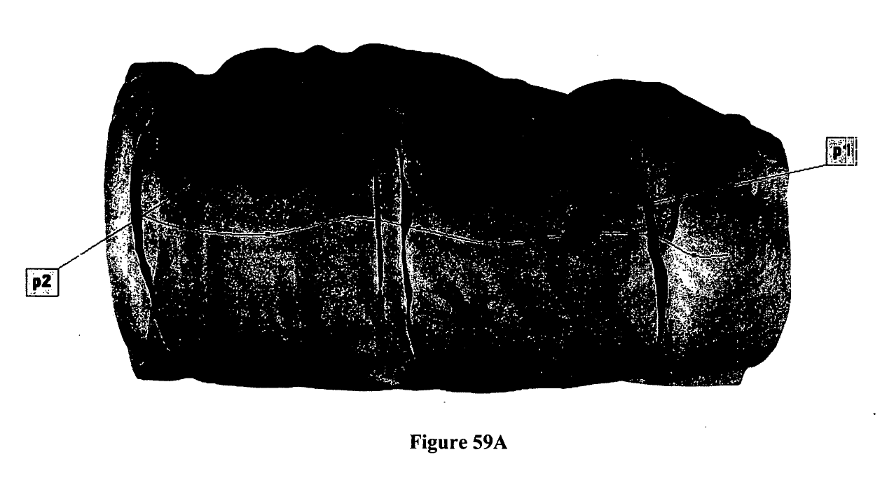

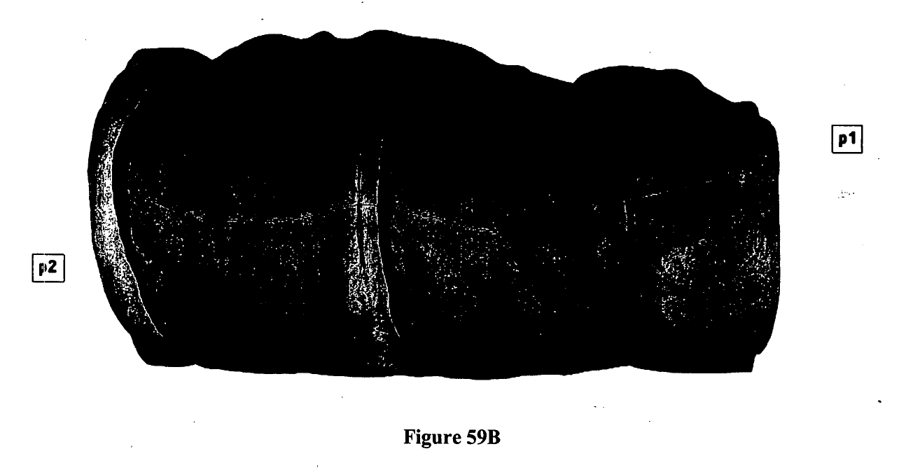

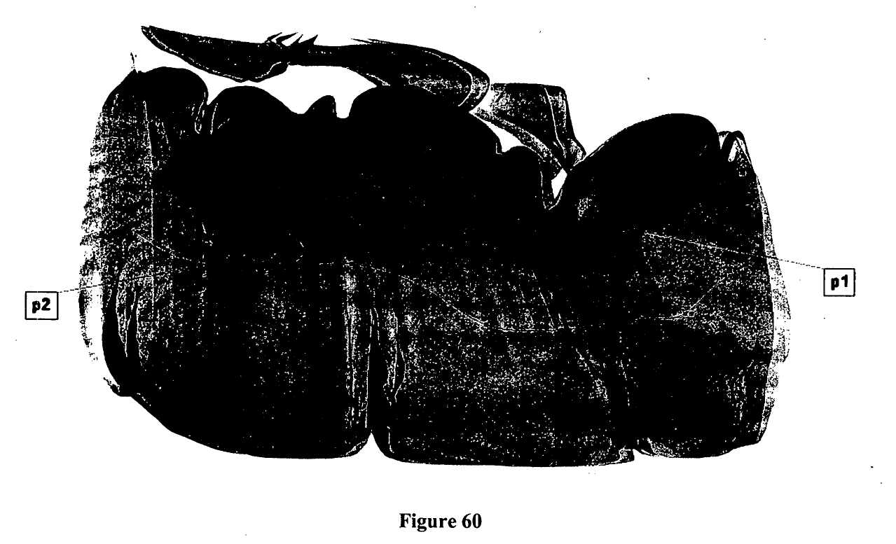

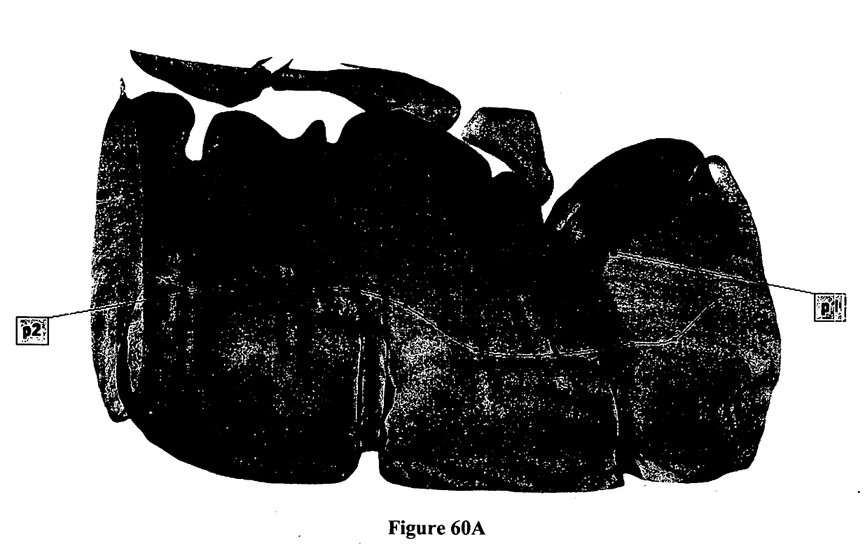

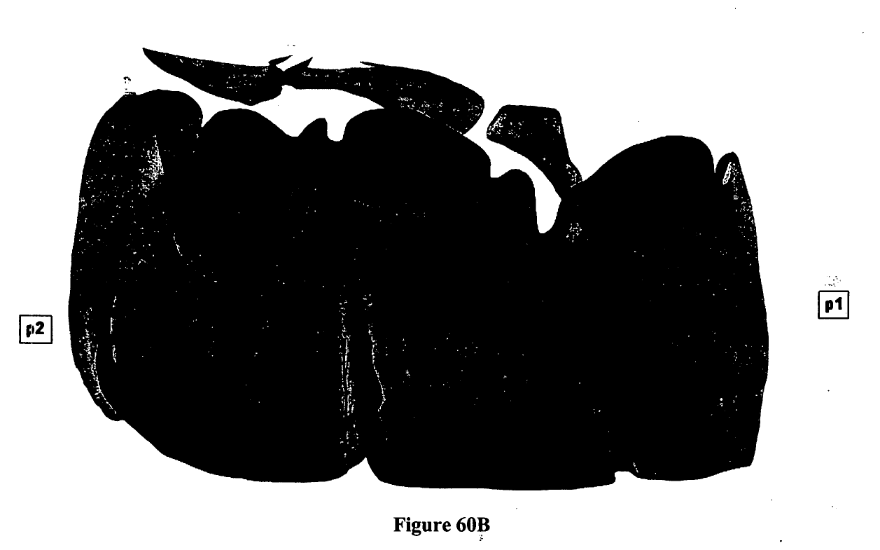

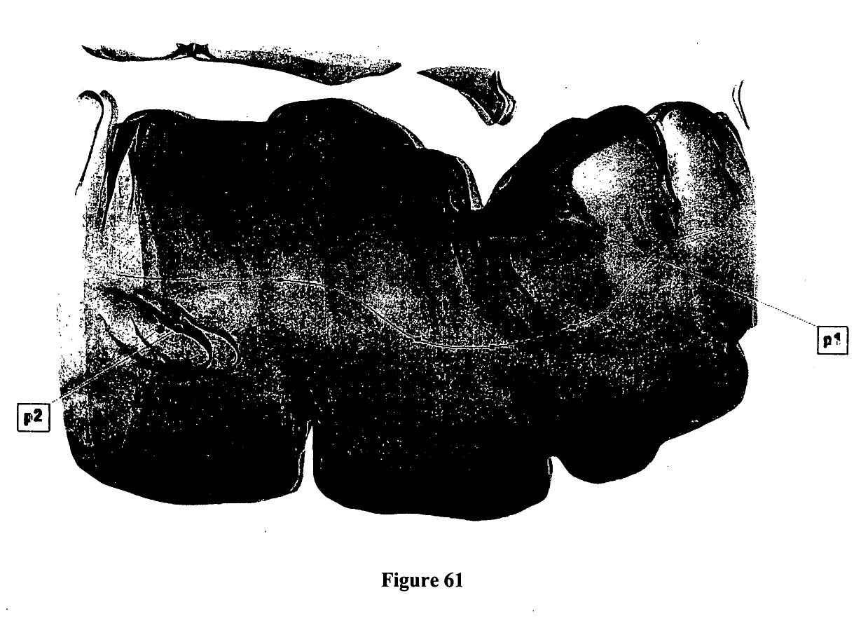

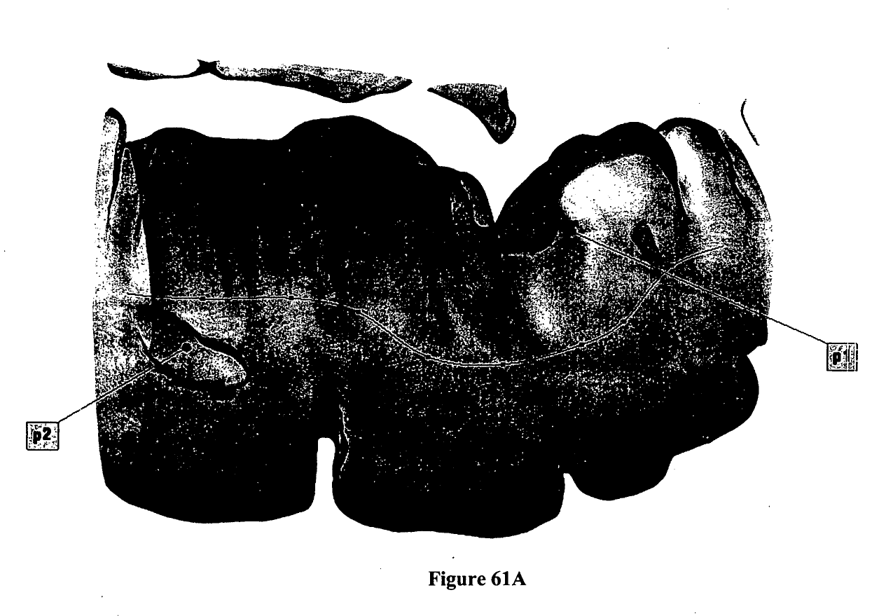

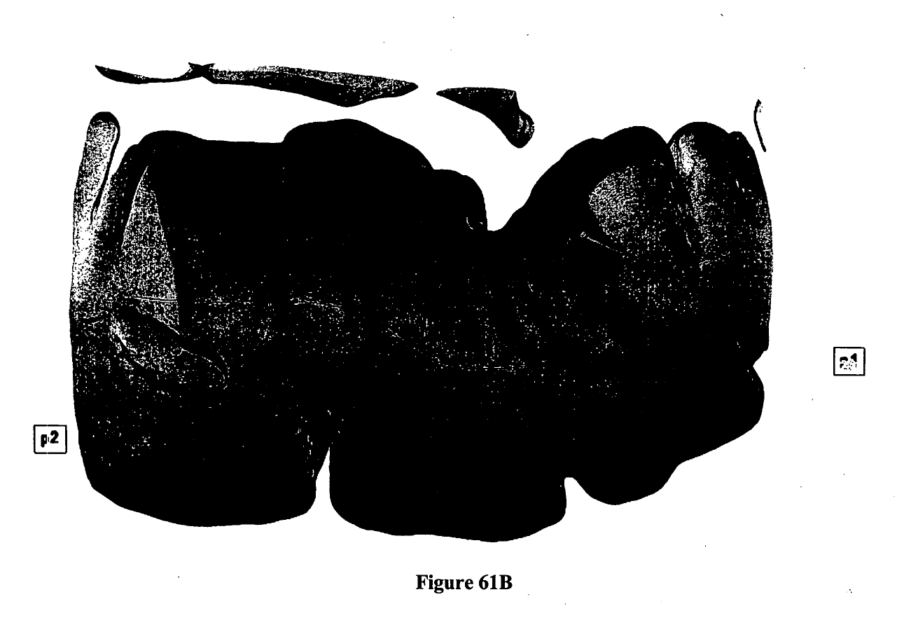

FIGS. 52 through 56, respectively, depict the rotation of a transparent colon along its centerline in five steps according to an exemplary embodiment of the present invention. FIGS. 57 through 61, respectively, show the exemplary views of FIGS. 52 through 56, respectively, displayed in red-blue stereo according to an exemplary embodiment of the present invention. These figures illustrate separate red and blue channels, that when combined, form a red-blue stereo images. The depicted colon in FIG. 52 is the same as shown in FIGS. 23-26, but rotated 180 degrees about a point in the center of the figure. Thus P1 in FIG. 52 (FIG. 57) is protruding from the rear colon wall, and after rotating approximately 180 degrees counterclockwise about an axis pointing to the right in the plane of the figure, ends up protruding into the figure from the front colon wall in FIG. 56 (FIG. 61). FIGS. 57A and 57B illustrate, in black and white, the separate red and blue channels of information for the red-blue stereo image shown in FIG. 57. Similarly, FIGS. 58A and 58B are black and white illustration of each of the red and blue channels of the stereo image of FIG. 58, and FIGS. 59A and 59B are black and white depictions of the separate red and blue channels of the red-blue stereo image of FIG. 59. In addition, FIGS. 60A and 60B illustrate the separate red and blue channels (depicted in black and white) of the red-blue stereo image of FIG. 60, and FIGS. 61A and 61B depict the red and blue channels of the stereo image of FIG. 61.

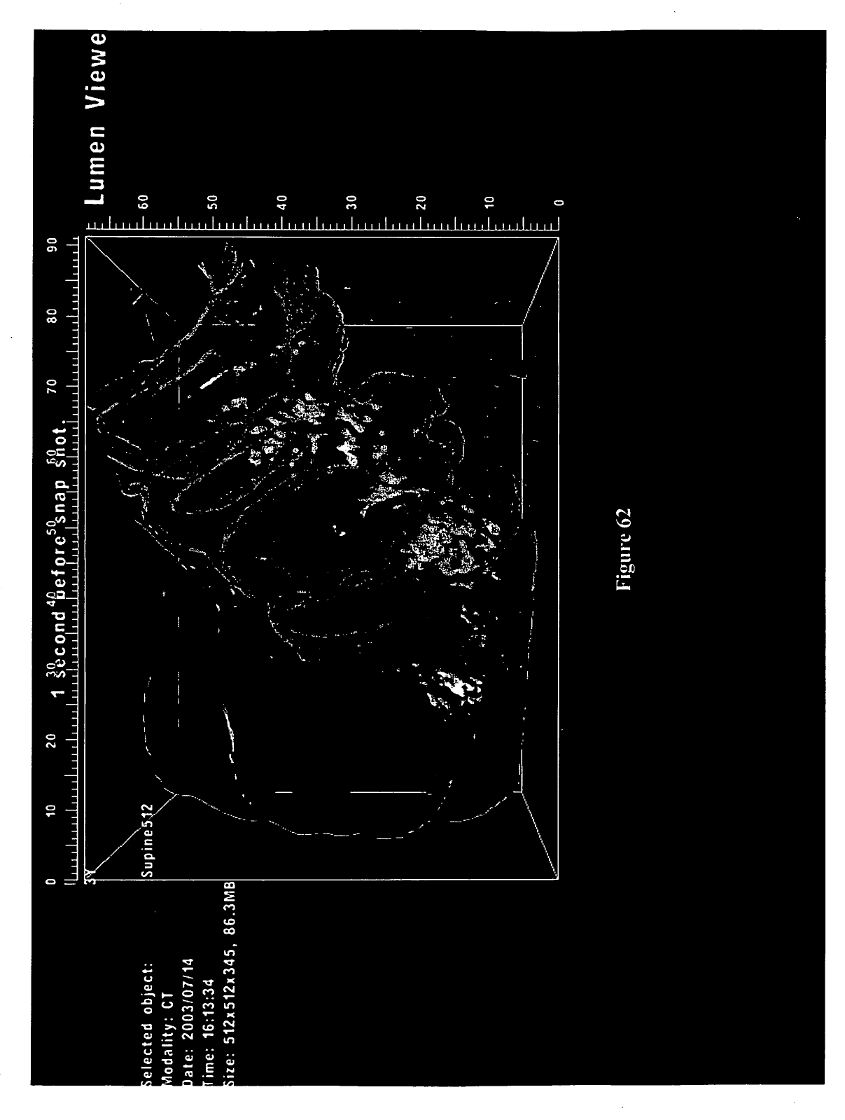

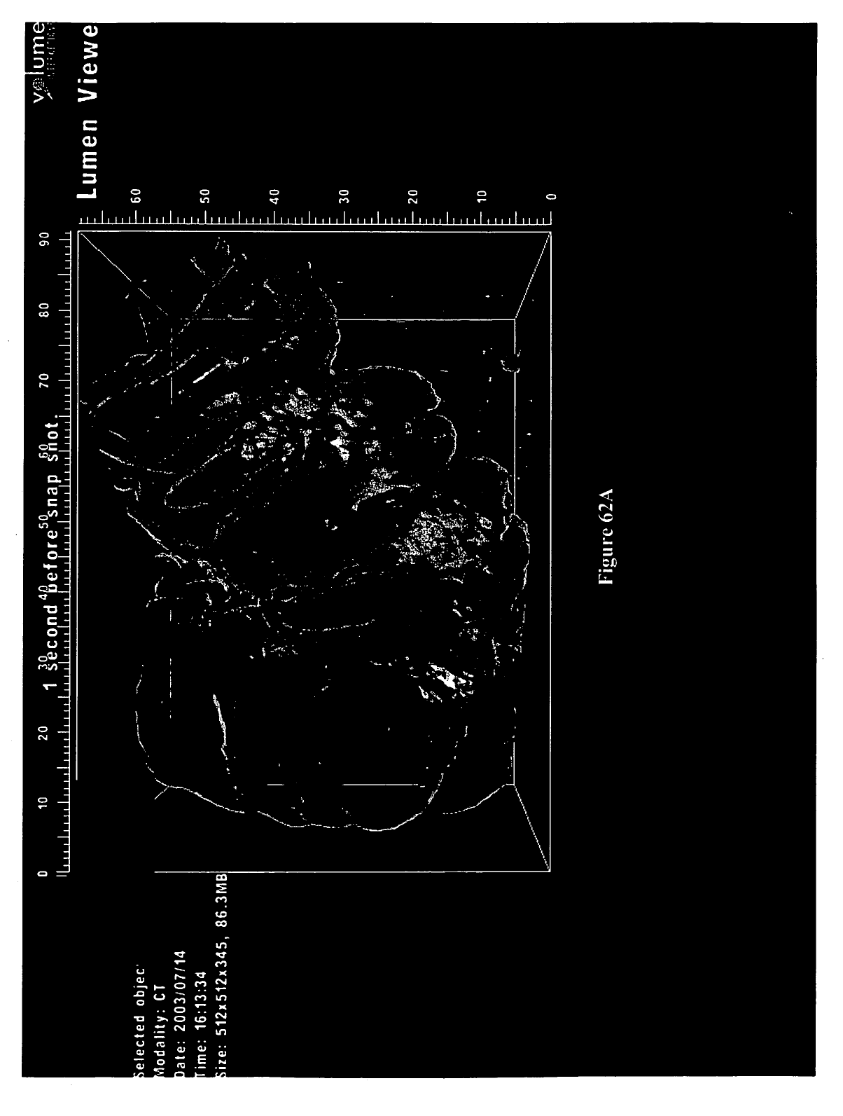

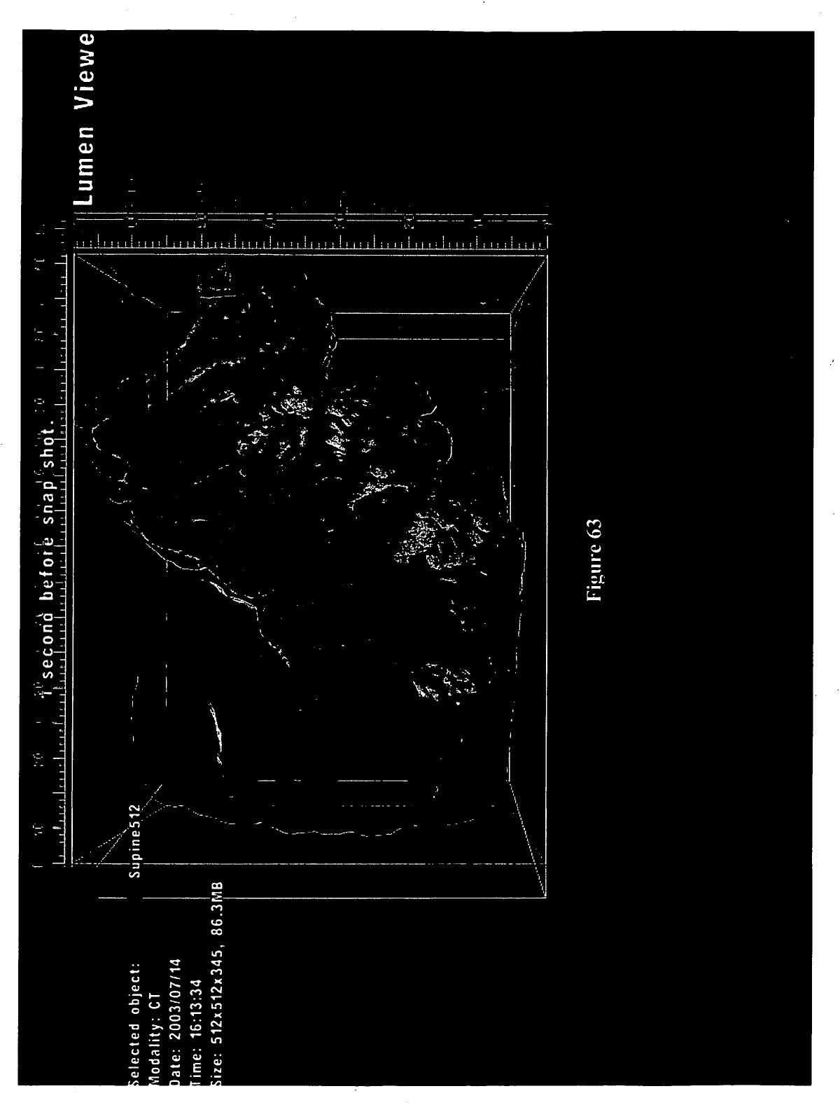

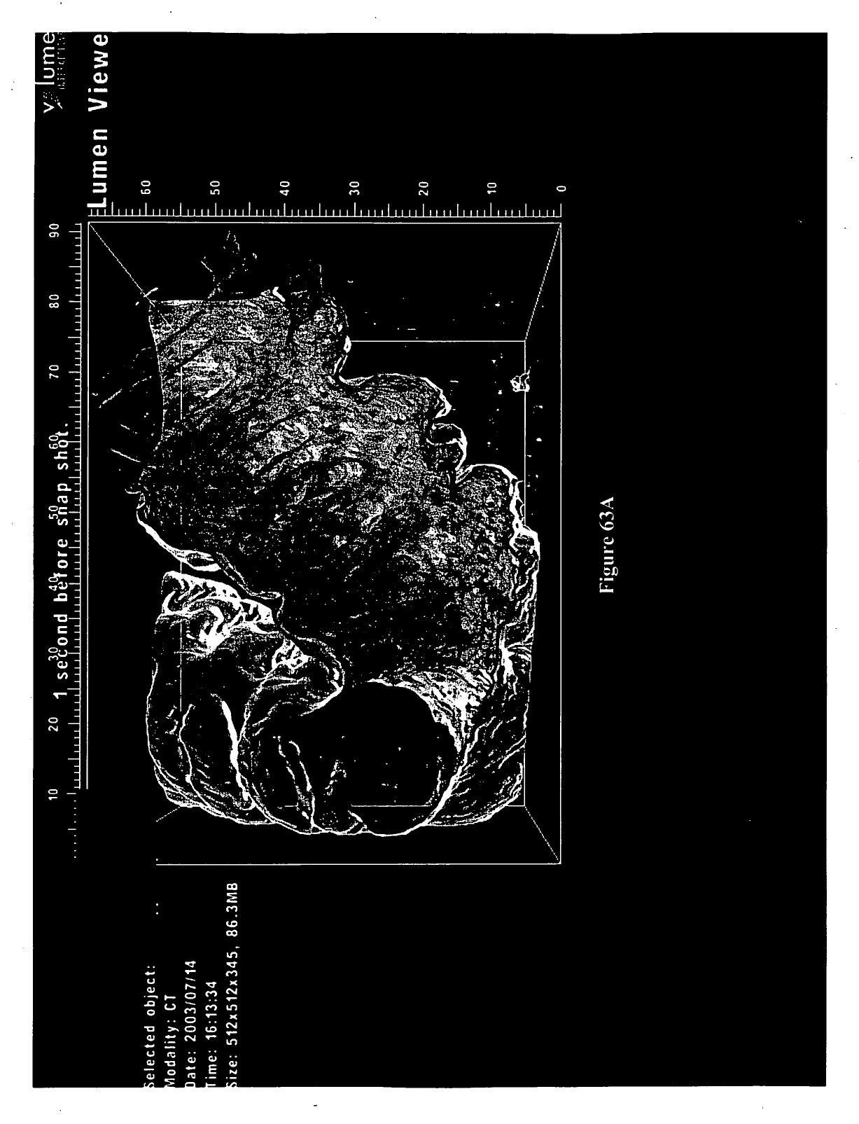

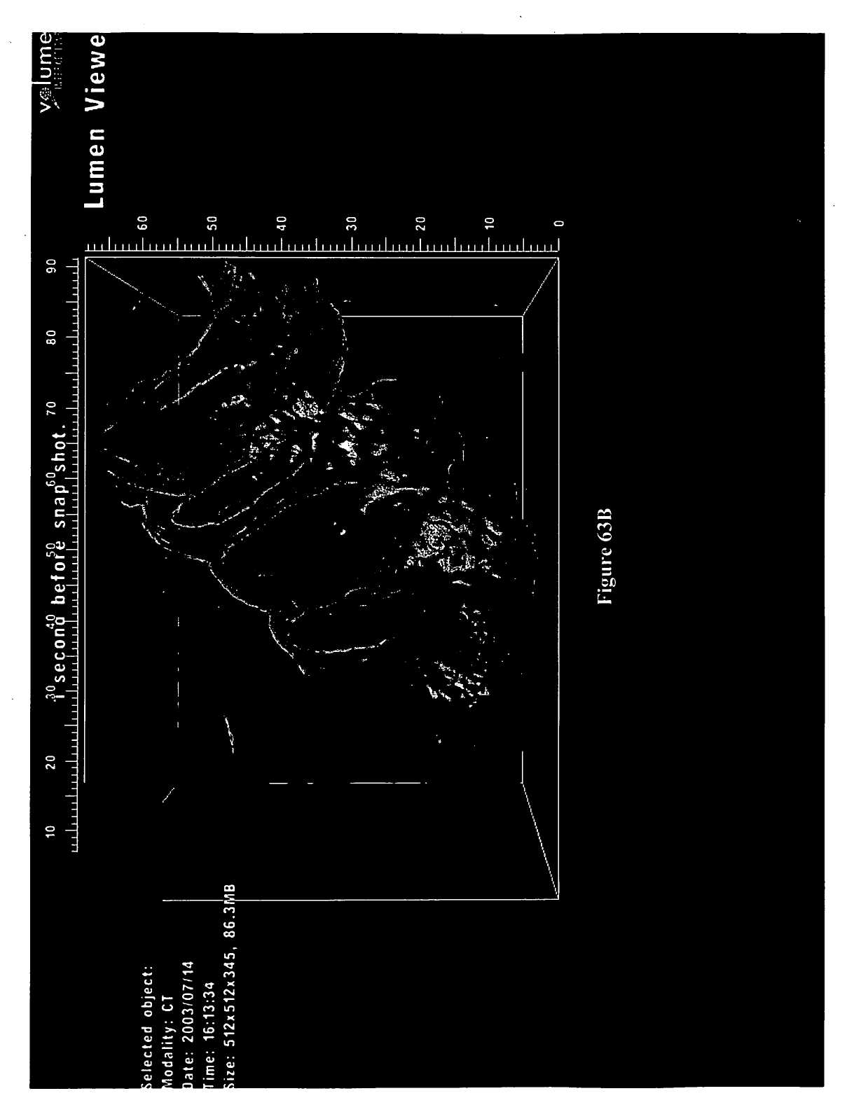

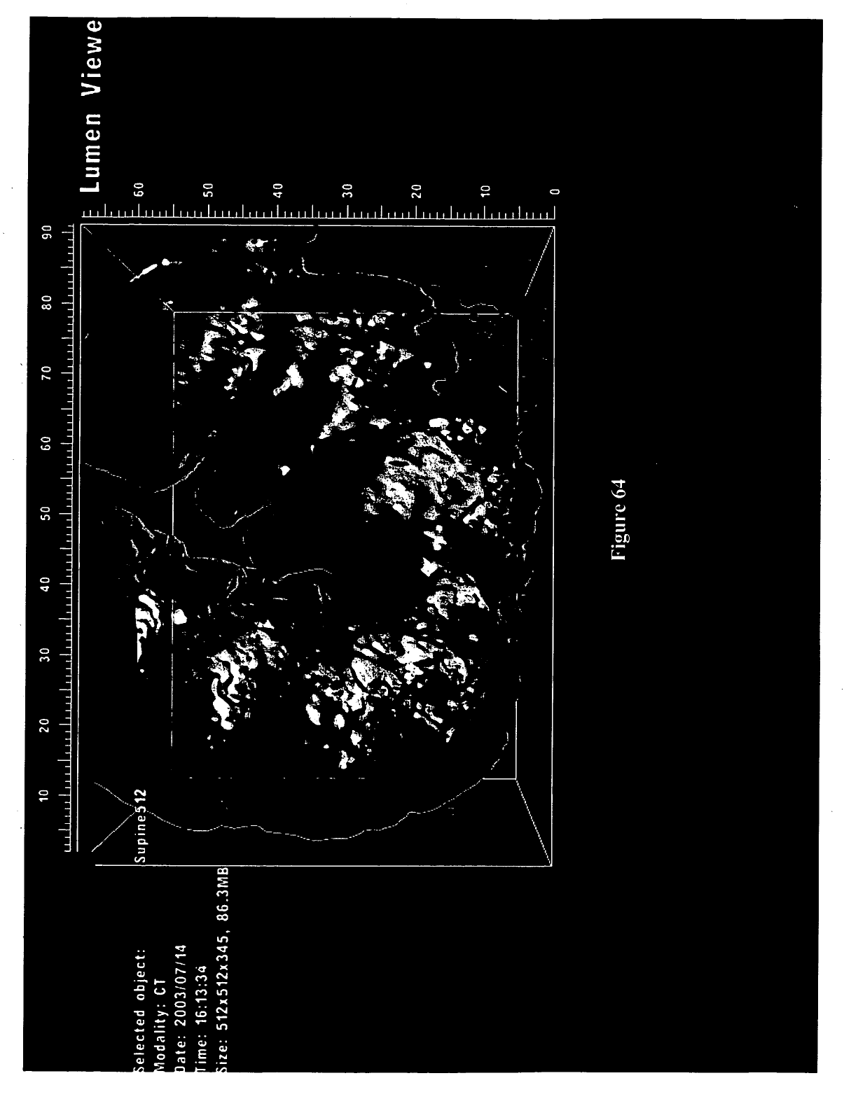

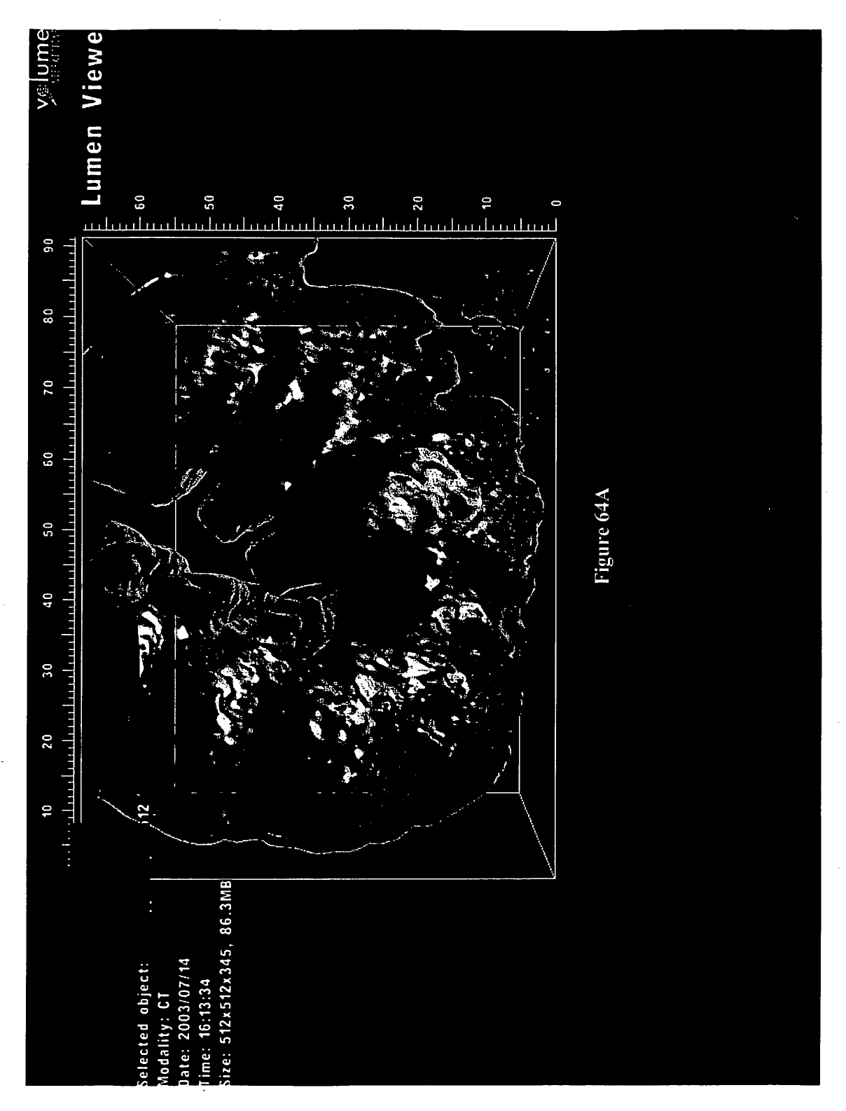

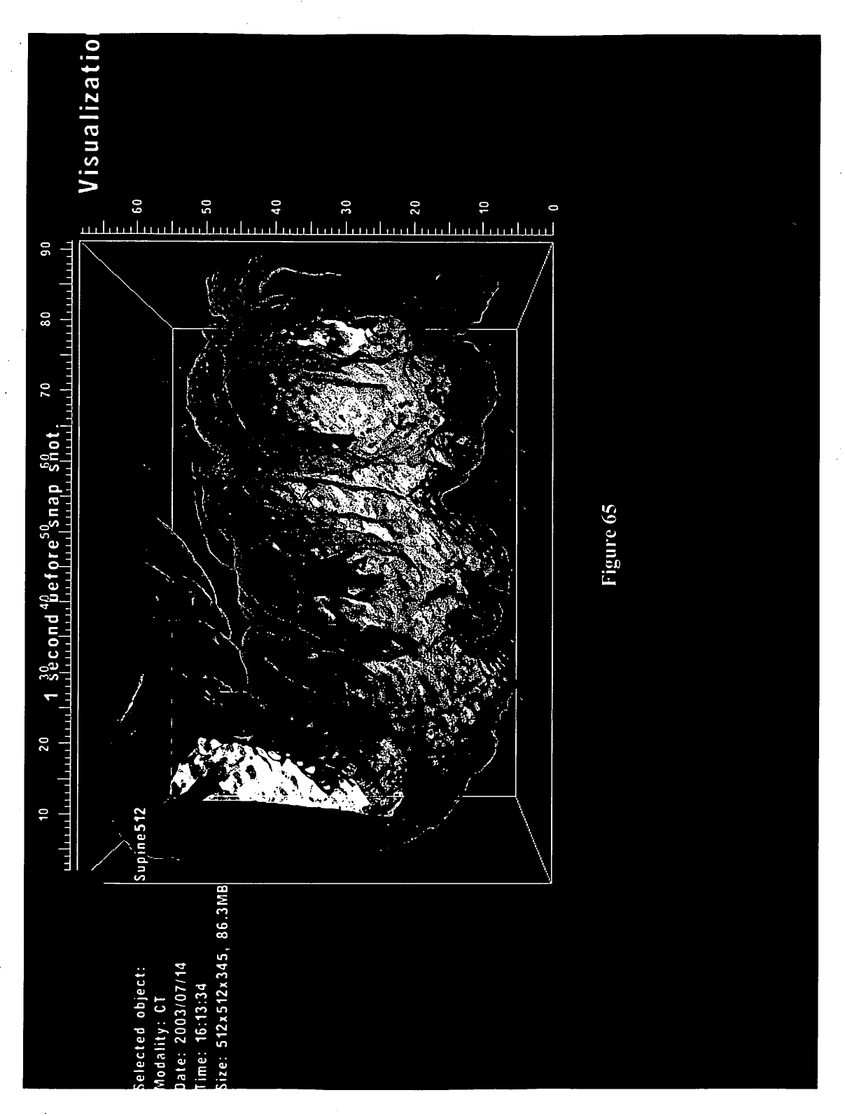

FIG. 62 depicts an exemplary colon seen as two halves according to an exemplary embodiment of the present invention, where the front half is seen transparently and the rear half is seen as opaque using color shading. FIG. 62A is a black and white illustration of the shading used in FIG. 62. FIG. 63 depicts the exemplary colon of FIG. 62 using red-green stereo according to an exemplary embodiment of the present invention. FIGS. 63A and 63B illustrate, in black and white, the separate red and green channels for the stereo image FIG. 63. Combining the red and green channels of FIGS. 63A and 63B would result in a red-green stereo image. FIG. 64 depicts an alternate portion of the exemplary colon depicted in FIGS. 62 and 63, where the rear portion of the colon is displayed opaquely with shading according to an exemplary embodiment of the present invention (front portion not shown). FIG. 64A is a black and white illustration of the shading used in FIG. 64. FIG. 65 depicts a further alternate view of the exemplary colon depicted in FIGS. 62 through 64, with the foreground half of the exemplary colon displayed semi-transparently in gray, and the background half of the exemplary colon displayed opaquely with shading. FIG. 65A is a black and white illustration the foreground view of an alternate view of the exemplary colon depicted in FIG. 65. These images can be combined to form a composite image of the two halves of the colon. Using varying exemplary values for CLUTs a portion of a colon can, in exemplary embodiments, be displayed anywhere from opaque to totally transparent, with any color assigned to any voxel intensity value, as may be useful or convenient.

Illustrative Figures Using Air Injector as Object of Interest

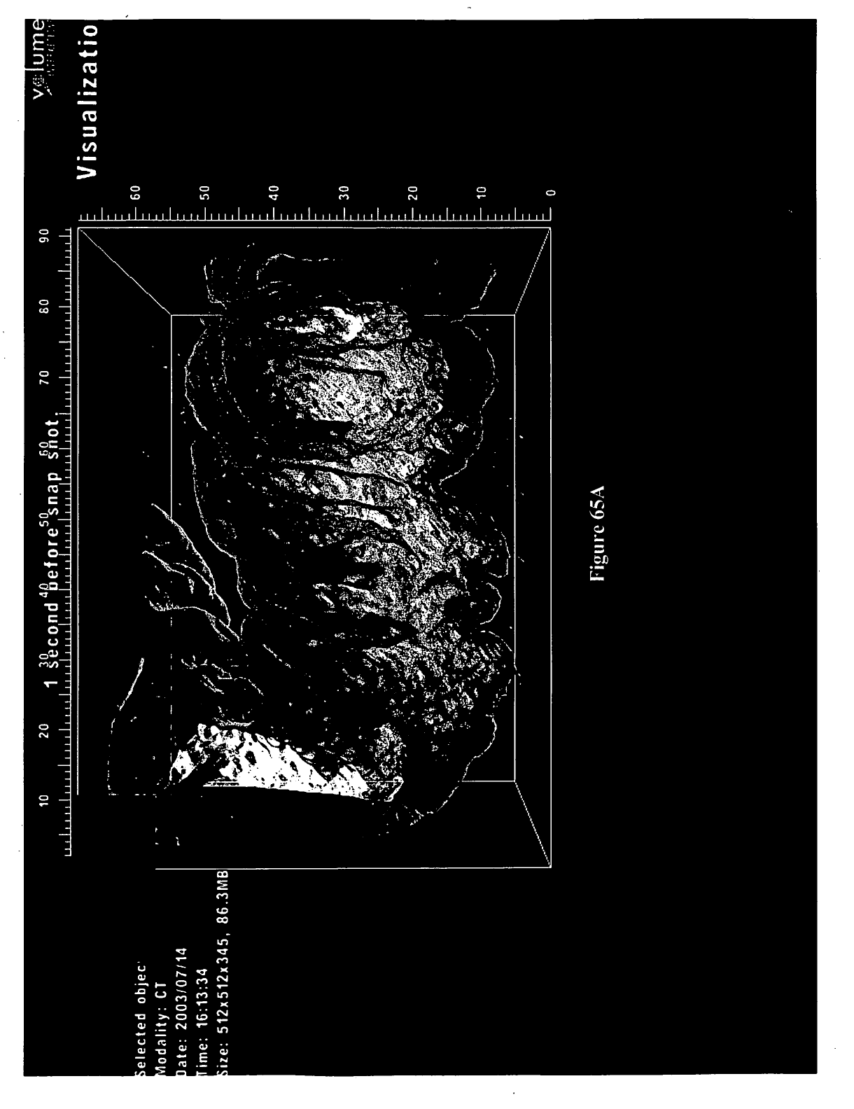

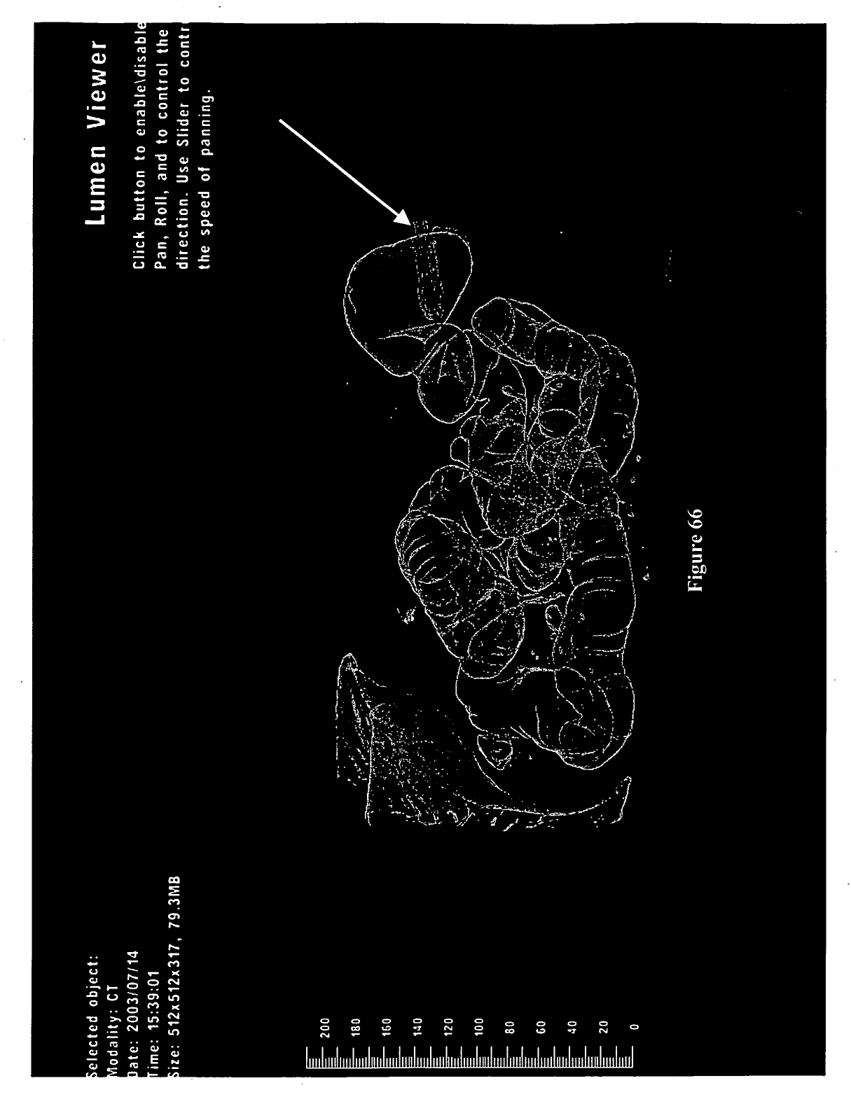

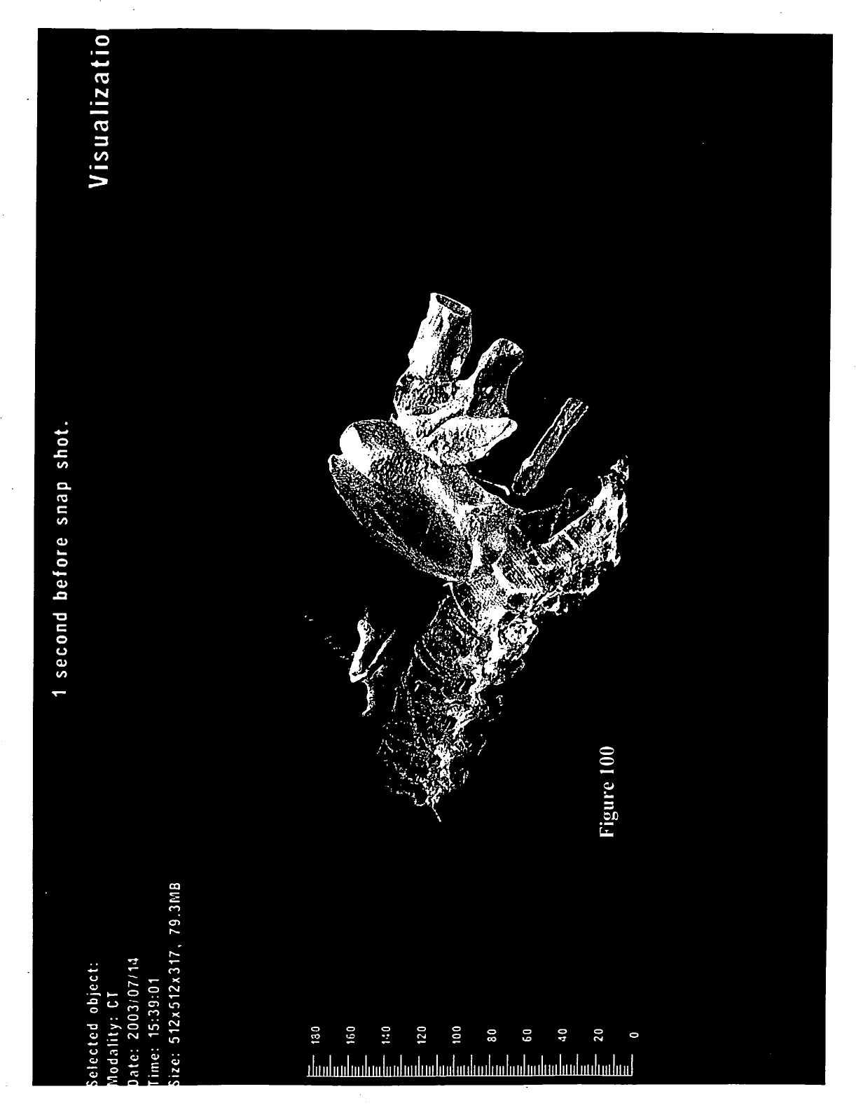

As can be appreciated from FIGS. 7-65 and the foregoing discussion of same, colon polyps are difficult to discern to the untrained eye. Thus, for purposes of illustration of certain display functionalities of exemplary embodiments according to the present invention, FIGS. 66-101 depict various display features using an object more easily discernable to the general public, i.e., an air injector device. These exemplary figures will next be presented. They each depict various display parameters according to exemplary embodiments of the present invention. Many of FIGS. 66-101 illustrate isolation of the object of interest from the surrounding issue. These illustrative visualizations allow a user to study an object of interest in detail, perform measurements, study the inside voxels of the structure, or any other suitable analysis tasks.

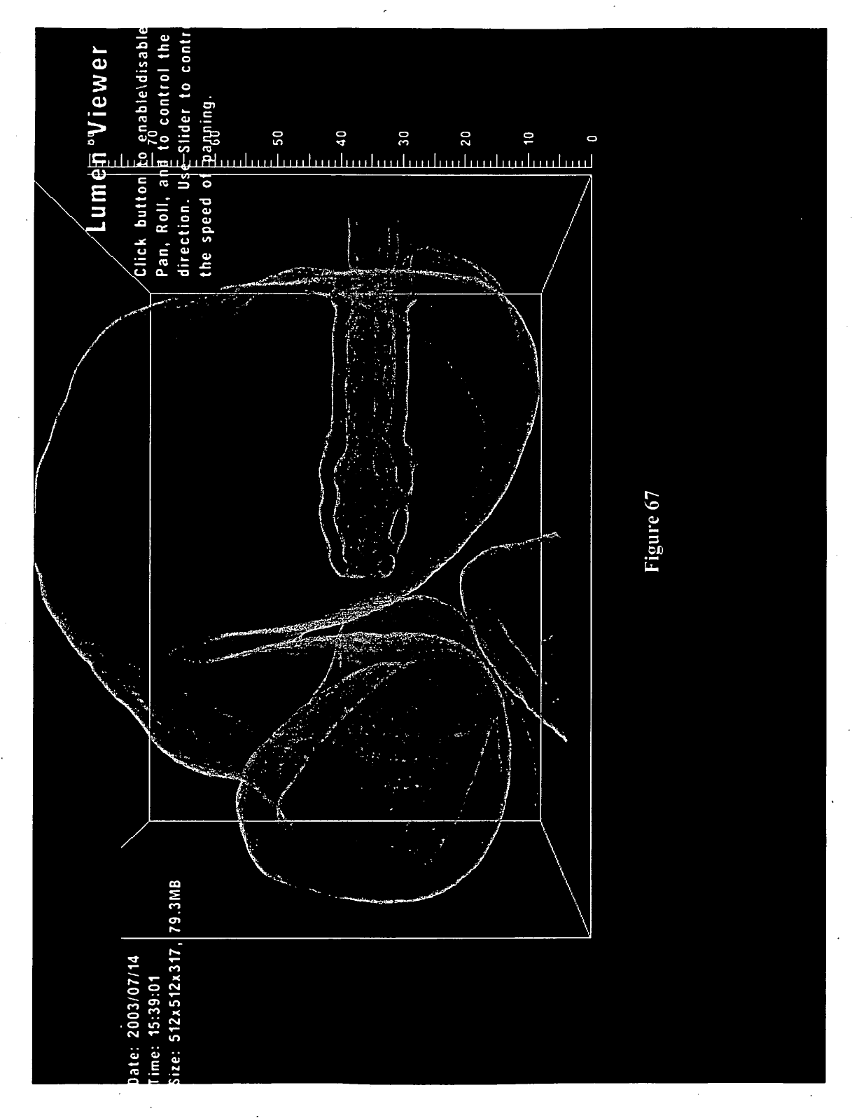

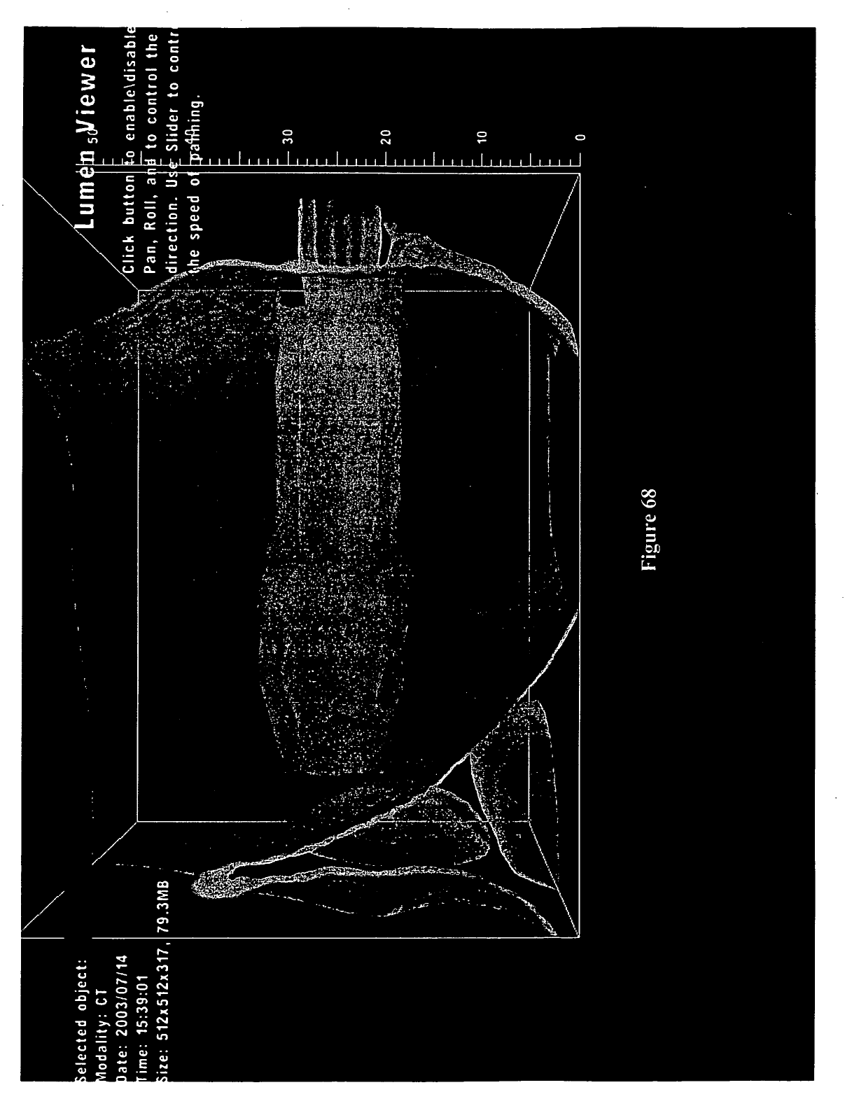

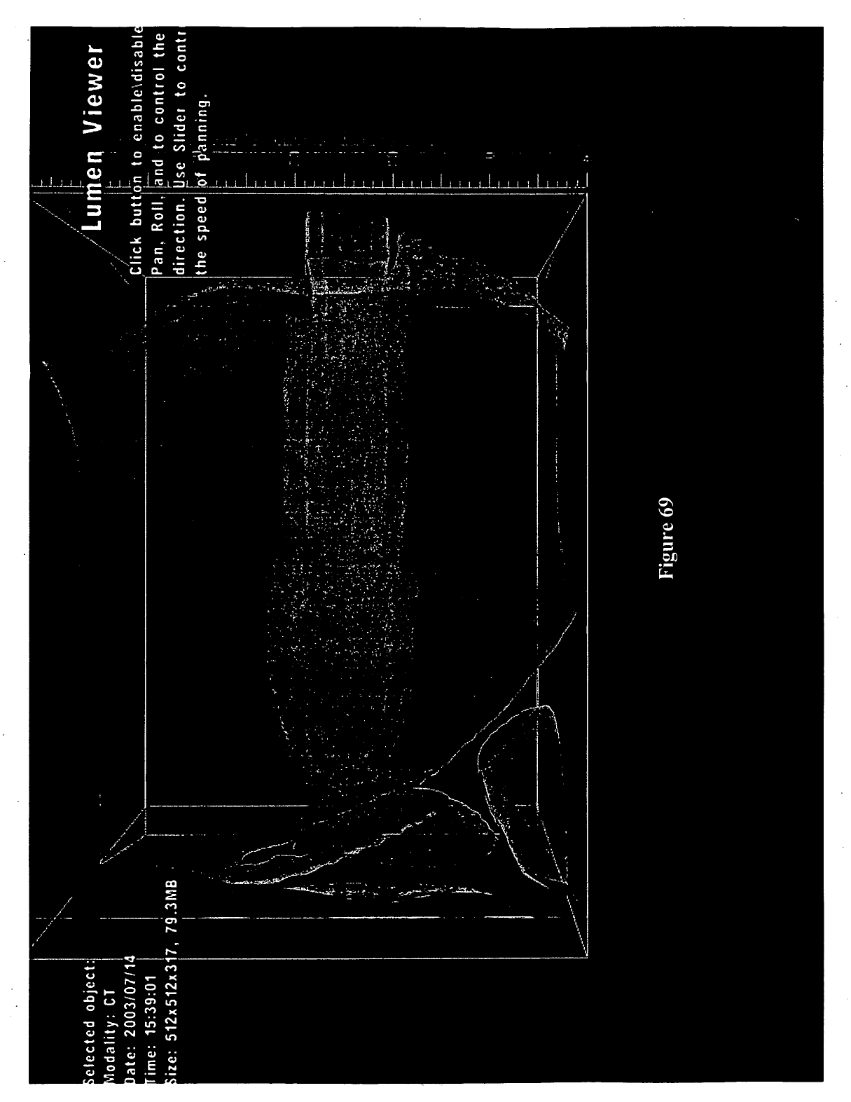

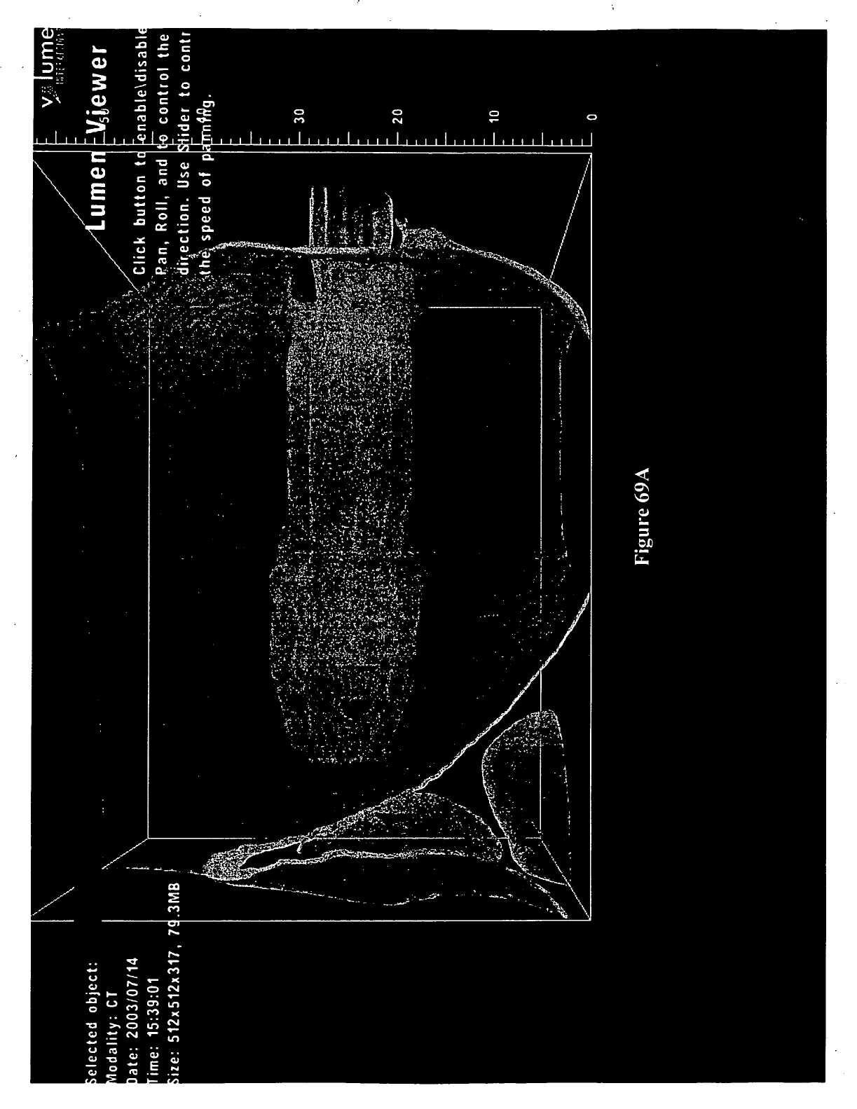

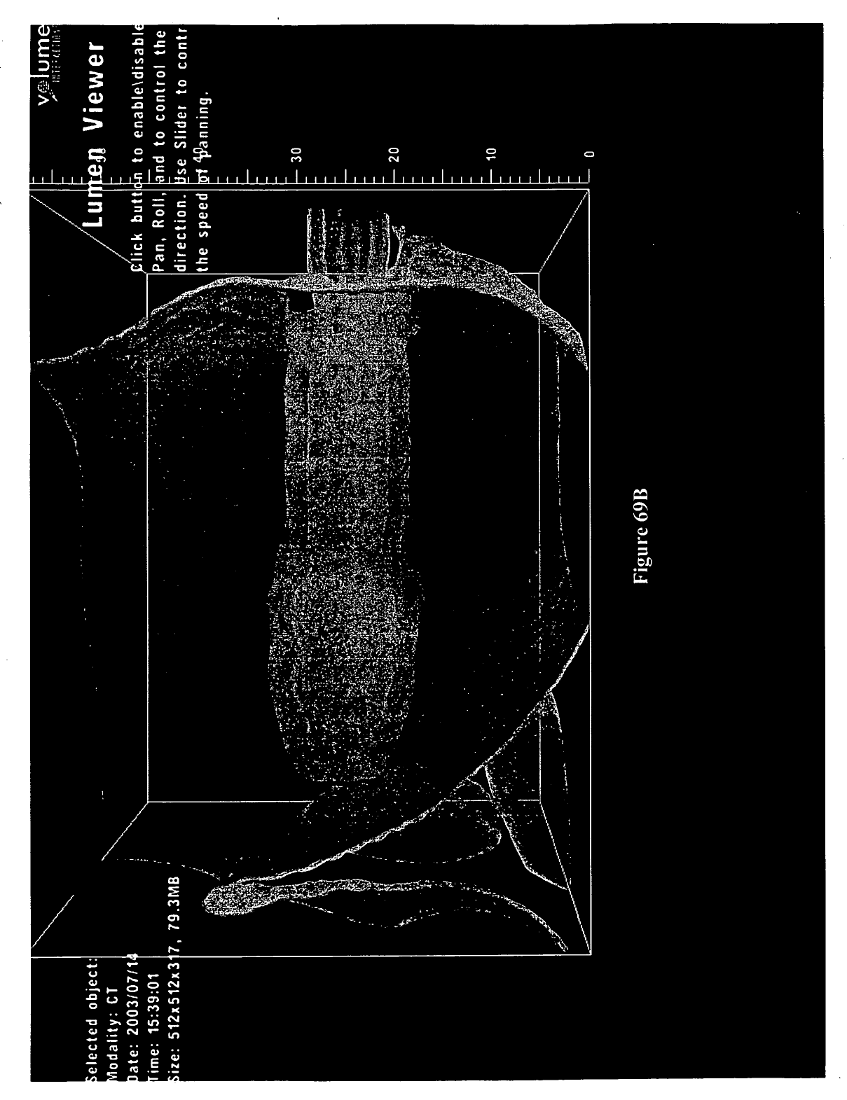

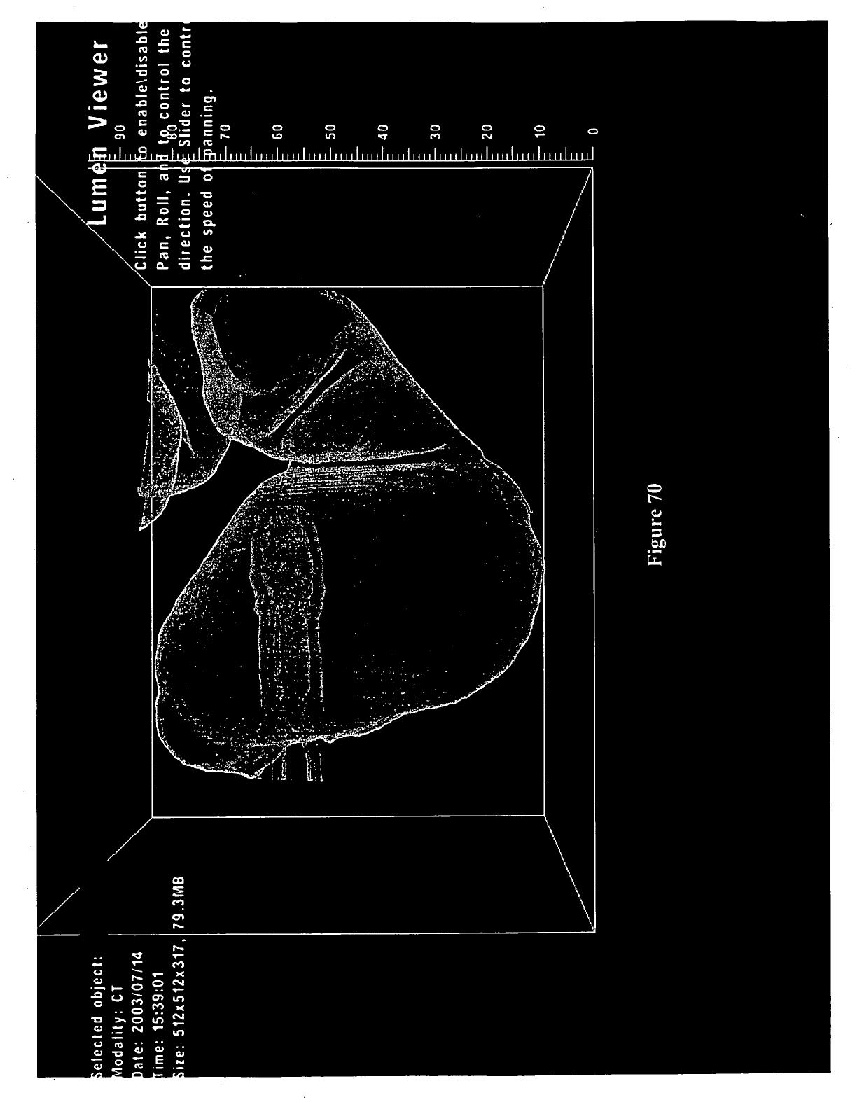

FIG. 66 depicts an exemplary transparent view of the entire colon, with Air Injector device inserted into rectum (in color drawing, yellow line pointing at anus). Similarly, FIG. 67 also illustrates an Air Injector device inserted into rectum. However, the view of FIG. 67 is an exemplary transparent magnified view. FIG. 68 illustrates an exemplary transparent view with higher magnification of an Air Injector device inserted into rectum. Turning to FIG. 69, an exemplary red-green stereo image is depicted with an Air Injector device inserted into rectum. FIG. 69A illustrates the red channel image of an Air Injector device inserted into rectum, while FIG. 69B shows the green channel of the same Air Injector device. The red and green channels of FIGS. 69A and 69B, illustrated in black and white, can be combined to form a red-green stereoscopic image. FIG. 70 depicts the air injector device of FIG. 67 rotated 180 degrees, and illustrates a transparent magnified view.

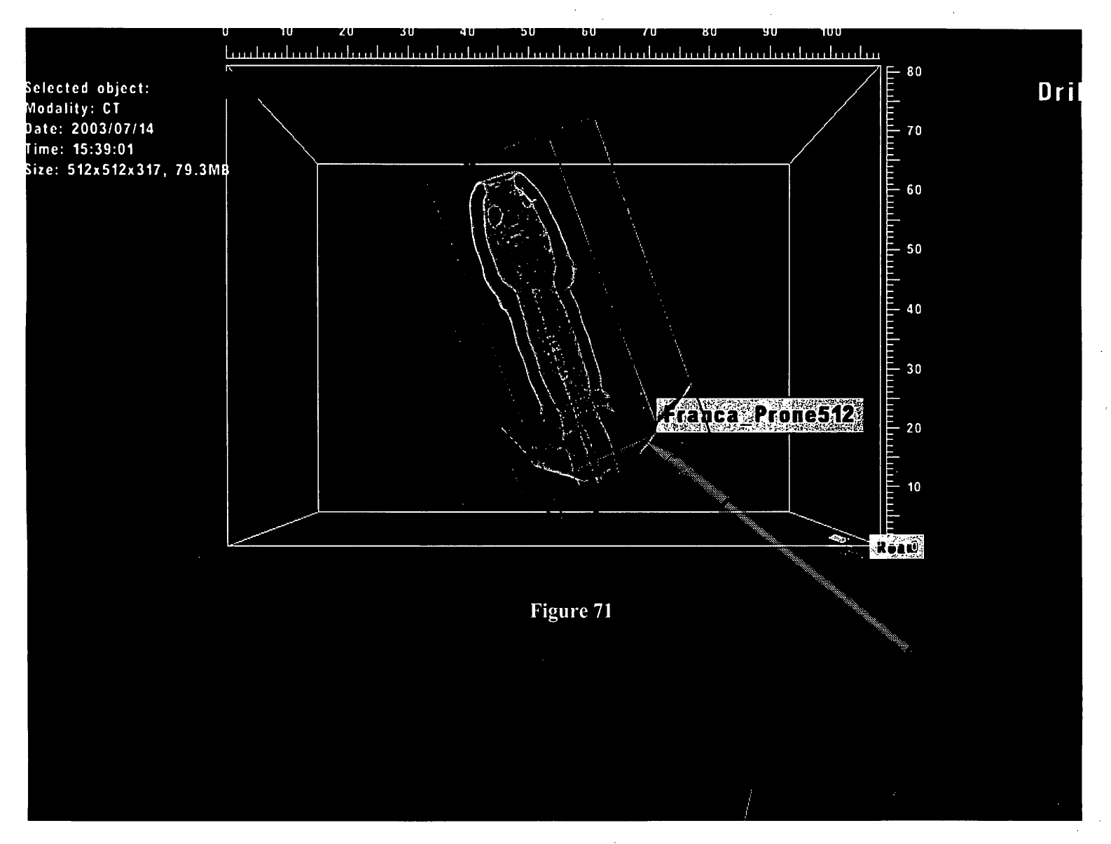

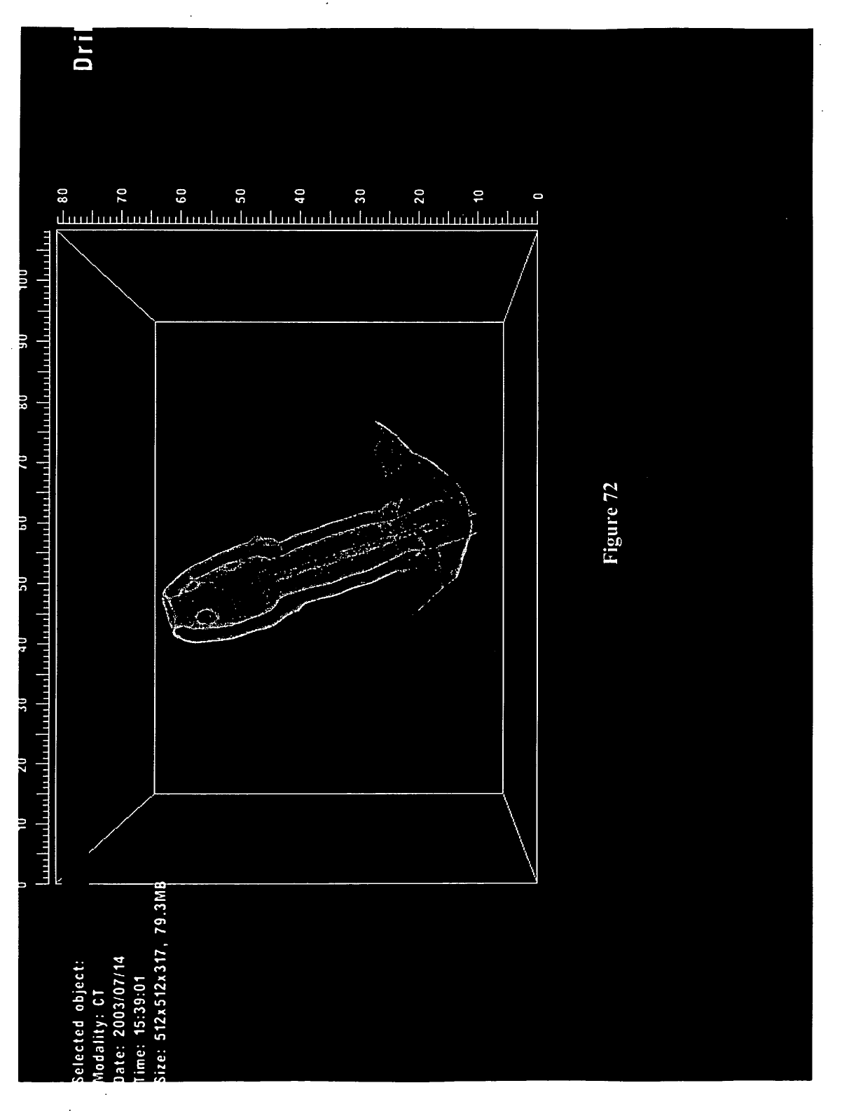

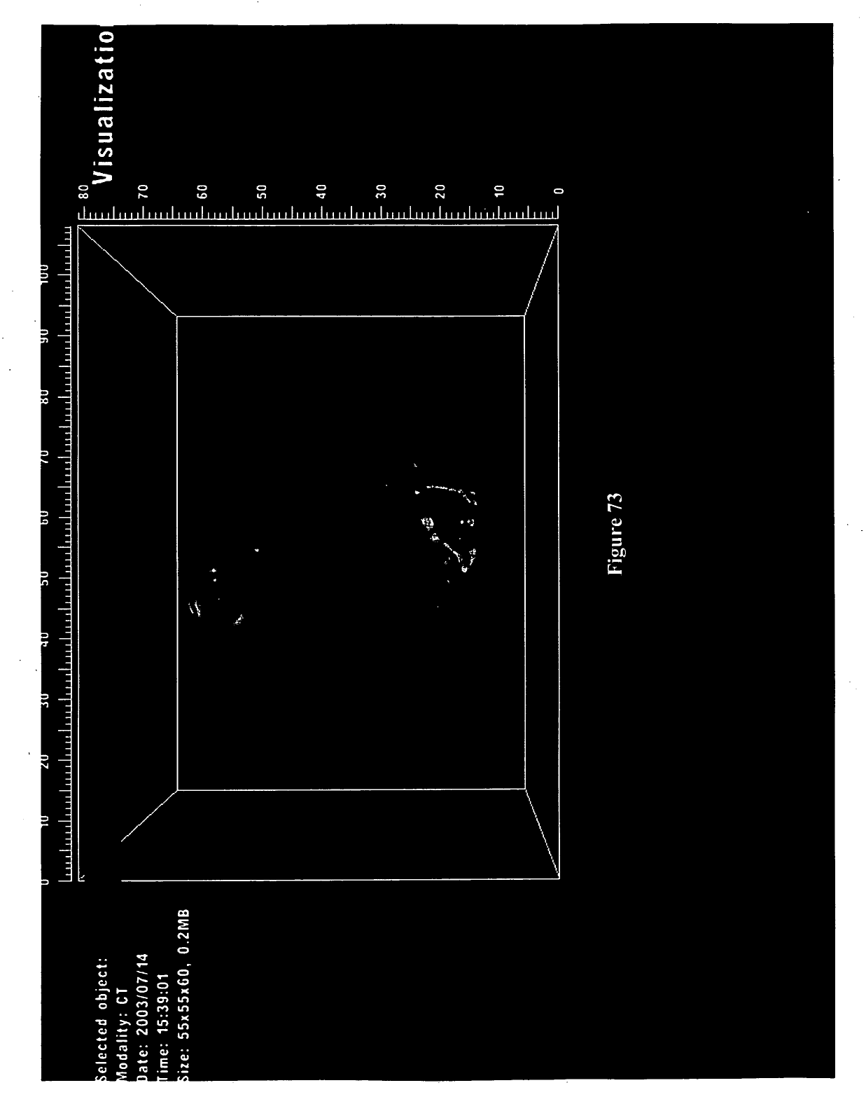

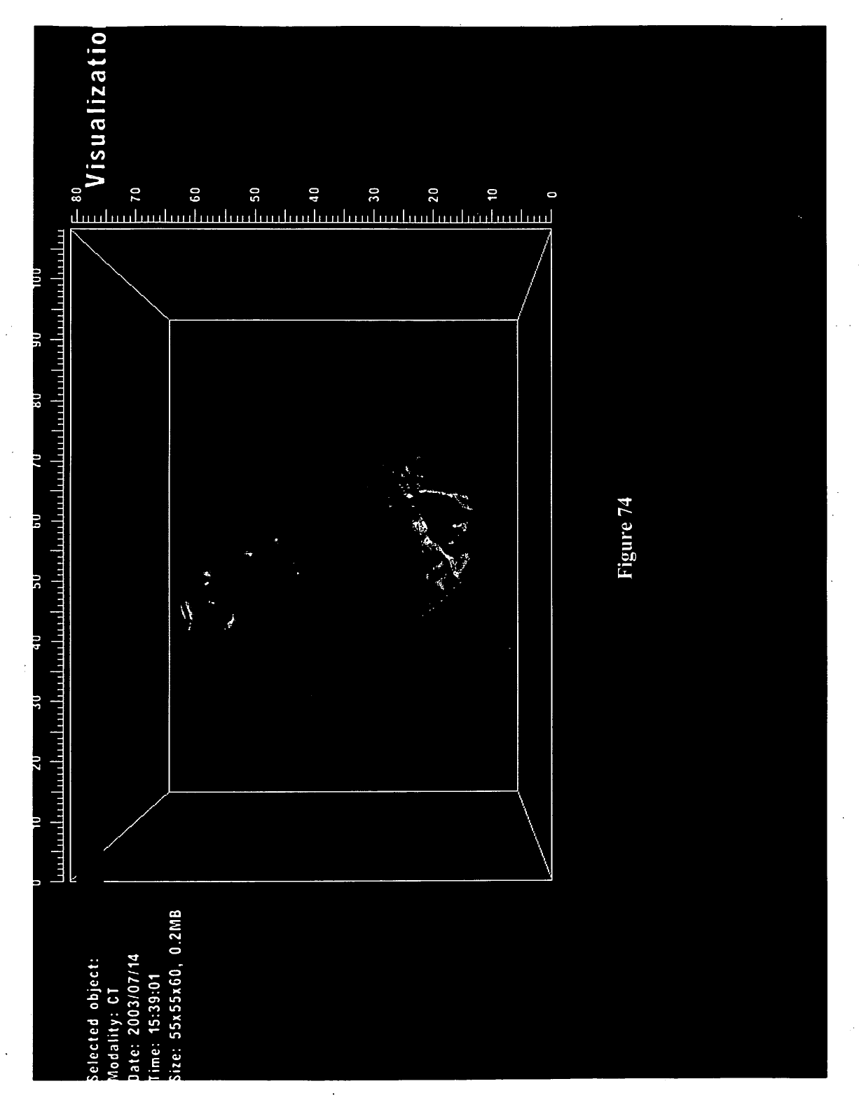

FIGS. 71 and 72 illustrate transparent views of an Air Injector device inserted into rectum. A user is adjusting a crop box to isolate the device, without showing the surrounding tissue (rectum). Similar functionality could be applied to a polyp or other region of interest. FIG. 73 depicts the Air Injector device of FIG. 72, but FIG. 73 shows the shaded view after isolation of the device from surrounding tissue. FIG. 74 illustrates the shaded view of the air injector device with slightly different CLUT after isolation of the device from surrounding tissue (rectum).

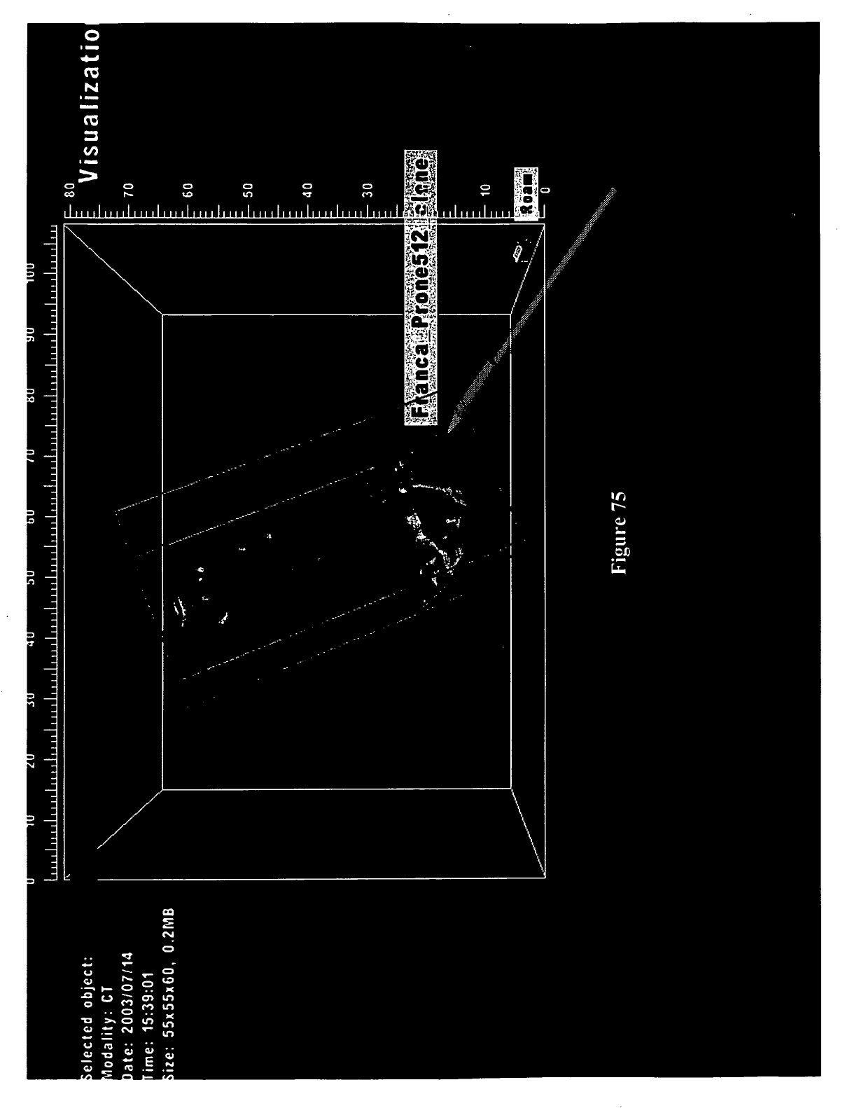

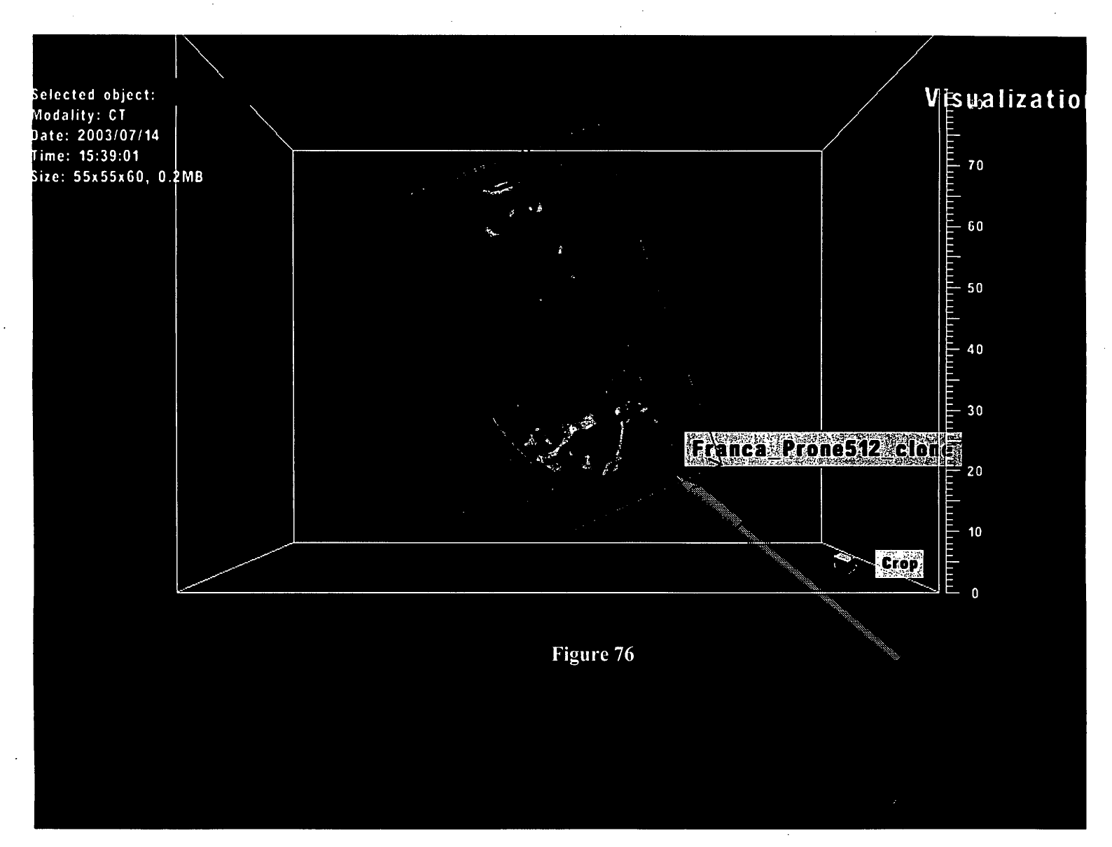

FIG. 75 depicts the Air Injector device of FIG. 71. As shown, FIG. 75 illustrates the shaded view (with crop box) after isolation of the device from surrounding tissue. FIG. 76 shows the Air Injector device of FIG. 75 in an alternative shaded view.

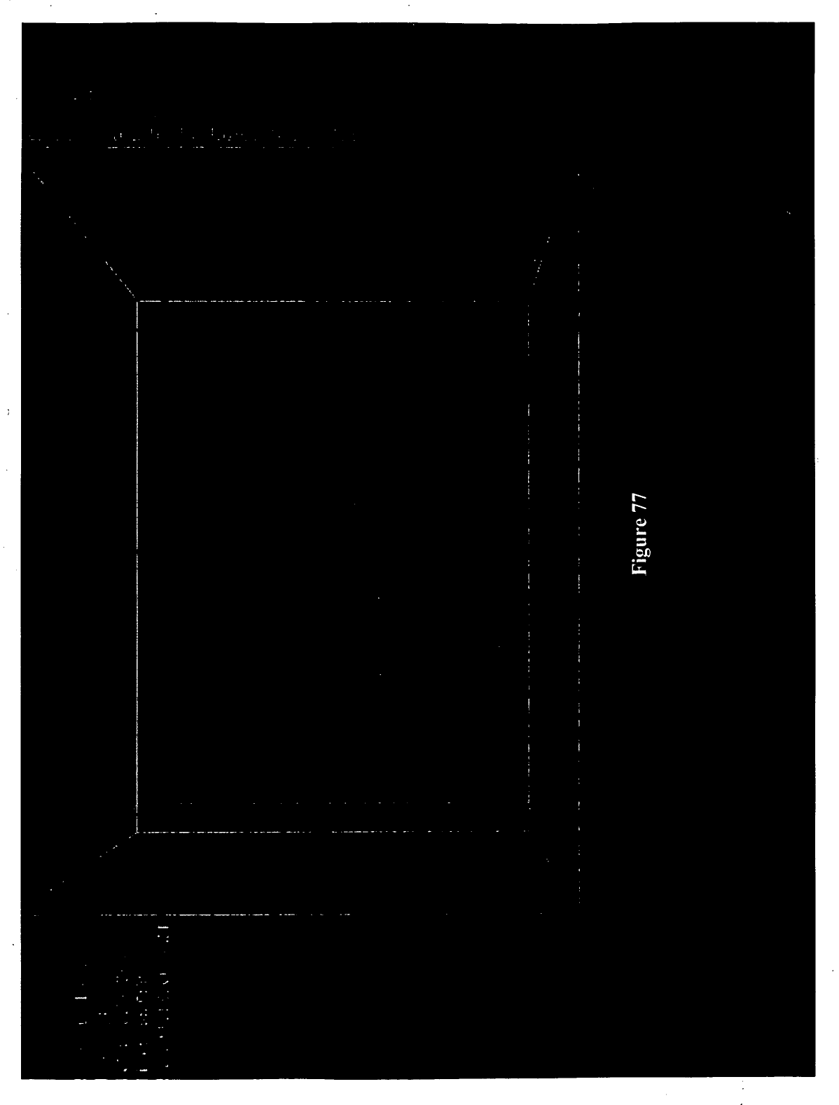

FIG. 77 illustrates a red-blue stereo image of the air injector device of FIG. 76. FIGS. 77A and 77B illustrate the separate red and blue channels of a red-blue stereo image of the air injector device of FIG. 76. The red and blue channel information of FIGS. 77A and 77B, shown in black and white, can be combined to form a red-blue stereo image.

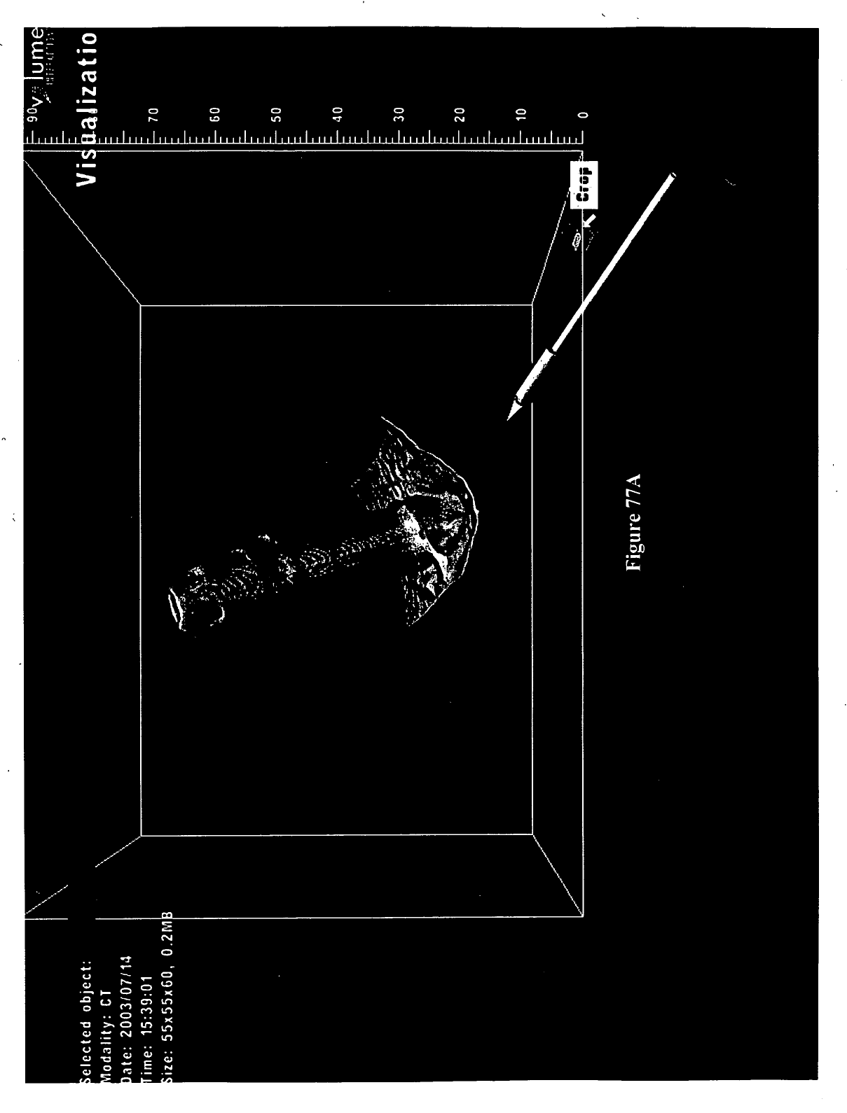

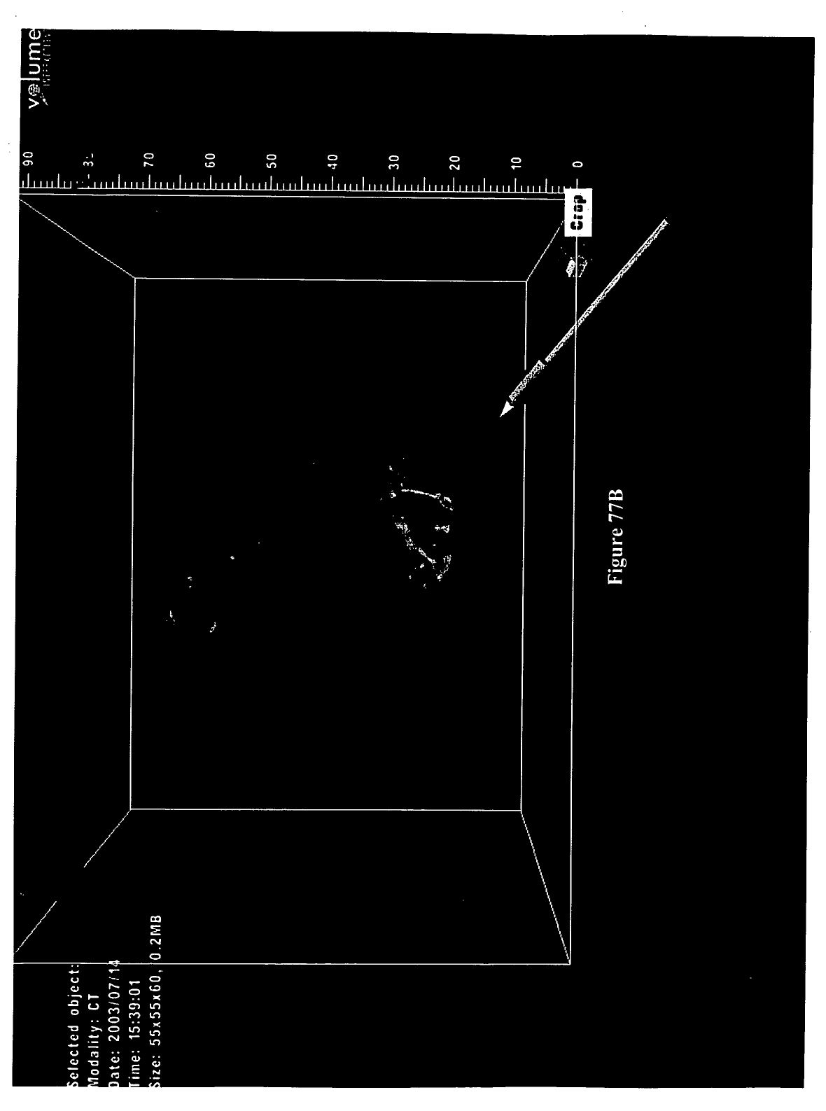

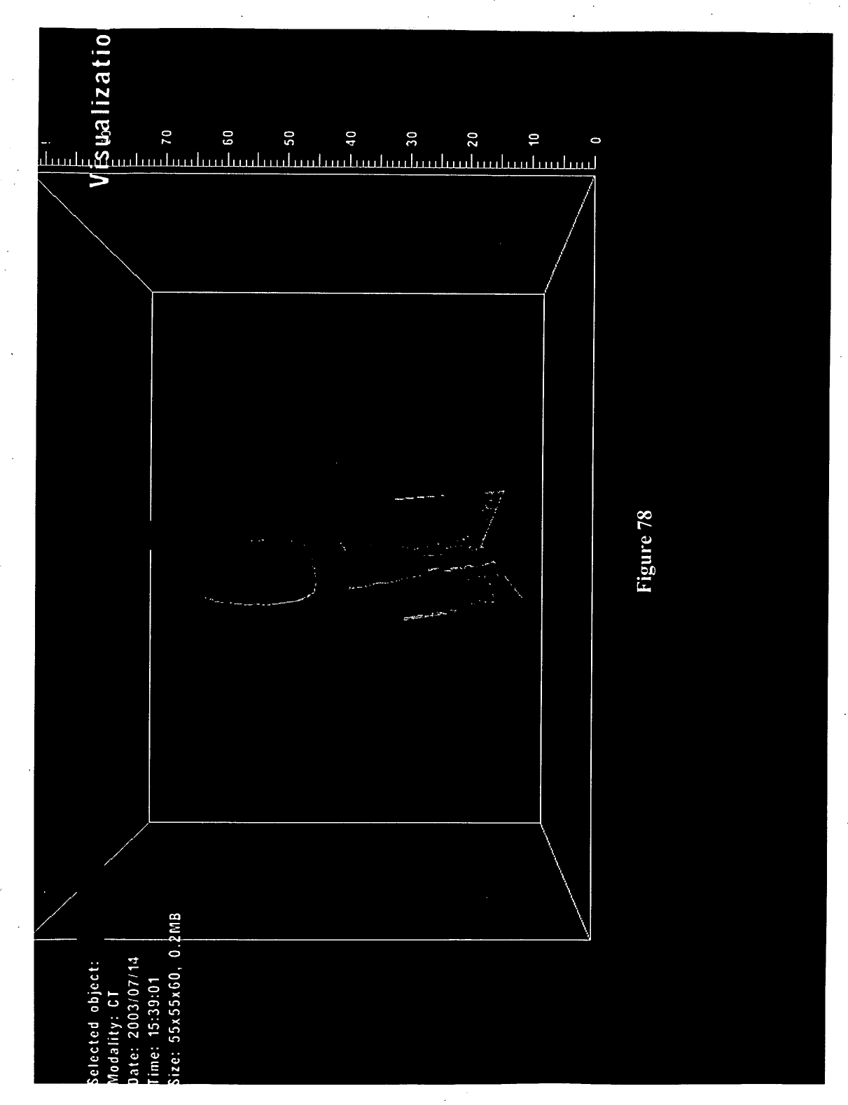

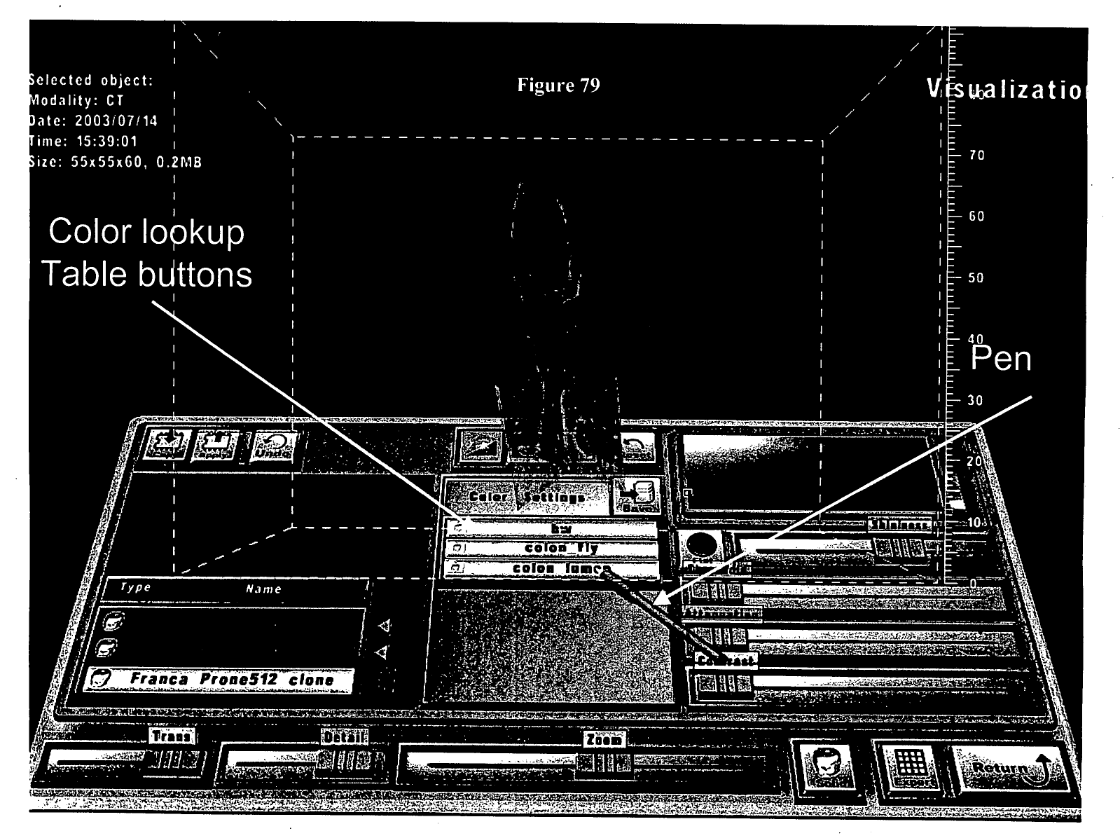

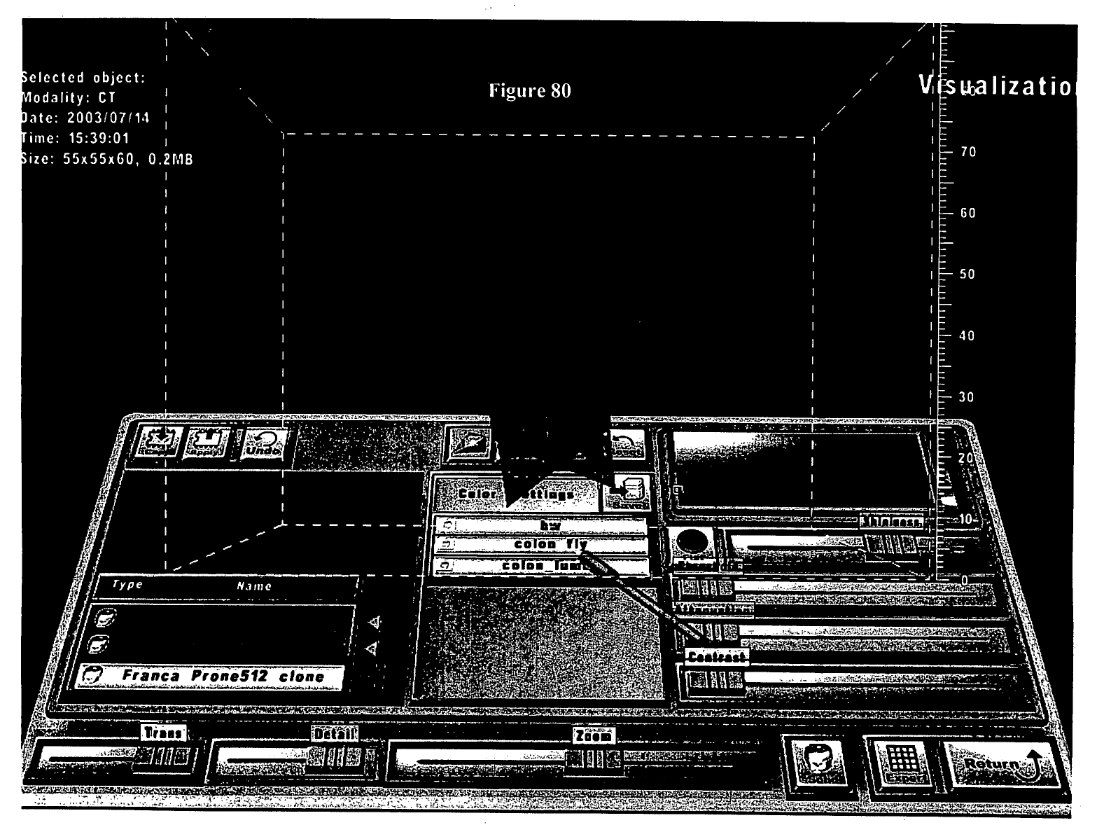

Turning to FIG. 78, the Air Injector device of the previous figures is shown using a tri-planar view (three orthogonal planes intersecting the air injector longitudinal axis) after isolation of the device from surrounding tissue. This exemplary view reveals the actual scan values for final decision. FIGS. 79 and 80 also illustrate tri-planar views of the Air Injector device, although the views in these figure are transparent tri-planar view. In FIG. 79, an exemplary user interface, with an exemplary virtual pen device, is shown. A user can point to a color lookup table button (here labeled “colon_lumen”) to obtain a different visualization of the device. FIG. 80 also shows an exemplary user interface, where user can point to the color lookup table button (here labeled “colon_fly” which shows a red colored rendering) to obtain a different visualization of the device.

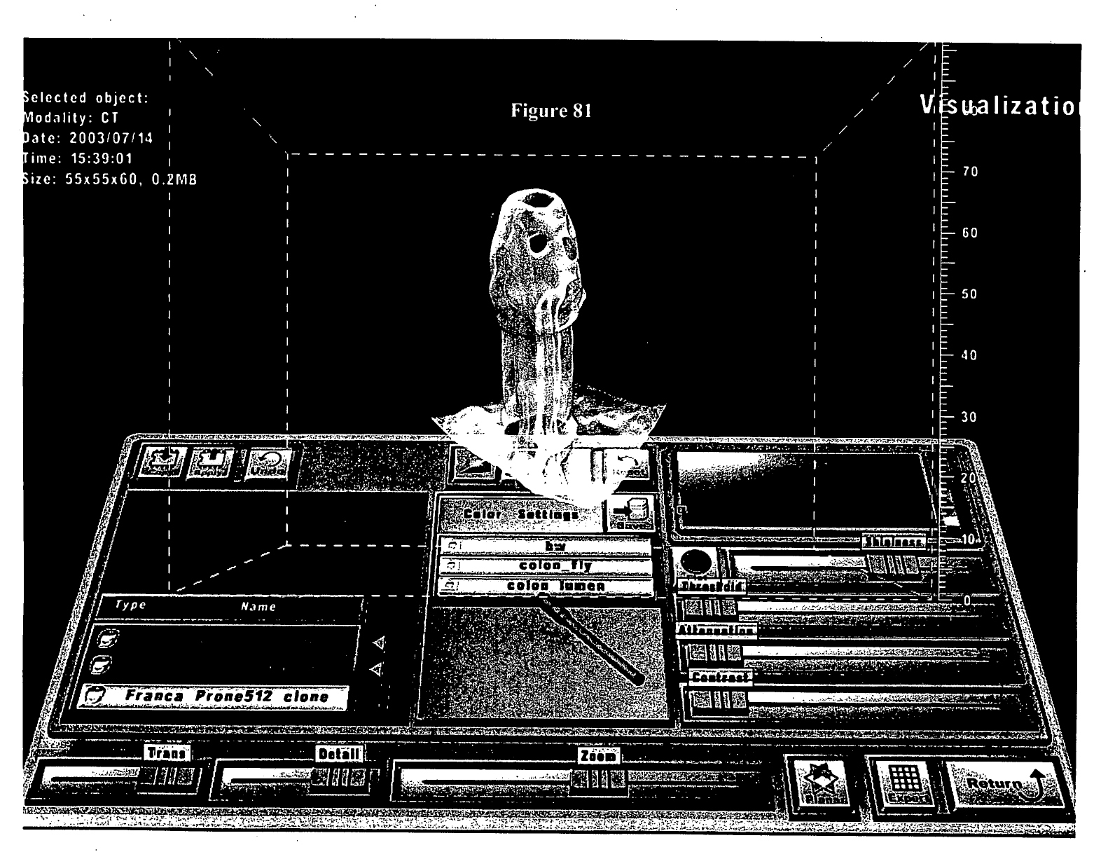

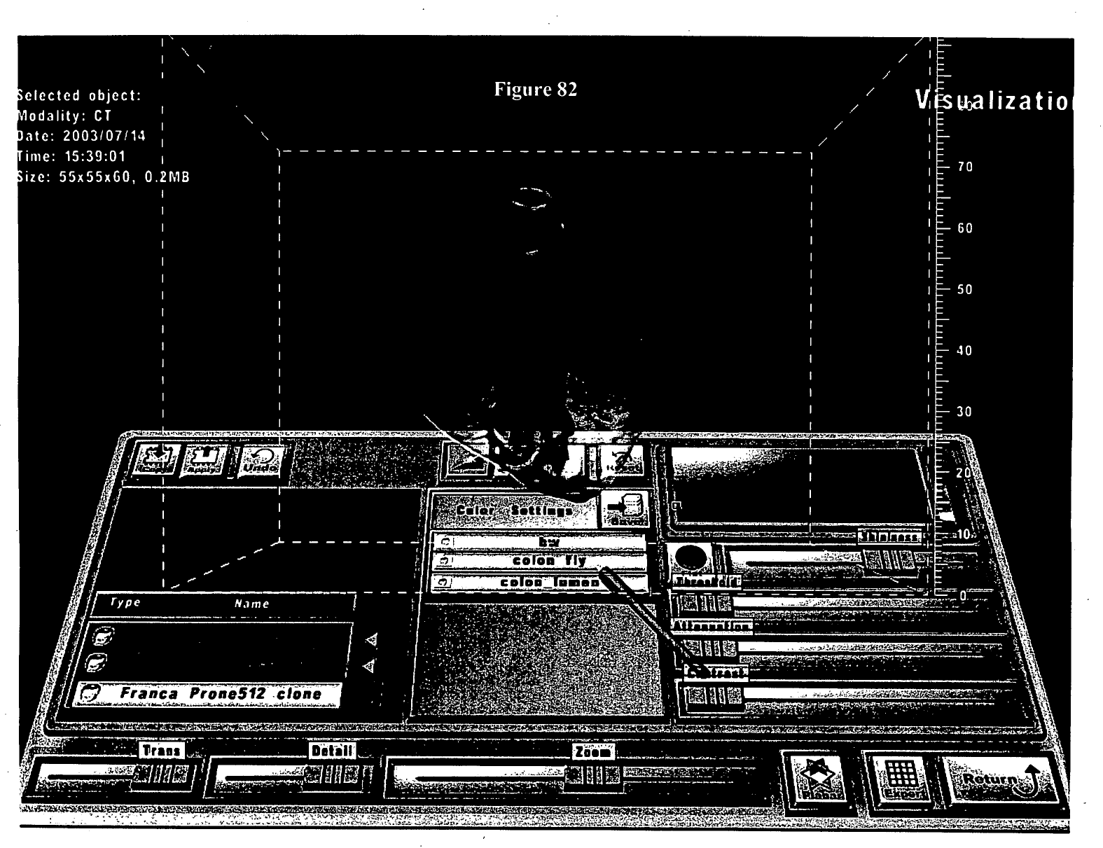

FIG. 81 depicts an Air Injector device inserted into rectum in a transparent volume rendered view after isolation of the device from surrounding tissue. A user can point to a color lookup table button (here labeled “colon_lumen”) to obtain a different visualization of the device. FIG. 82 shows a semi-transparent volume rendered view of the Air Injector device. An exemplary user interface is shown, where a user can point to a color lookup table button, here labeled “colon_fly”, to obtain a different visualization of the device.

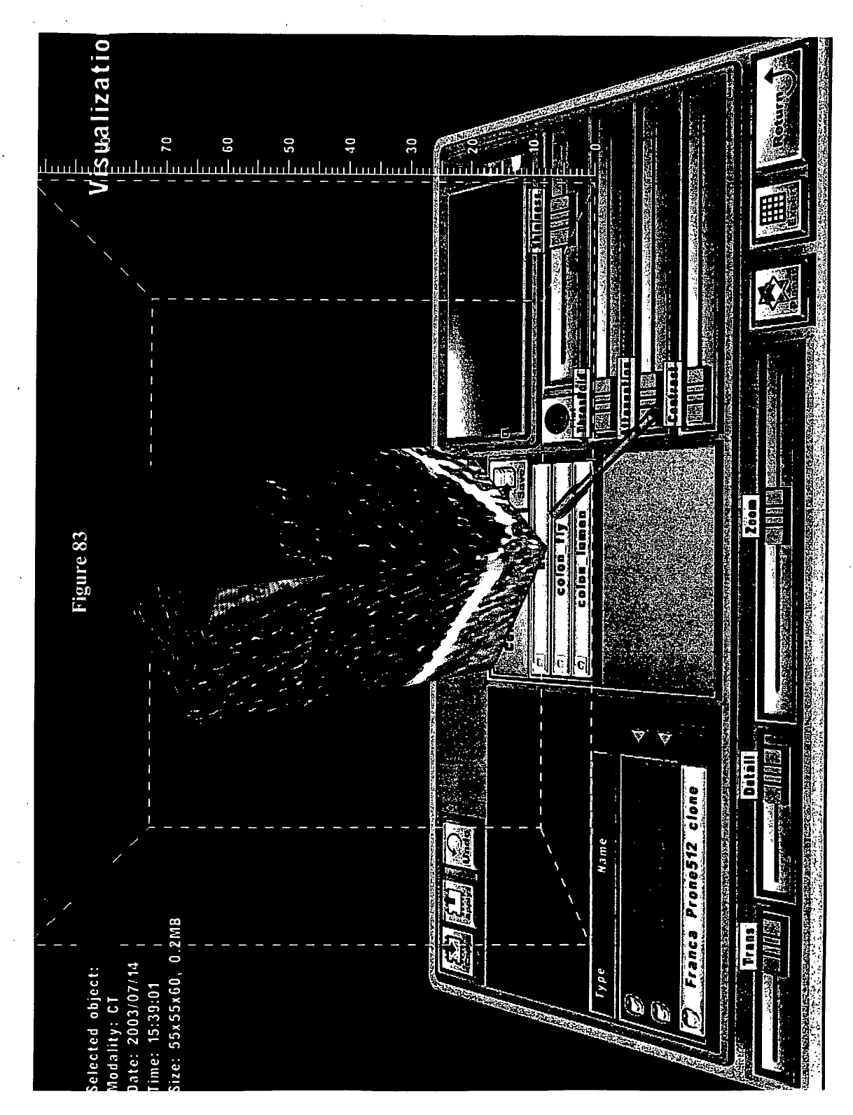

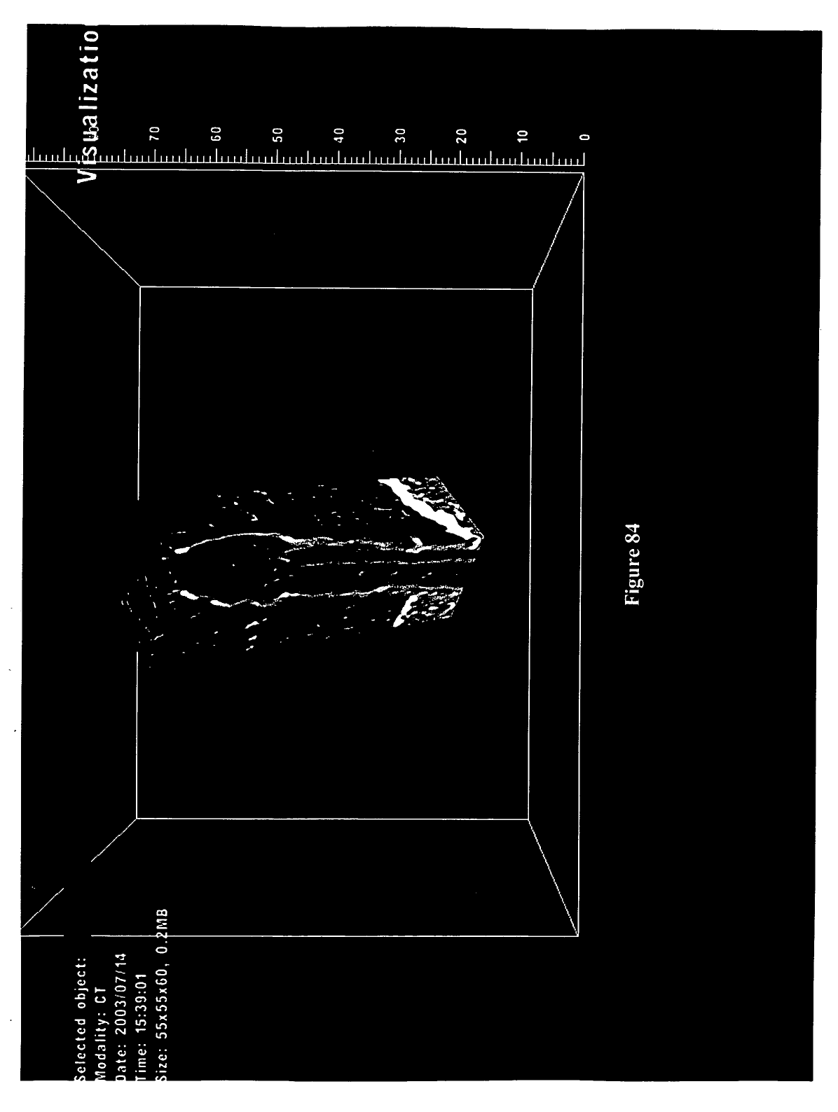

Turning to FIG. 83, a totally opaque view is shown of the Air Injector. This view reveals voxel values surrounding the device (within boundaries of crop box). A user may points to the color lookup table button in the exemplary interface (here labeled “bw” for black and white) to obtain a different visualization of the device. FIG. 84 also illustrates a totally opaque view of the Air Injector. However, the view is cropped to reveal voxel values inside the device. If the device were a polyp, investigation of interior voxel values as depicted would allow for the differentiation of an actual polyp from fecal matter. Here, as seen, the interior has the same voxel values as the surrounding air, as fecal matter might, and is thus not a polyp.

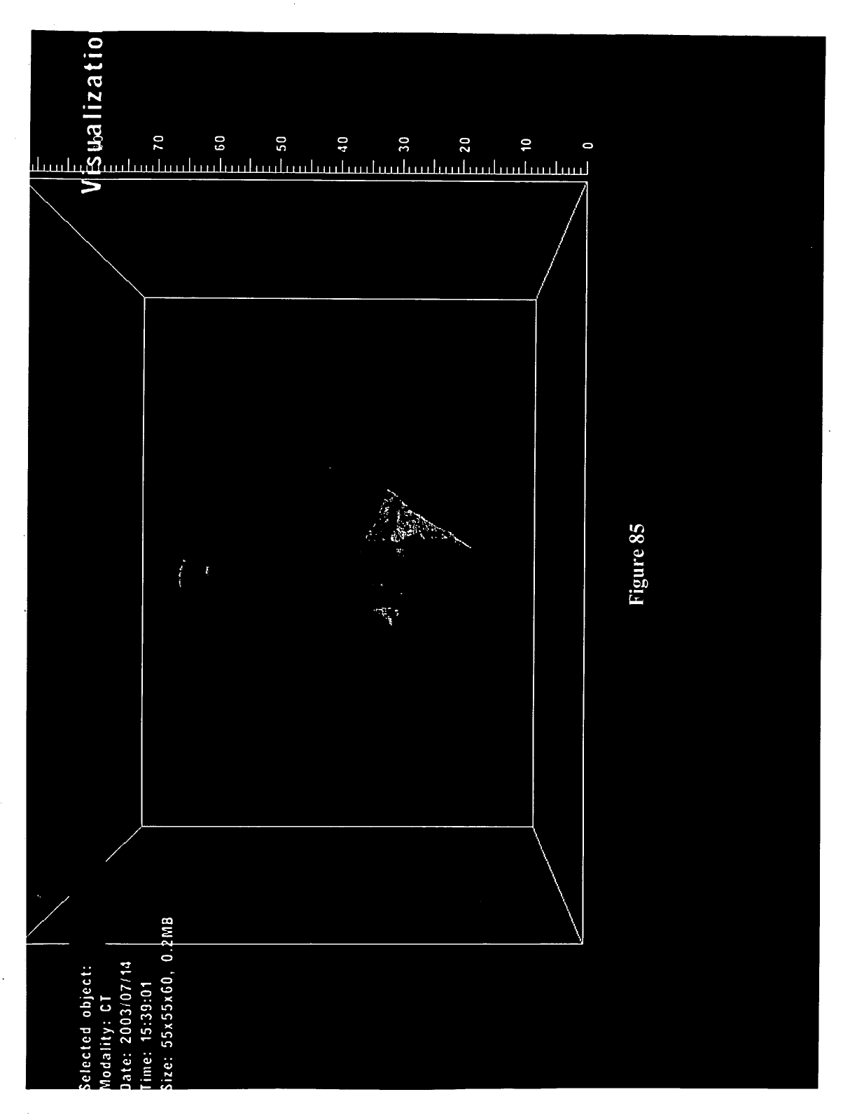

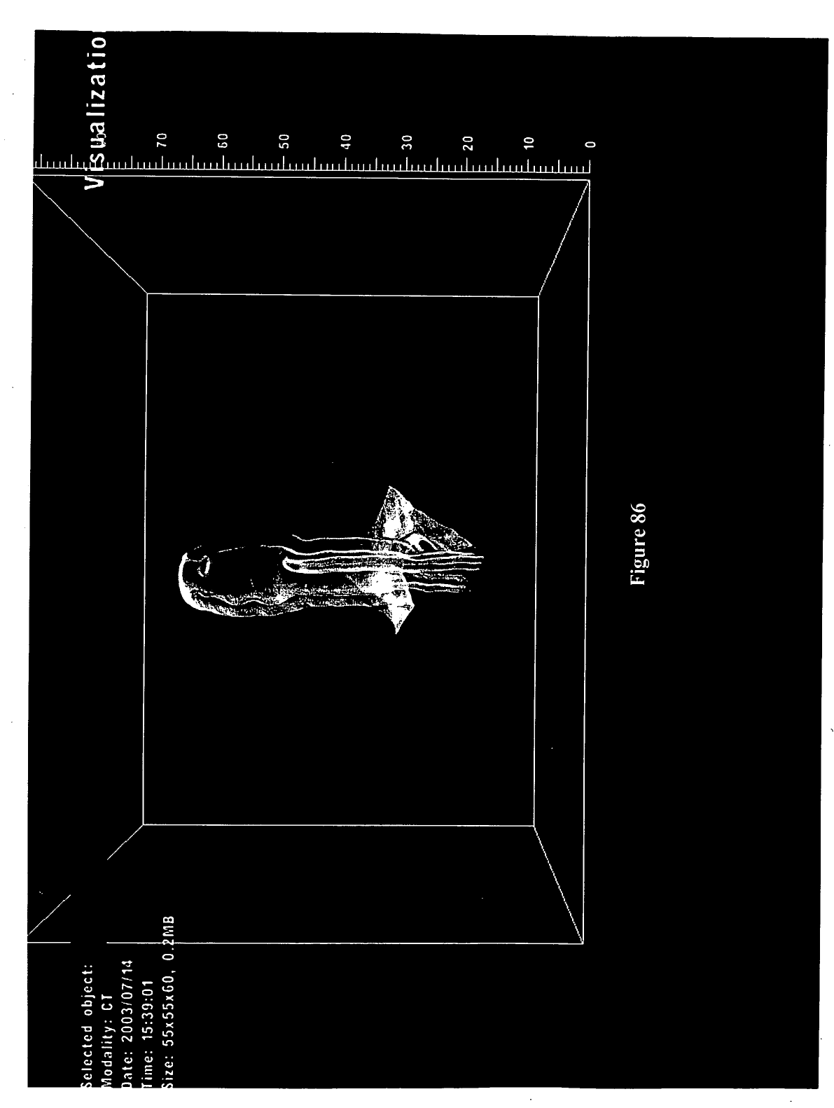

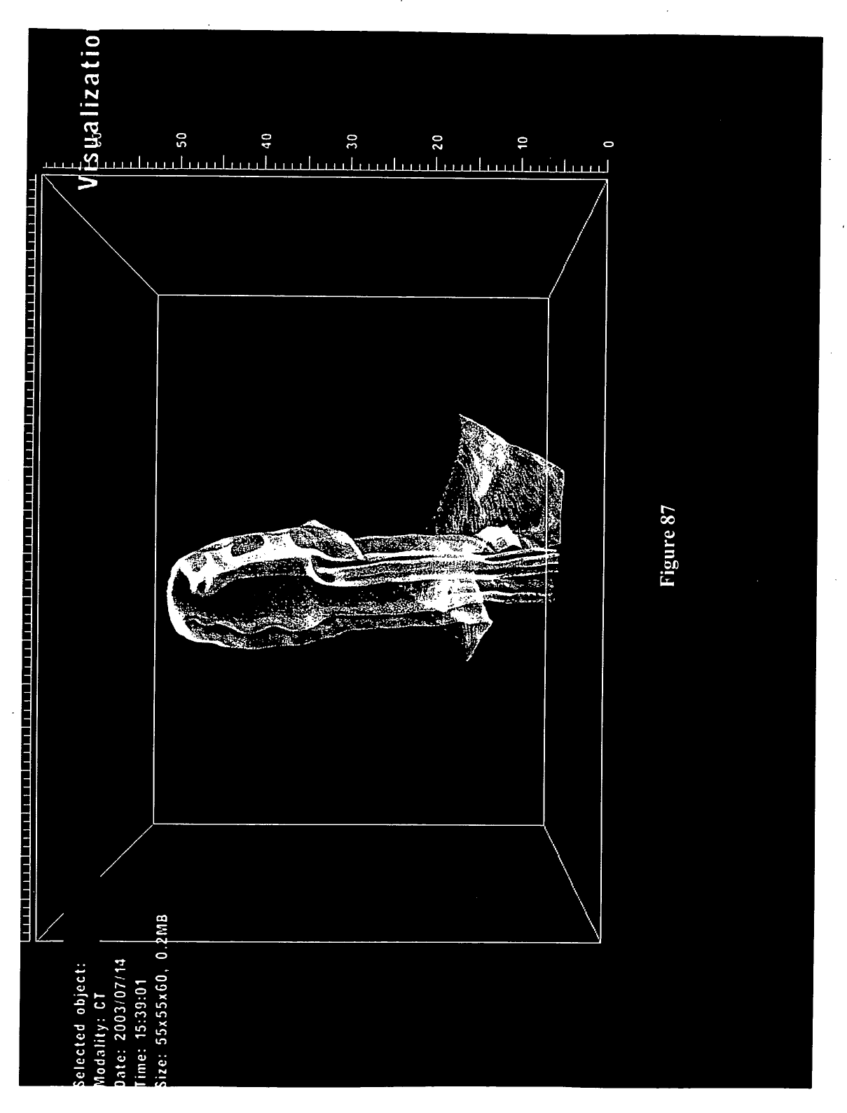

Turning now to FIG. 85, the Air Injector device is depicted using a transparent view cropped to reveal voxel values inside the device. FIG. 86 illustrates the Air Injector device with a transparent black and white view, cropped to reveal voxel values inside the device. As shown in FIG. 87, the Air Injector device is depicted using a transparent, magnified black and white view, which is cropped to reveals voxel values inside the device. The views in these figures are after isolation of the device from surrounding tissues, and reveal the actual scan values for final decision.

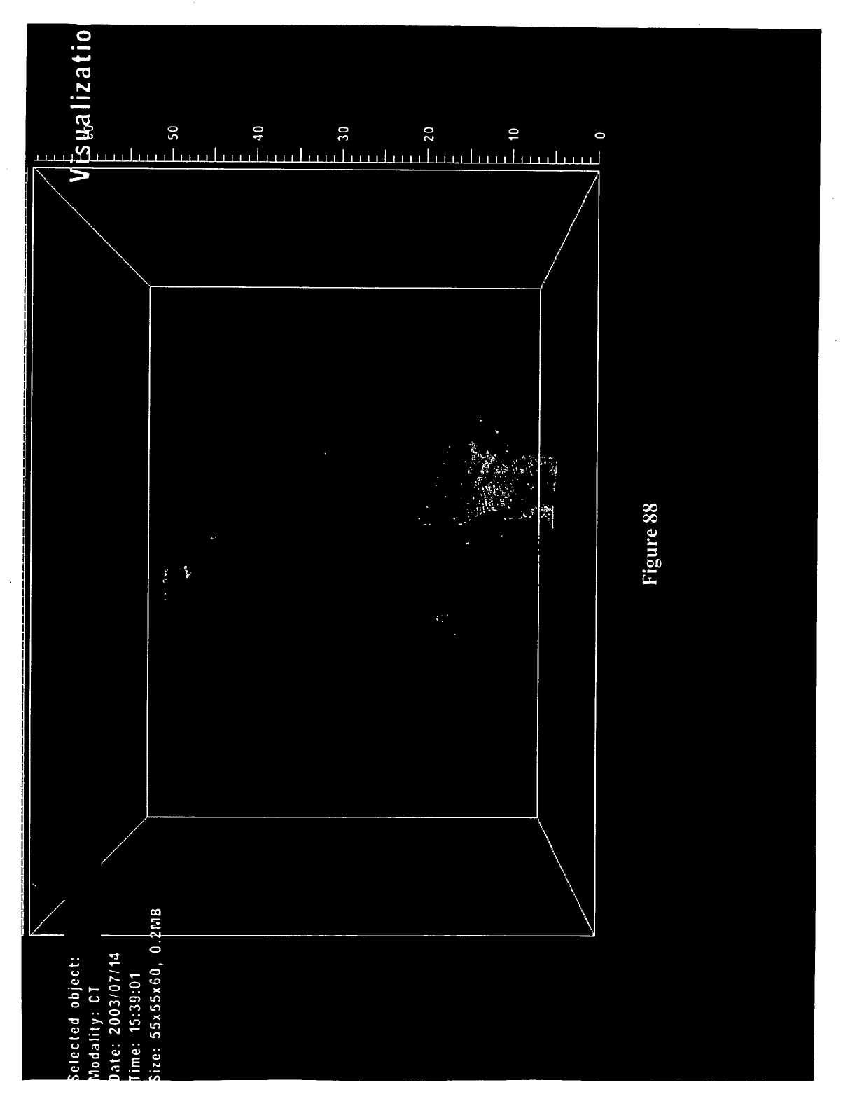

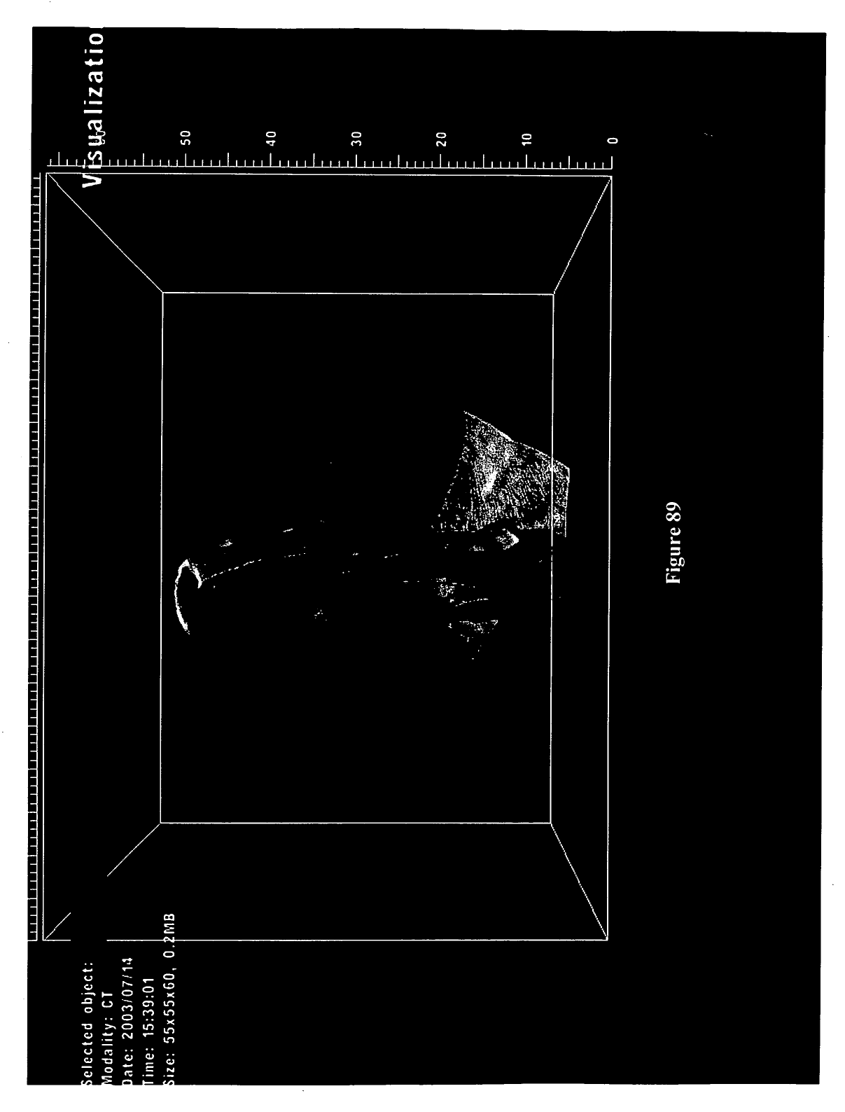

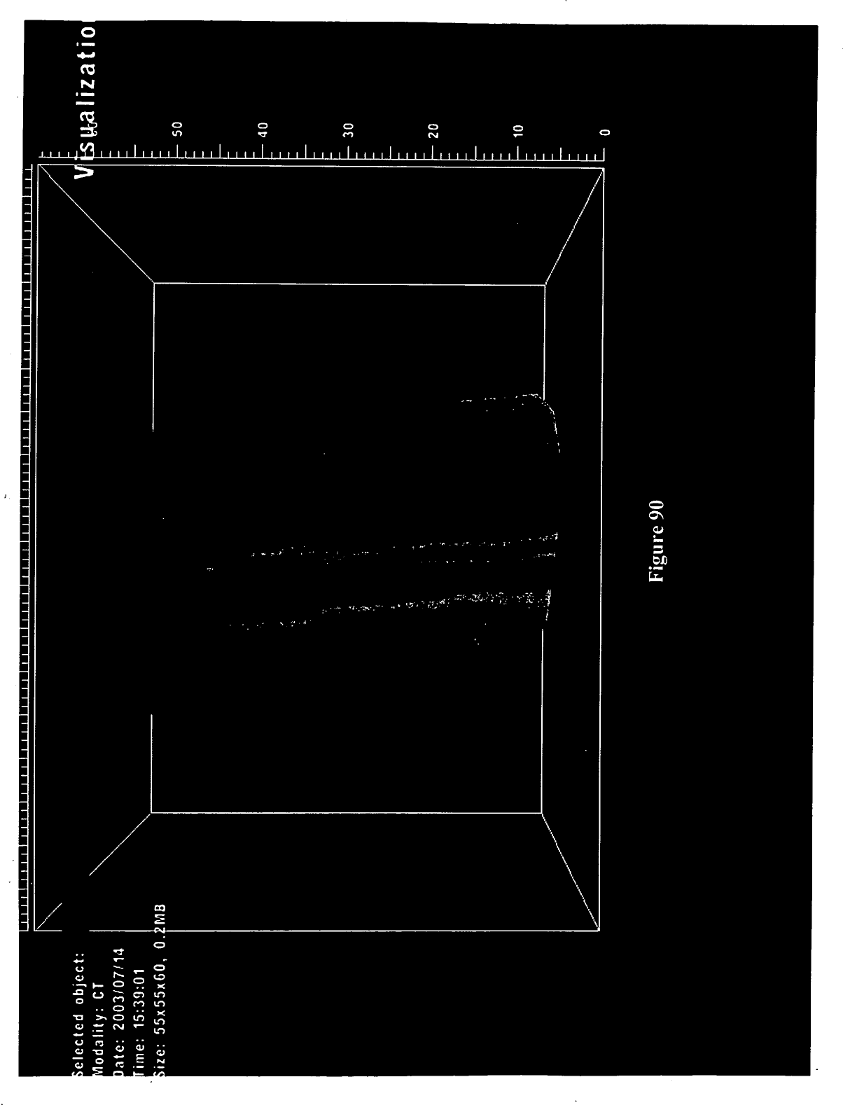

FIG. 88 depicts an Air Injector device using a transparent, magnified reddish view, cropped to reveal voxel values inside the device. Turning now to FIG. 89, the Air Injector device is depicted in a transparent, magnified black and red view, cropped to reveals voxel values inside the device. FIG. 90 illustrates the Air Injector device in a tri-planar, magnified black and white view, cropped to reveal voxel values inside the device.

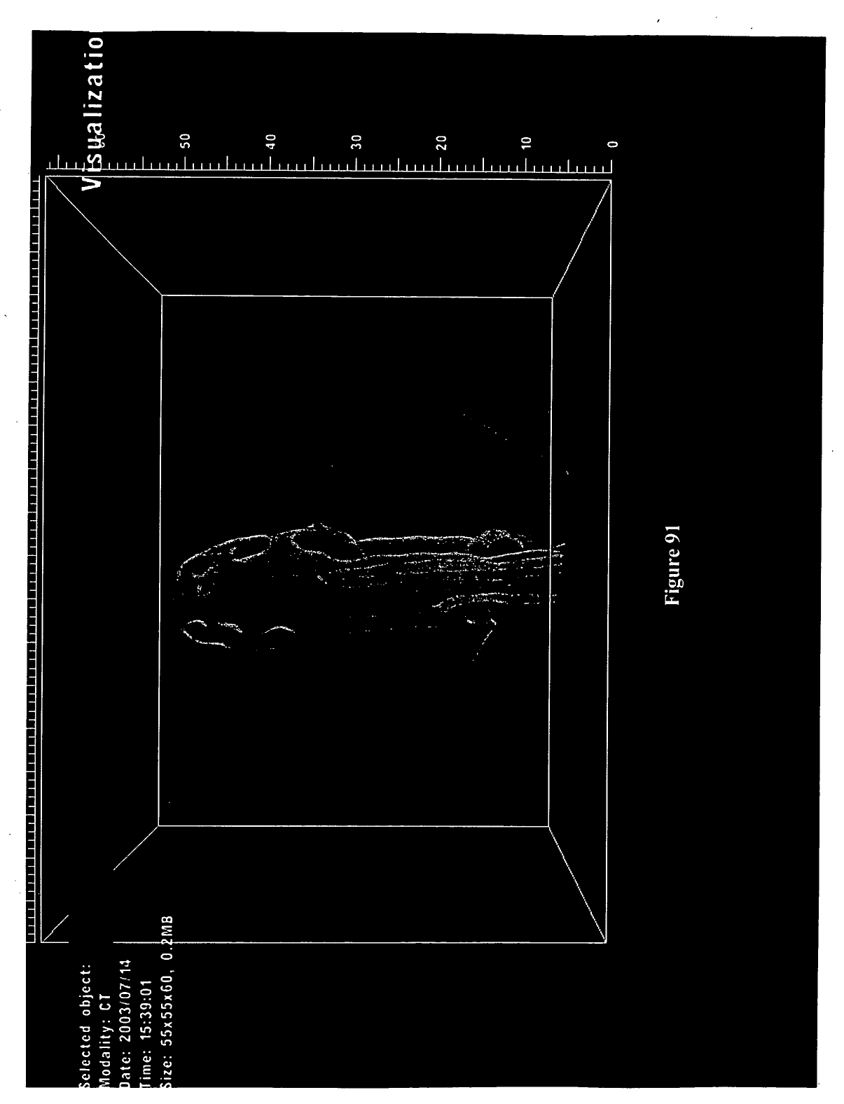

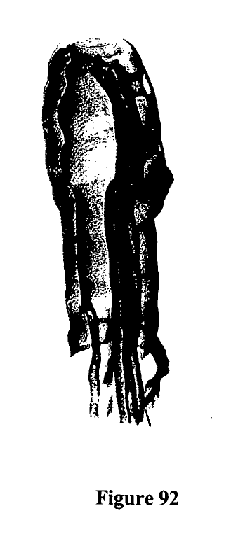

As shown in FIG. 91, the Air Injector device is depicted in a transparent, magnified black and white view, cropped to reveals voxel values inside the device. In FIG. 92, the Air Injector device is depicted in a transparent, magnified black and red view, cropped to reveals voxel values inside the device.

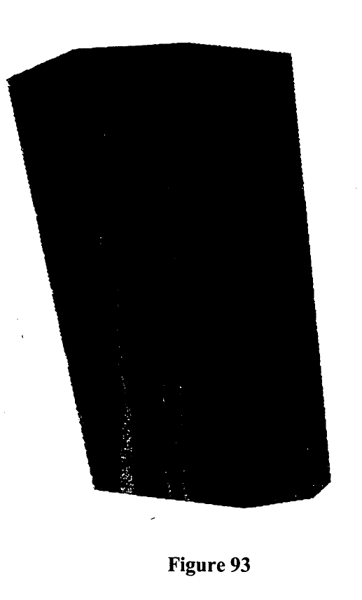

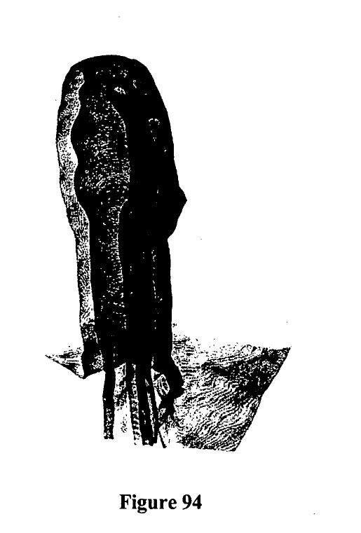

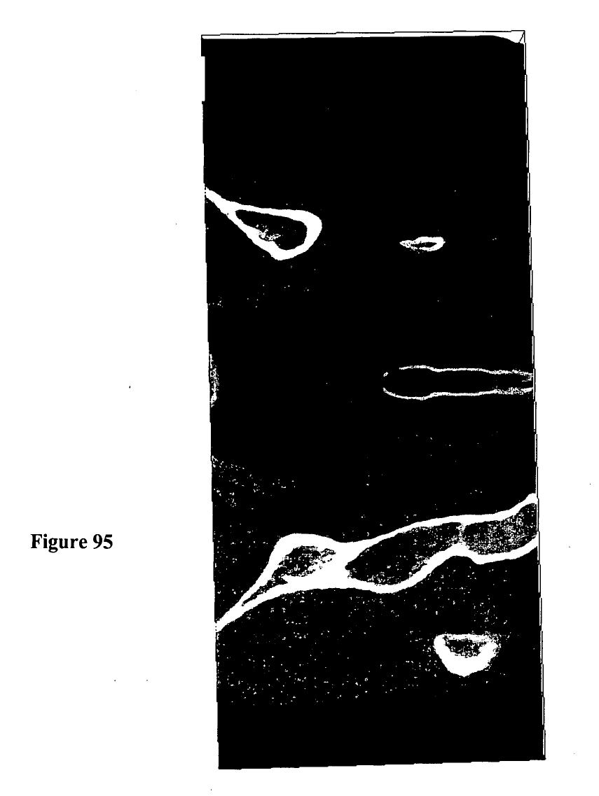

FIG. 93 depicts the air injector view of FIG. 90 against a white background according to an exemplary embodiment of the present invention. In FIG. 94, the air injector device of FIG. 91 is shown using a transparent black and white view with a slightly different look-up table against a white background according to an exemplary embodiment of the present invention. FIG. 95 depicts the exemplary air injector device. The figure shows an overview view of CT, cut to reveal the device and rectum. The bone is seen as white. FIG. 96 also shows the Air Injector device and reveals the bone, which is white.

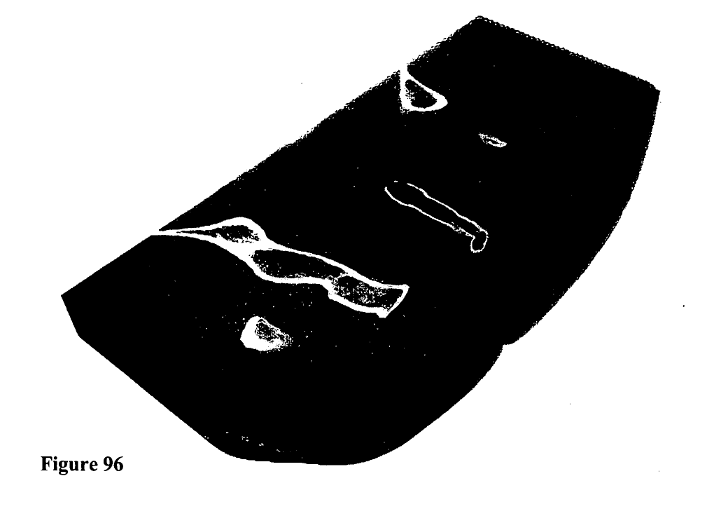

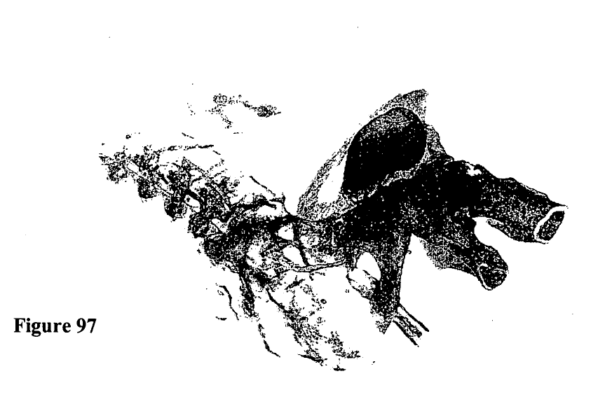

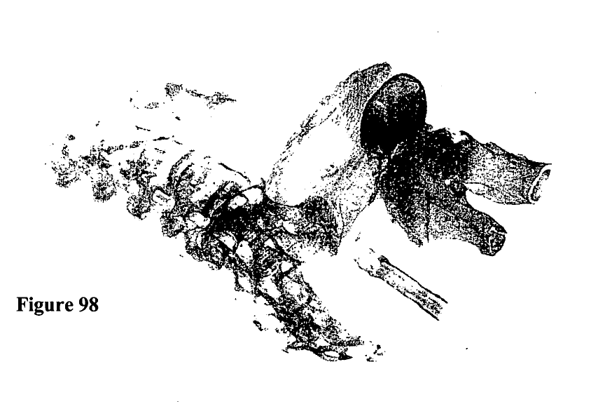

As shown in FIG. 97, an Air Injector device is illustrated with an overview view of CT, with bone (and other highly opaque materials like the air injector) revealed by means of a color lookup setting that makes the soft tissue transparent and the other tissue opaque. FIG. 98 also depicts an Air Injector device with an overview view of CT, with bone (and other highly opaque materials like the air injector) revealed by means of a color lookup setting that makes the soft tissue transparent and the other tissue opaque.

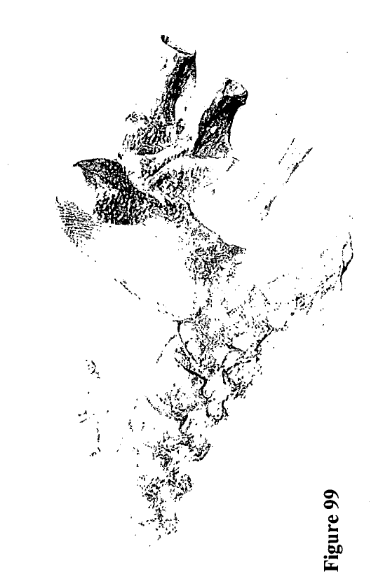

Turning now to FIGS. 99-101, an Air Injector device is illustrated with a shaded overview view of CT, with bone (and other highly opaque materials like the air injector) revealed by means of a color lookup setting that makes the soft tissue transparent and the other tissue opaque. In FIG. 101, the air injector is seen behind the bone.

Virtual Endoscopy and Centerline Generation and Interface

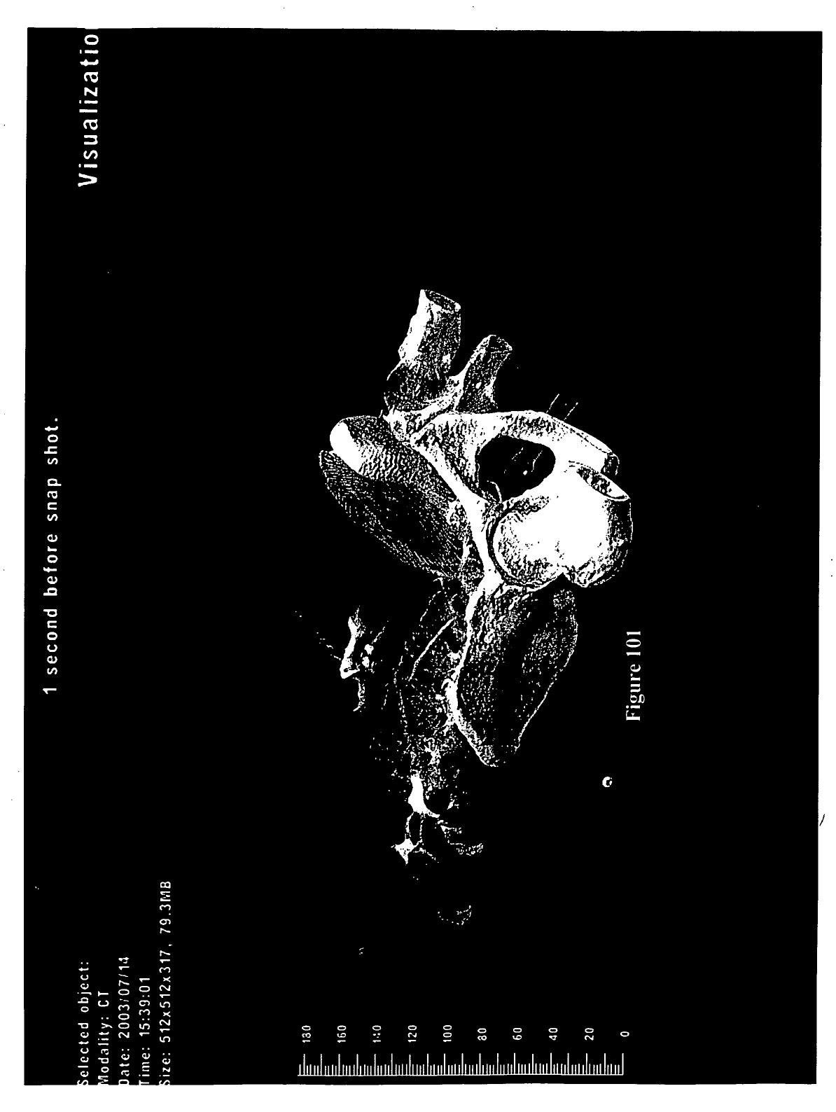

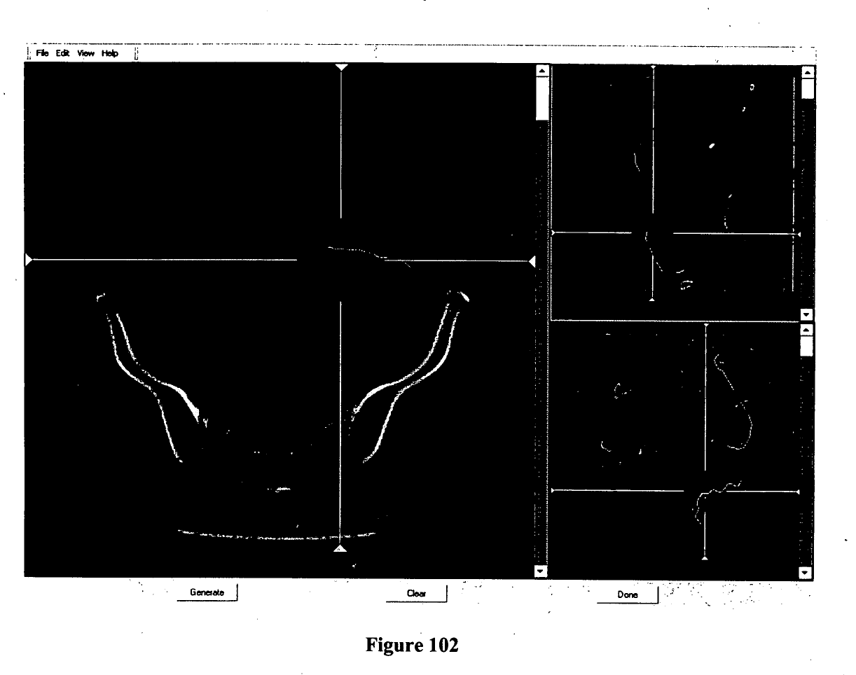

The exemplary system described above can receive multiple seed points as input from a user for a virtual endoscopy procedure and related centerline generation in tube-like structures. FIG. 102 illustrates and exemplary user interface for allowing a user to specify multiple seed points and for centerline generation on any of the axial, coronal and sagittal slices. After receiving input, an exemplary system can automatically sort the seed points, and construct centerline segments from the seed points. This technique can work well for disjointed colon datasets. In some embodiments, the method can assume that the first seed point defines the location of the rectum tube and the order of subsequent seed points is not important. Alternatively, the seed point that is closest to the rectum area may be determined from the group of inputted seed points, and upon determining this point, the remaining seed points may be sorted accordingly.

In some exemplary embodiments, automatic rectum detection may be utilized. Automatic rectum detection can rely on features of the rectum region in a common abdominal CT scan. For example, the rectum region appears as a cavity near the center of the torso in an axial slice can be utilized in automatic detection. In addition, the information that the rectum region always appears near the inferior end of the whole volume data set may be used.

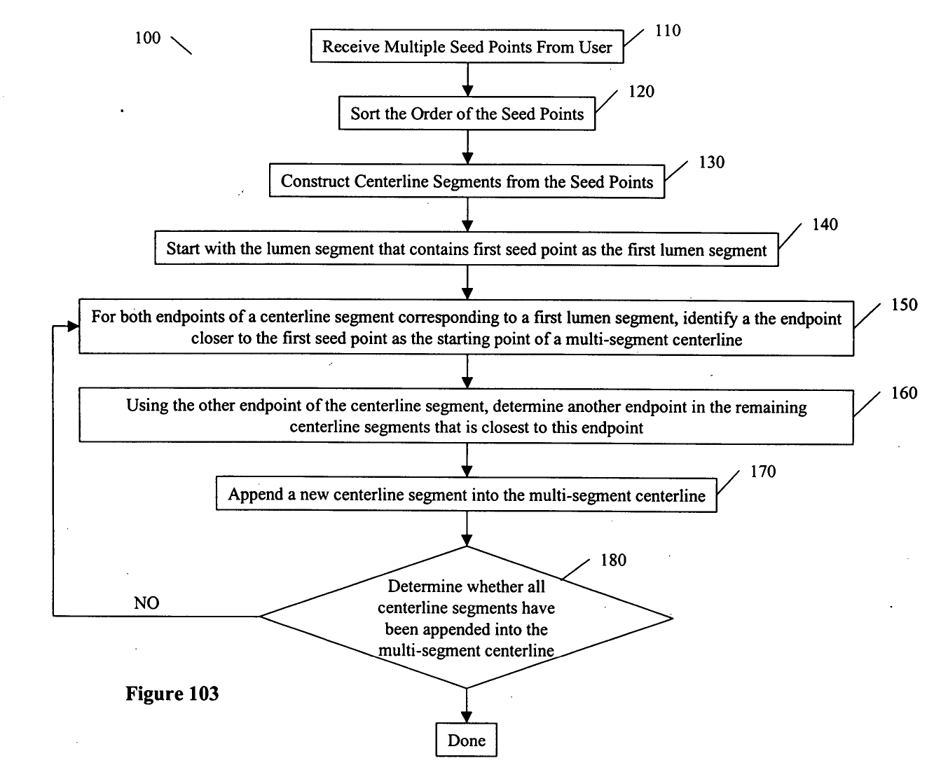

Turning to FIG. 103, in exemplary centerline generation method 100, multiple seed point may be obtained from a user at step 110. In exemplary embodiments of the present invention, several assumptions may be utilized in a exemplary virtual endoscopy procedure and centerline calculation in a tube-like structure. The length of collapsed regions may be assumed to be very short as compared to the length of well-blown colon lumen segments. In addition, as stated above, the first seed point may be assumed to be near the rectum region.

The order of the seed points may be important in exemplary embodiments of the present invention for ordering multiple colon lumen segments. Thus, the order of the seed points may be automatically calculated at step 120 of FIG. 103. When a user provides seed points to all the lumen segments, only the first seed point may be significant to the algorithm. In exemplary embodiments, the remaining seed points may be automatically sorted into the correct order.

In the exemplary virtual endoscopy, centerlines can be generated for each lumen segment at step 130. It is important to note that at this stage of method 100, the set of centerline segments is unordered.

Next, at exemplary step 140, the lumen segment that contains the first seed point may be assigned as the first lumen segment. For both endpoints of the centerline segment corresponding to the first lumen segment, step 150 may mark the endpoint closer to the first seed point as the starting point of the whole multi-segment centerline. Next, at step 160, using the other endpoint of the first centerline segment, another endpoint in the remaining centerline segments that is closest to this endpoint may be determined. Step 170 appends the new centerline segment into the multi-segment centerline. Next, at step 180, it is determined whether all of the centerline segments have been appended into a multi-segment centerline. If this has not occurred, method 100 will repeat steps 160 and 170 until all centerline segments have been appended into the multi-segment centerline.

In some exemplary embodiments of method 100, the first seed point can be automatically placed by detecting the rectum region. Automatic rectum detection may rely on information such as the rectum region appears as a cavity near the center of the torso in an axial scan slice, and that the rectum region appears near the inferior end of the whole volume data set. A user may select this automatic rectum detection feature to find the rectum and a suitable seed point for use in exemplary method 100. In an exemplary embodiment, the seed point selected by the automatic rectum detection may be displayed for the user in the exemplary user interface containing the axial, coronal and sagittal slices, as in FIG. 102.

Lumen Viewer and Flythrough Modules

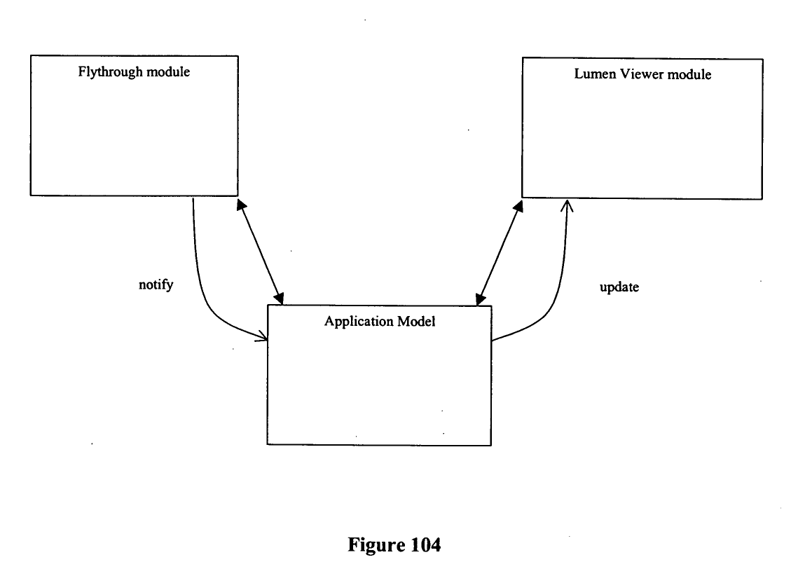

Various functions may be implemented on the above-indicated exemplary system to allow quick screening of the colon via the translucent mode and detail inspection via the translucent-opaque mode. FIG. 104 illustrates the interaction of the flythrough module and lumen viewer module with the application model. The flythrough module may be responsible for generating a traditional endoscopic view of a tube-like structure, such as a colon. The lumen viewer module, as stated above, may generate a view of the colon using translucent and translucent-opaque modes.

The lumen viewer display mode can be displayed simultaneously with the flythrough view in synchronization for thorough inspection of the colon in stereoscopic mode. As illustrated in FIG. 104, both the flythrough module and lumen viewer module are registered with a central Virtual Colonoscopy Application Model.

The synchronization may be performed using observer/notifier design pattern. For example, when flythrough module is the active component, it is actively performing calculations or modifying viewing parameters, it can notify the Application Model whenever it makes changes to the system. The Application Model, in turn, can examine the list of components registered with it, and update them accordingly. In this case, it will be the Lumen Viewer that is being updated with the latest parameters that Flythrough module modified.

The system performance in synchronous mode can be slower than that in normal unsynchronized operation. However, this slowdown is not caused by the synchronization mechanism. Rather, it is the additional rendering performed that is slowing the system down. Additional graphics processing hardware and memory may improve the rendering speed and performance of the system. Note that only one of the Flythrough module or the Lumen Viewer module may require updating of its display in unsynchronized mode. Both of the modules may require updating of their displays in synchronous mode, which effectively doubles the total amount of data rendered interactively. Although slowdown may be experienced when the exemplary system is working in synchronous mode, the overall system, however, remains responsive. Thus, additional rendering attributed to the synchronization does not affect the interactivity of the system.

Radii Estimation

In exemplary embodiments of the present invention, radii estimation may be performed in order to regulate the size of the lumen displayed to the user. For example, the estimation may be performed by sampling the minimum distance along a centerline, using the distance field information and selecting the largest radii out of the samples.

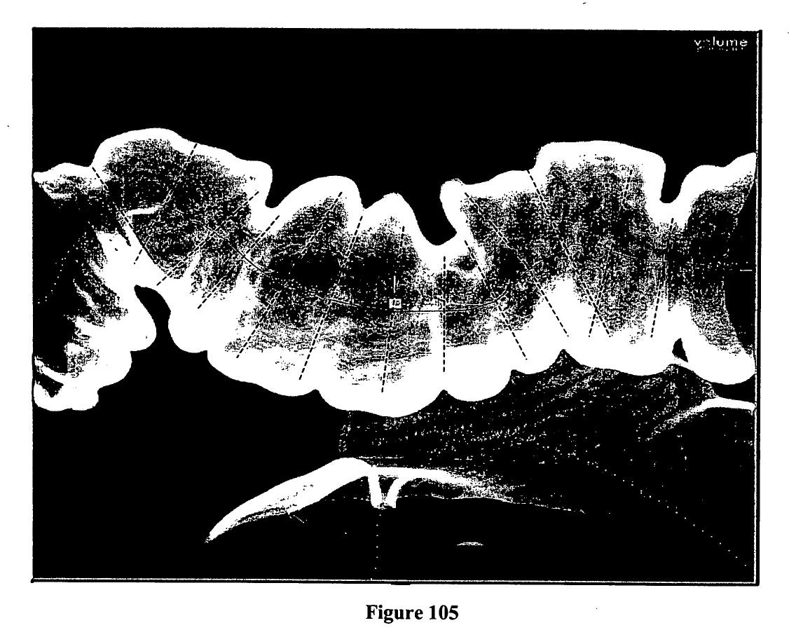

The radii estimation may be performed in two separate steps. First, the radius of the colon lumen may be determined at various positions as a function of the distance along the centerline from the starting point. This step utilizes the approximate Euclidean distance-to-boundary field already computed for each lumen segment during centerline generation. For each point within the colon lumen, the shortest distance from this point to the colon lumen boundary can be estimated from the Euclidean distance field, as illustrated in FIG. 105.

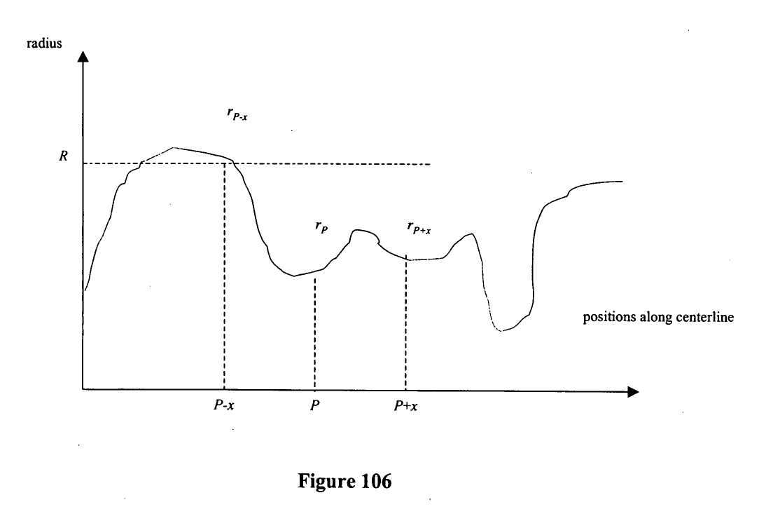

After sampling the whole centerline in regular interval, a function can be constructed that estimates the radius of the lumen at every point on the centerline, as illustrated in FIG. 106. In exemplary embodiments, the following equation may be solved:
R=2 km·max{r_{q}:qε[P−x, P+x]}=2x
where k is the aspect ratio of the OpenGL view port for the Lumen Viewer, m is the desired ratio of the view port that is to be occupied by the lumen. OpenGL is merely an exemplary graphics API (Application Program Interface), and other graphics application program interfaces may be utilized in order to provide similar functionality. In the rendering example illustrated in FIG. 106, k=1, m≈1.75. The values of k and m can be changed according to a user preference. In exemplary embodiments, the zoom ratio R that is required to fill the view port with the lumen segment under inspection may be estimated. The above equation can be solved efficiently, for example, at run-time via standard iterative approximation algorithm.
Display Modes

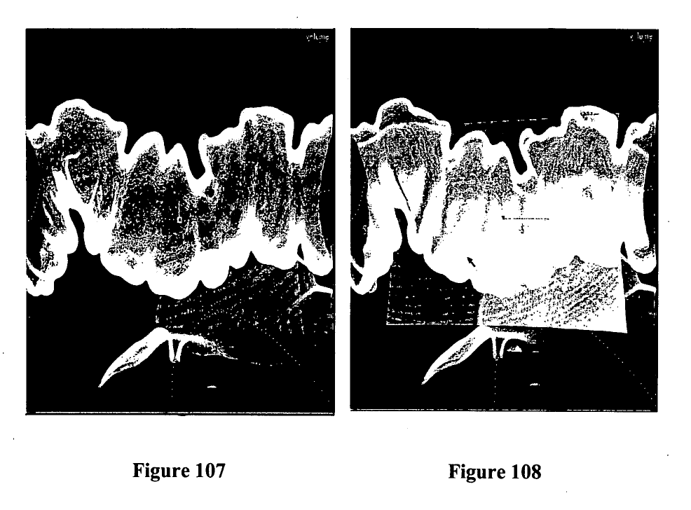

In exemplary embodiments of the present invention, two different display modes may be implemented for depicting of the colonic walls in the Lumen Viewer. The first display mode is the translucent mode as shown in FIG. 107. The second display mode is the translucent-opaque mode, illustrated in FIG. 108. Color look-up tables for each display mode may be automatically generated via image analysis.

In CT imaging, for example, different types of objects absorb different amount of X-ray energy. Air absorbs almost no energy, while fluid and soft tissue absorbs some amount of energy, and bone absorb the most. Thus, each type of matter appears to be of different intensity values in the scan image. Other imaging techniques are governed by similar principles.

Again, in CT datasets, air usually appears with a very low intensity (typically 0-10 in the grayscale range of 0-255) and soft tissues have a higher intensity. The actual intensity value range for each type of object varies depending on the nature of the object, the device calibration, the X-ray dosage, etc. For example, air may be of values ranging 0-5 in one scan, while it may appear to be 6-10 in another. The intensity ranges of other types of objects can also vary in a similar fashion.

Despite the difference in the actual intensity of different objects, the distribution of these objects' intensity values has a certain pattern that is characterized by the histogram of the data. Therefore, by analyzing the histogram of the CT data, it is possible to determine the correspondence between intensity value ranges and various types of objects. Upon determining the intensity value ranges, a color look-up table may be implemented in order to make different types of objects appear differently in the volumetric rendering.

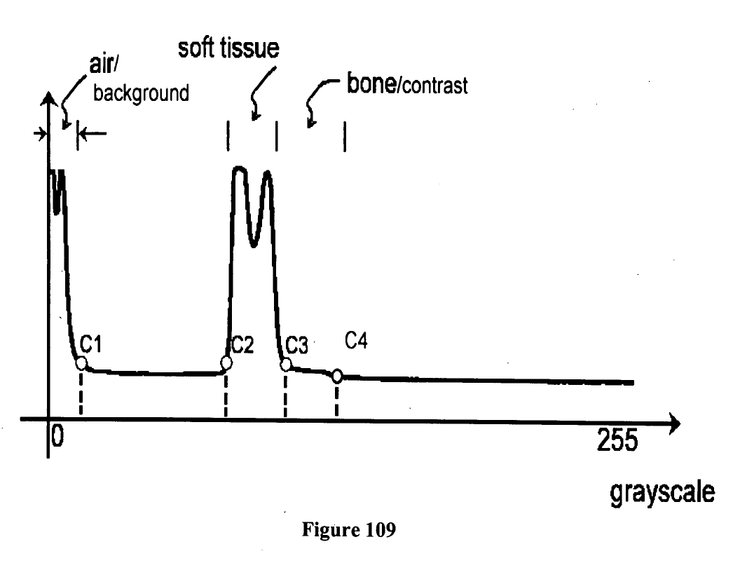

The histogram of a typical abdominal CT dataset for virtual colonoscopy is similar to the one shown in FIG. 109. The histogram is segmented into different ranges by three thresholds of interest, namely C1, C2, and C3. The first two peaks within the range [0, C1] corresponds to air in some cavities/lumens and the background of the CT scan images. In some instances, only one of the first two peaks may be within the [0,C1] range. The next two peaks within the range [C2, C3] correspond to soft tissues in the torso. In some instances, there may be only one peak in this region, as sometimes occurs in low dosage CT scans. Finally, the plateau region beyond C3 may due to bones and contrast agent.

In a virtual endoscopy, human tissues surrounding some lumen structure are rendered differently from the cavity of interest, which might be filled with air, fluid, contrast agent, etc.

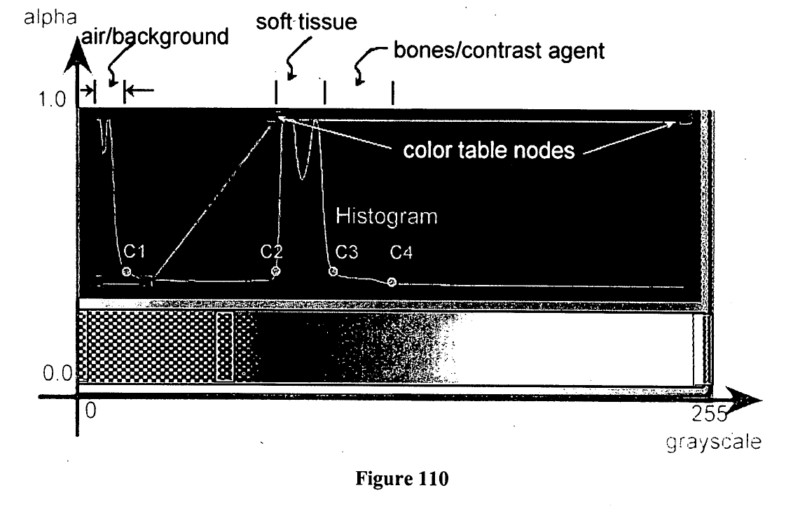

In FIG. 110, the histogram of an abdominal CT dataset is shown (in the color version of this figure, it is shown in yellow). The lines and squares (shown in green in the color figure) represent the color look-up table's alpha (opacity) function. As illustrated in FIG. 110, the alpha function is shown as a ramp with the left side (corresponding to the air) completely transparent and the right side (corresponding to soft tissues and bones) complete opaque. In order to obtain a visually softer rendering result, the alpha function of a color look-up table can be a smoother ramp shape similar to the one depicted in the FIG. 110. The voxel intensity values ranging from C1 to C2 are rendered from completely transparent gradually to completely opaque, which visually depicts the transition from the colon lumen (air-filled) to the colon wall (a type of soft tissue).

By performing analysis on the histogram, voxel intensity thresholds of interest are identified in exemplary embodiments of the invention, namely C1, C2, and C3. The color look-up table's setting are adjusted in order to obtain the desired rendering results.

In the example illustrated in FIG. 110, the alpha function is set to be fully transparent in the range of [0, C1], and fully opaque in the range of [C2, 255], with a simple ramp in between the two ranges.

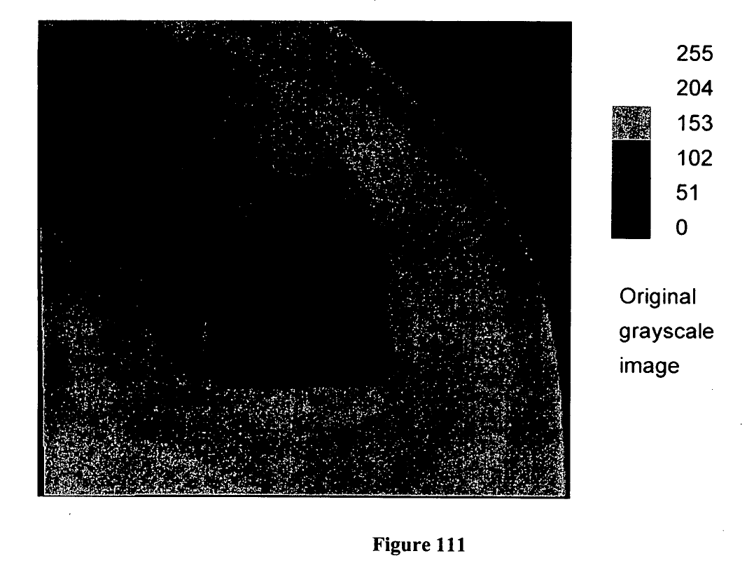

Part of the original CT data is used to form the image shown in FIG. 111. The first visible slice blocks all the details behind due to its opacity. By applying only the alpha function, the same data may appear more informative since the lumen is not transparent.

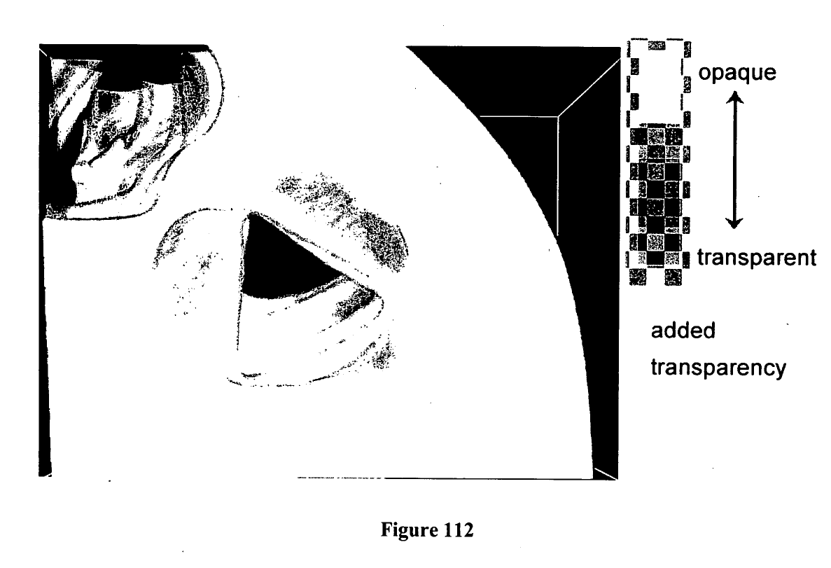

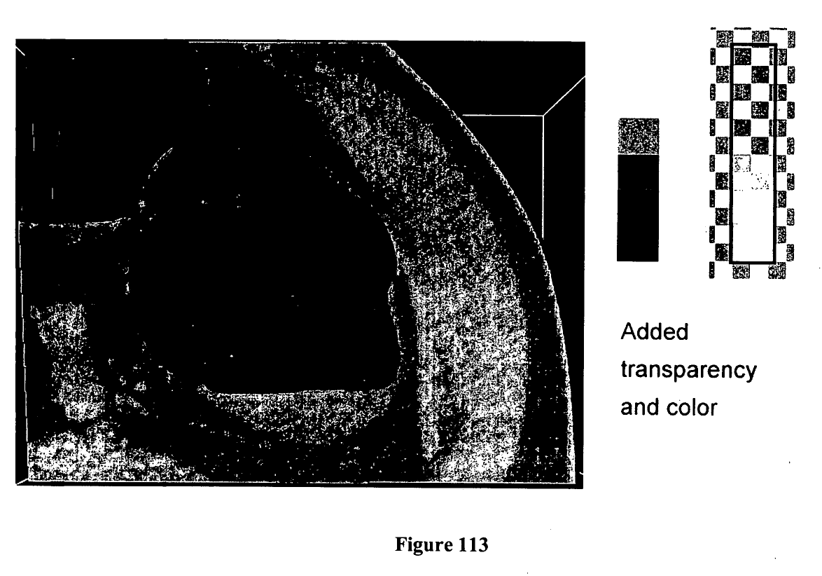

In some exemplary embodiments, in order to further enhance the visual result, further color information is added into the color look-up table. For example, pinkish red and white can be used for different voxel intensity ranges (which may be depicted near the bottom of a histogram-overlaid color look-up table). The rendering result are shown in FIGS. 112 and 113 (only the color figures depict the pinkish red), which gives the user an insightful view of the colon lumen as well as the surrounding soft tissues.

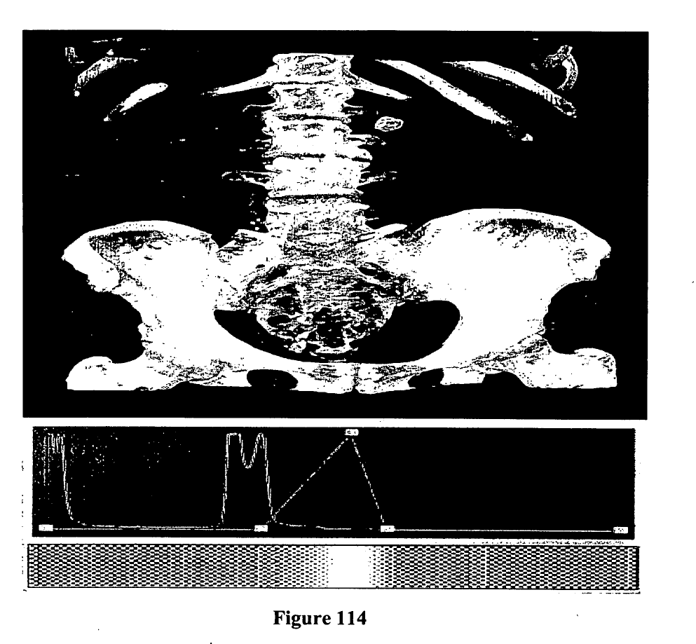

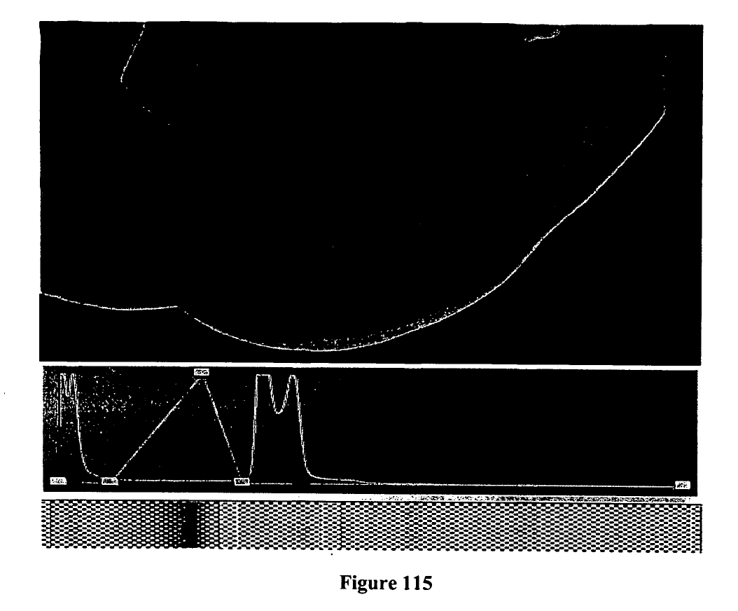

Based on the result of the histogram analysis, other color look-up tables may be constructed to emphasize other parts of the human anatomy. For example, FIG. 114 shows the bones and FIG. 115 illustrates the colon wall of the same CT dataset respectively, by applying different color look-up tables (shown at the bottom of each figure) on the same volume.

Flythrough Module

In exemplary embodiments of the present invention, markers in the Flythrough module are synchronized with the Lumen Viewer, axial, coronal and sagittal displays. In order to speed up rendering, the rendering of the orthogonal slices can be implemented with a hardware accelerated multi-texture method. This technique overcomes the problem of large texture memory usage.

Multi-texturing is a technique used in graphics processing units (GPUs). In exemplary embodiments, the underlying GPU of the system supports multi-texturing, and both of the two adjacent slices that are to be interpolated as textures are rendered. The GPU hardware may then be instructed to perform the necessary calculations to produce an interpolated slice in the frame buffer. Typically, the multi-texture approach runs faster than blending-based interpolations.

In one embodiment, a CT dataset is textured and then transferred to (and stored in) graphics memory in the format of the original slices. However, if the volume is relatively large, this process may be burdensome to the graphics system. Furthermore, for slices other than those in the axial direction (i.e. coronal and sagittal slices), the slices in the original volume dataset have to be processed together at once. Note that each interpolated coronal or sagittal slice involves taking one scan line of voxels from each axial slice in the whole volume. Thus, such an approach may incur a significant computing overhead and may therefore be slow.

In another embodiment of the present invention, instead of transferring all the slices to the texture memory at one time, two adjacent slices (coronal or sagittal) can be constructed dynamically by taking two adjacent scan lines from each of the axial slices in the original volume. These two temporary slices may then processed by the graphics system for multi-texture interpolation. This drastically reduce the burden on the texture memory as well as the overhead in data processing.

Virtual Colonoscopy Application

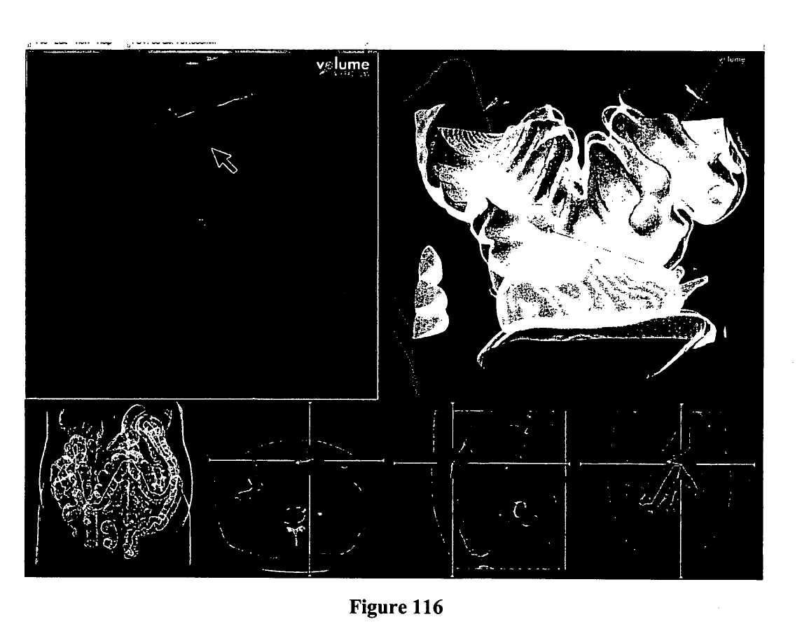

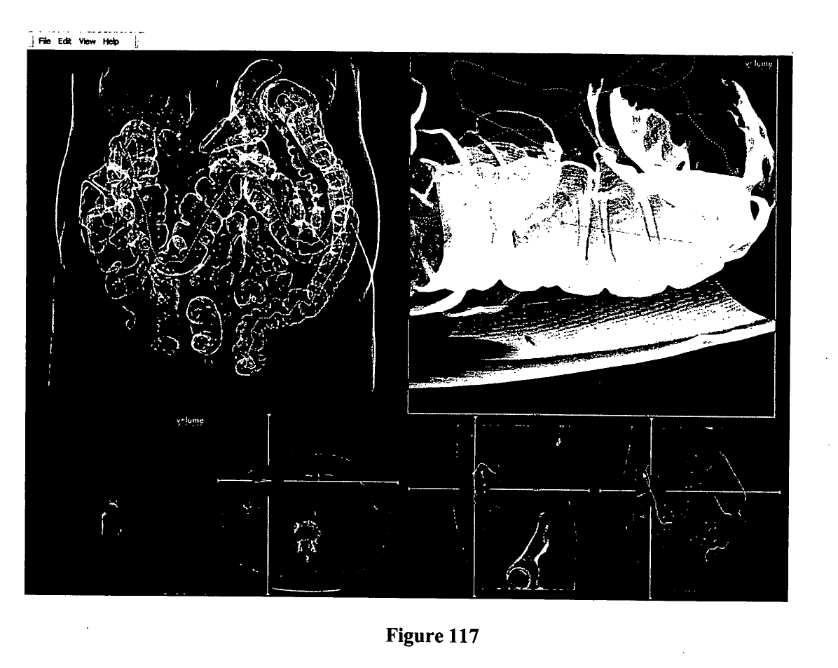

FIGS. 116 and 117 illustrate exemplary interfaces for a Virtual Colonoscopy Application with Flythrough and Lumen Viewer modes display windows in a single interface. The interface illustrated in these figures may also include windows for views of the axial, coronal, and sagittal slices, as well as the “jelly map” view of the entire colon structure. In some embodiments, it is possible to use the modules independently of each other, or keep the flythrough and lumen views synchronized (as shown in FIG. 116). Each window of the display is capable of independent display modes like monoscopic, stereoscopic or red-green stereo. To overcome the limitation of screen ‘real estate’ (i.e., how much screen space each window occupies—the endoscopic view versus the axial slice view), the interface can be user-configurable. This allows the user to allocate more screen space to particular views of interest. As shown in FIG. 117, the Jelly Map window (illustrates the full intestinal structure) has been dragged into the screen space originally occupied by the endoscopic view, therefore giving a larger and clearer view.

Interface for Brightness and Contrast

In some embodiments of the present invention, a user interface for real-time brightness and contrast control of interpolated slices may be implemented on the exemplary hardware. The dynamic brightness and contrast adjustment can be performed on the interpolated slice computed by GPU using multi-texture technique described above, or alternatively by using common techniques that instruct the graphics hardware to perform the additional calculations required.

The present invention has been described in connection with exemplary embodiments and implementations, as examples only. Thus, any functionality described in connection with a colon, can just as well be applied to any luminal organ, such as, for example, a large blood vessel, and vice versa. It is understood by those having ordinary skill in the pertinent arts that modifications to any of the exemplary embodiments or implementations, can be easily made without materially departing from the scope or spirit of the present invention.

1. A method of generating a virtual view of a tube-like anatomical structure, comprising:
obtaining scan data of an area of interest of a body which contains a tube-like structure;
constructing at least one volumetric data set from the scan data;
generating a virtual tube-like structure from the at least one volumetric data set; and
displaying the virtual tube-like structure, wherein the tube-like structure is displayed with a user's point of view placed outside of the tube-like structure, and wherein the tube-like structure is seen as moving in front of the user.

2. The method of claim 1, wherein the tube-like structure is displayed transparently.

3. The method of claim 1, wherein the displayed tube-like structure is rotated as it moves in front of the user.

4. The method of claim 1, wherein the tube-like structure is displayed using user defined display parameters including at least one of a color look up table, a crop box, transparency, shading, zoom, or tri-planar view.

5. The method of claim 4, wherein the tube-like structure is displayed in two longitudinally cut halves, a back half displayed opaquely and a front half displayed transparently or semi-transparently.

6. The method of claim 4, wherein the tube-like structure is displayed using two different look up tables, a first look up table for a foreground region of the tube-like structure and a second look up table for a background region of the tube-like structure.

7. The method of claim 6, where the foreground region is used to render a section of the tube-like structure from a prone scan, and the background region used to render the same section from a supine scan.

8. The method of claim 6, where the background region is used to render a section of the tube-like structure from a prone scan, and the foreground region used to render the same section from a supine scan.

9. The method of claim 1, wherein the tube-like structure is displayed stereoscopically.

10. The method of claim 9, wherein the tube-like structure is displayed using one or more of red-blue stereo, red-green stereo, and interlaced display.

11. The method of claim 1, wherein the displayed tube-like structure moves along its center line at an angle with the user's direction of view between 90 and 0 degrees.

12. The method of claim 1, wherein the user can switch the display of the tube-like structure from the user's point of view placed outside the tube-like structure to an endoscopic flythrough view.

13. The method of claim 1, wherein an endoscopic flythrough view of the tube-like structure is simultaneously displayed with a lumen view where the user's point of view is placed outside the tube-like structure.

14. The method of claim 1, wherein the displaying further comprises at least one of a flythrough view, a view of the entire tube-like structure, an axial view, a sagittal view, or a coronal view.

15. The method of claim 14, wherein the display of each at least one of flythrough view, lumen view, entire tube-like structure view, axial view, or coronal view can be arranged in the display by the user.

16. The method of claim 14, wherein the display of each at least one of flythrough view, lumen view, entire tube-like structure view, axial view, or coronal view can be adjusted in size by the user.

17. The method of claim 1, wherein the user can linearly measure an object of interest in the displayed tube-like structure.

18. The method of claim 1, further comprising generating a histogram of voxel intensities from the scan data.

19. The method of claim 18, further comprising adjusting a color look-up table in order to emphasize an area of interest in the display according to the generated histogram.

20. A method for centerline generation in a tube-like structure, comprising:
(a) receiving multiple seed points from a user;
(b) sorting the order of the seed points;
(c) constructing centerline segments from the seed points in lumen segments;
(d) for both endpoints of a first centerline segment corresponding to a first lumen segment, identifying a first endpoint closer to a first seed point as the starting point of a multi-segment centerline;
(e) using a second endpoint of the first centerline segment, determine another endpoint in a second centerline segments that is closest to this endpoint;
(f) append a new centerline segment into the multi-segment centerline; and
(g) determine whether all centerline segments have been appended into the multi-segment centerline.

21. The method of claim 20, wherein the tube-like structure is a human colon.

22. The method of claim 21, wherein the sorting of the order of the seed points determines that the first point is closest to a rectum region of the colon.

23. The method of claim 21, wherein the first seed point received from the user is assumed to be the nearest to a rectum region of the colon.

24. The method of claim 20, further comprising estimating the radii of the tube-like structure to regulate the size of the tube-like structure displayed.

25. The method of claim 24, wherein the radii estimation comprises:
estimating the radii of the tube-like structure at various positions as the function of the distance along the centerline from a starting point;
constructing a function estimating the radius of the lumen at every point of the centerline; and
estimating the zoom ratio required to fill the view area of the display with the lumen segment.

26. A method for volume rendering, comprising:
obtaining scan data of an area of interest;
constructing at least one volumetric data set from the scan data;
constructing two adjacent slices dynamically from the at least one volumetric data set, wherein the construction comprises taking two adjacent scan lines from each axial slice in the original volume; and
processing the two adjacent slices with a graphics system for multi-texture interpolation.

27. A method of generating a virtual view of a colon lumen for use in a virtual colonoscopy, comprising:
obtaining scan data of an area of interest of a body which contains the colon;
constructing at least one volumetric data set from the scan data;
generating a virtual colon lumen from the at least one volumetric data set; and
displaying the virtual colon lumen, wherein the virtual colon lumen is displayed with a user's point of view placed outside of the virtual colon lumen, and wherein the colon lumen is seen as moving in front of the user.

28. The method of claim 27, wherein some or all of the virtual colon lumen is displayed transparently.

29. The method of claim 27, wherein the displayed virtual colon lumen is rotated as it moves in front of the user.

30. The method of claim 27, wherein the colon lumen is displayed using user defined display parameters including at least one of a color look up table, a crop box, transparency, shading, zoom, or tri-planar view.

31. The method of claim 30, wherein the colon lumen is displayed in two longitudinally cut halves, a back half displayed opaquely and a front half displayed transparently or semi-transparently.

32. The method of claim 30, wherein the virtual colon lumen is displayed using two different look up tables, a first look up table for a foreground region of the colon lumen and a second look up table for a background region of the colon lumen.

33. The method of claim 32, where the foreground region is used to render a section of the colon lumen from a prone scan, and the background region used to render the same section from a supine scan.

34. The method of claim 32, where the background region is used to render a section of the colon lumen from a prone scan, and the foreground region used to render the same section from a supine scan.

35. The method of claim 27, wherein the virtual colon lumen is displayed stereoscopically.

36. The method of claim 35, wherein the virtual colon lumen is displayed using one or more of red-blue stereo, red-green stereo and interlaced display.

37. The method of claim 27, wherein the displayed virtual colon lumen moves along its center line at an angle with the user's direction of view between 90 and 0 degrees.

38. The method of claim 27, wherein the user can switch the display of the virtual colon lumen from the user's point of view placed outside the tube-like structure to an endoscopic flythrough view.

39. The method of claim 27, wherein an endoscopic flythrough view of the colon lumen is simultaneously displayed with a lumen view where the user's point of view is placed outside the virtual colon lumen.

40. The method of claim 27, wherein the display further comprises at least one of a flythrough view, a lumen view where the user's point of view is placed outside the virtual colon lumen, a view of the entire colon lumen, an axial view, a sagittal view, or a coronal view.

41. The method of claim 40, wherein the display of each at least one of flythrough view, lumen view, a view of the entire colon lumen, axial view, or coronal view can be arranged in the display by the user.

42. The method of claim 40, wherein the display of each at least one of flythrough view, lumen view, a view of the entire colon lumen, axial view, or coronal view can be adjusted in size by the user.

43. The method of claim 27, wherein the user can linearly measure an object of interest in the displayed virtual colon lumen.

44. The method of claim 27, further comprising generating a histogram of voxel intensities from the scan data.

45. The method of claim 44, further comprising adjusting a color look-up table in order to emphasize an area of interest in the display according to the generated histogram.

46. A method of selecting points of interest in a tube-like structure, comprising:
obtaining scan data of an area of interest of a body which contains a tube-like structure;
constructing at least one volumetric data set from the scan data;
generating a virtual tube-like structure from the at least one volumetric data set;
displaying the virtual tube-like structure;
on a first pass through the tube-like structure, identifying at least one region of interest;
setting display parameters for the at least one identified region of interest; and
on a second pass through the tube-like structure, viewing the at least one region of interest according to the set display parameters.

47. The method of claim 46, wherein the setting display parameters comprises setting to zoom on the at least one region of interest.

48. The method of claim 46, wherein the setting display parameters comprises selecting the location of the region of interest to be displayed.

49. The method of claim 46, wherein the setting display parameters comprises selecting the boundaries of the region of interest to be displayed.

50. The method of claim 46, wherein the setting display parameters comprises setting viewing parameters for the region of interest, including a view point, a viewing direction, or a field of view.

51. The method of claim 46, wherein the setting display parameters comprises allowing a user to adjust the rendering parameters for the region of interest, including a color look-up table, a shading mode, or light position for the display of the at least one region of interest.

52. The method of claim 46, wherein the setting display parameters comprises setting diagnostic information including an identification, a classification, linear measurements, distance from rectum, or comments.

53. The method of claim 46, where the setting display parameters comprises user-requested monoscopic or stereoscopic snapshots.

54. The method of claim 46, further comprising receiving a selection from a user to view a list of the identified regions of interest.

55. A method using zoom on areas of interest in a tube-like structure, comprising:
obtaining scan data of an area of interest of a body which contains a tube-like structure;
constructing at least one volumetric data set from the scan data;
generating a virtual tube-like structure from the at least one volumetric data set;
generating a centerline in the generated tube-like structure by using radius estimation; and
displaying the virtual tube-like structure, wherein the center of the tube-like structure in centered in a display window, and the zoom is adjusted such that the tube-like structure is of the appropriate size so that it fits within the display window.

56. A system for generating a virtual view of a tube-like anatomical structure, comprising:
means for obtaining scan data of an area of interest of a body which contains a tube-like structure;
means for constructing at least one volumetric data set from the scan data;
means for generating a virtual tube-like structure from the at least one volumetric data set; and
means for displaying the virtual tube-like structure, wherein the tube-like structure is displayed with a user's point of view placed outside of the tube-like structure, and wherein the tube-like structure is seen as moving in front of the user.

57. The system of claim 56, wherein the tube-like structure is displayed transparently.

58. The system of claim 56, wherein the displayed tube-like structure is rotated as it moves in front of the user.

59. The system of claim 56, wherein the tube-like structure is displayed using user defined display parameters including at least one of a color look up table, a crop box, transparency, shading, zoom, or tri-planar view.

60. The system of claim 59, wherein the tube-like structure is displayed in two longitudinally cut halves, a back half displayed opaquely and a front half displayed transparently or semi-transparently.

61. The system of claim 59, wherein the tube-like structure is displayed using two different look up tables, a first look up table for a foreground region of the tube-like structure and a second look up table for a background region of the tube-like structure.

62. The system of claim 61, where the foreground region is used to render a section of the tube-like structure from a prone scan, and the background region used to render the same section from a supine scan.

63. The system of claim 61, where the background region is used to render a section of the tube-like structure from a prone scan, and the foreground region used to render the same section from a supine scan.

64. The system of claim 56, wherein the tube-like structure is displayed stereoscopically.

65. The system of claim 64, wherein the tube-like structure is displayed using one or more of red-blue stereo, red-green stereo and interlaced display.

66. The system of claim 56, wherein the displayed tube-like structure moves along its center line at an angle with the user's direction of view between 90 and 0 degrees.

67. The system of claim 56, wherein the user can switch the display of the tube-like structure from the user's point of view placed outside the tube-like structure to an endoscopic flythrough view.

68. The system of claim 56, wherein an endoscopic flythrough view of the tube-like structure is simultaneously displayed with a lumen view where the user's point of view is placed outside the tube-like structure.

69. The system of claim 56, wherein the displaying further comprises at least one of a flythrough view, a view of the entire tube-like structure, an axial view, a sagittal view, or a coronal view.

70. The system of claim 69, wherein the display of each at least one of flythrough view, lumen view, entire tube-like structure view, axial view, or coronal view can be arranged in the display by the user.

71. The system of claim 69, wherein the display of each at least one of flythrough view, lumen view, entire tube-like structure view, axial view, or coronal view can be adjusted in size by the user.

72. The system of claim 56, wherein the user can linearly measure an object of interest in the displayed tube-like structure.

73. The system of claim 56, further comprising generating a histogram of voxel intensities from the scan data.

74. The system of claim 73, further comprising adjusting a color look-up table in order to emphasize an area of interest in the display according to the generated histogram.

75. A computer program product, comprising:
a computer useable medium having computer readable program code means embodied therein, the computer readable program code means in said computer program product comprising means for causing a computer to:
obtain scan data of an area of interest of a body which contains a tube-like structure;
construct at least one volumetric data set from the scan data;
generate a virtual tube-like structure from the at least one volumetric data set; and
display the virtual tube-like structure, wherein the tube-like structure is displayed with a user's point of view placed outside of the tube-like structure, and wherein the tube-like structure is seen as moving in front of the user.
